(19) United States
(12) Patent Application Publication
(10) Pub. No.: US 2015/0186971 A1
(43) Pub. Date: Jul. 2, 2015

(54) AUTOMATED GENERATION OF ONE OR MORE CUSTOMIZED FOOD ITEMS IN RESPONSE TO A GENERIC FOOD REQUEST

(71) Applicant: Elwha LLC, Bellevue, WA (US)

(72) Inventors: Pablos Holman, Seattle, WA (US); Son Hong, San Francisco, CA (US); Roderick A. Hyde, Redmond, WA (US); Muriel Y. Ishikawa, Livermore, CA (US); Jordin T. Kare, Seattle, WA (US); Max R. Levchin, San Francisco, CA (US); Royce A. Levien, Lexington, MA (US); Richard T. Lord, Gig Harbor, WA (US); Robert W. Lord, Seattle, WA (US); Mark A. Malamud, Seattle, WA (US); Nathan P. Myhrvold, Bellevue, WA (US); Robert C. Petroski, Seattle, WA (US); Clarence T. Tegreene, Mercer Island, WA (US); Charles Whitmer, North Bend, WA (US); Lowell L. Wood, JR., Bellevue, WA (US); Victoria Y.H. Wood, Livermore, CA (US)

(21) Appl. No.: 14/263,828

(22) Filed: Apr. 28, 2014

Related U.S. Application Data
(63) Continuation of application No. 14/261,729, filed on Apr. 25, 2014.
Application No. 14/261,729 is a continuation-in-part of application No. 14/145,864, filed on Dec. 31, 2013.
Application No. 14/145,864 is a continuation of application No. 14/144,163, filed on Dec. 30, 2013.
Application No. 14/261,729 is a continuation-in-part of application No. 14/176,408, filed on Feb. 10, 2014.
Application No. 14/176,408 is a continuation of application No. 14/175,416, filed on Feb. 7, 2014.
Application No. 14/261,729 is a continuation-in-part of application No. 14/200,514, filed on Mar. 7, 2014.
Application No. 14/200,514 is a continuation of application No. 14/199,667, filed on Mar. 6, 2014.
Application No. 14/261,729 is a continuation-in-part of application No. 14/228,601, filed on Mar. 28, 2014.
Application No. 14/228,601 is a continuation of application No. 14/227,027, filed on Mar. 27, 2014.

(51) Int. Cl. G06Q 30/06; G06Q 50/12; G06Q 20/18

(52) U.S. Cl. CPC G06Q 30/0621; G06Q 20/18; G06Q 50/12

(57) ABSTRACT

Computationally implemented methods and systems include receiving a generic food request from a user for one or more food items; obtaining, in response to the reception of the generic food request, user preference information of the user that indicates one or more food customization preferences of the user including at least one or more ingredient integrity preferences of the user related to integrity of one or more ingredients, the user preference information to be obtained from one or more sources other than the user; and directing automated generation of one or more customized food items in response to the received generic food request and in accordance, at least in part, with the obtained user preference information. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

The present application constitutes a continuation-in-part of U.S. patent application Ser. No. 14/145,864, entitled SYSTEMS AND METHODS FOR PROVIDING CUSTOMIZED PACKAGINGS FOR CUSTOMIZED FOOD ITEMS THAT WERE CUSTOMIZED BASED, AT LEAST IN PART, ON CUSTOMIZED FOOD ITEM INTEGRITY PREFERENCE, naming Pablos Holman, Son Hong, Roderick A. Hyde, Muriel Y. Ishikawa, Jordin T. Kare, Max R. Levchin, Royce A. Levien, Richard T. Lord, Robert W. Lord, Mark A. Malamud, Nathan P. Myhrvold, Robert C. Petroski, Clarence T. Tegreene, Charles Whitmer, Lowell L. Wood, Jr., and Victoria Y. H. Wood, as inventors, filed 31, Dec. 2013 with attorney docket no. 0913-002-007-000000, which is currently co-pending or is an application of which a currently co-pending application is entitled to the benefit of the filing date, and which is a continuation of U.S. patent application Ser. No. 14/144,163, entitled SYSTEMS AND METHODS FOR PROVIDING CUSTOMIZED PACKAGINGS FOR CUSTOMIZED FOOD ITEMS THAT WERE CUSTOMIZED BASED, AT LEAST IN PART, ON CUSTOMIZED FOOD ITEM INTEGRITY PREFERENCE, naming Pablos Holman, Son Hong, Roderick A. Hyde, Muriel Y. Ishikawa, Jordin T. Kare, Max R. Levchin, Royce A. Levien, Richard T. Lord, Robert W. Lord, Mark A. Malamud, Nathan P. Myhrvold, Robert C. Petroski, Clarence T. Tegreene, Charles Whitmer, Lowell L. Wood, Jr., and Victoria Y. H. Wood, as inventors, filed 30, Dec. 2013 with attorney docket no. 0913-002-002-000000.

The present application constitutes a continuation-in-part of U.S. patent application Ser. No. 14/176,408, entitled SYSTEMS AND METHODS FOR PROVIDING CUSTOMIZED FOOD ITEMS THAT ARE CUSTOMIZED BASED, AT LEAST IN PART, ON CUSTOMIZED FOOD ITEM INTEGRITY PREFERENCE, naming Pablos Holman, Son Hong, Roderick A. Hyde, Muriel Y. Ishikawa, Jordin T. Kare, Max R. Levchin, Royce A. Levien, Richard T. Lord, Robert W. Lord, Mark A. Malamud, Nathan P. Myhrvold, Robert C. Petroski, Clarence T. Tegreene, Charles Whitmer, Lowell L. Wood, Jr., and Victoria Y. H. Wood, as inventors, filed 10, Feb. 2014 with attorney docket no. 0913-002-008-000000, which is currently co-pending or is an application of which a currently co-pending application is entitled to the benefit of the filing date, and which is a continuation of U.S. patent application Ser. No. 14/175,416, entitled SYSTEMS AND METHODS FOR PROVIDING CUSTOMIZED FOOD ITEMS THAT ARE CUSTOMIZED BASED, AT LEAST IN PART, ON CUSTOMIZED FOOD ITEM INTEGRITY PREFERENCE, naming Pablos Holman, Son Hong, Roderick A. Hyde, Muriel Y. Ishikawa, Jordin T. Kare, Max R. Levchin, Royce A. Levien, Richard T. Lord, Robert W. Lord, Mark A. Malamud, Nathan P. Myhrvold, Robert C. Petroski, Clarence T. Tegreene, Charles Whitmer, Lowell L. Wood, Jr., and Victoria Y. H. Wood, as inventors, filed 07, Feb. 2014 with attorney docket no. 0913-002-003-000000.

The present application constitutes a continuation-in-part of U.S. patent application Ser. No. 14/200,514, entitled DIRECTING ONE OR MORE USERS TO ONE OR MORE AUTOMATED CUSTOMIZED FOOD GENERATION MACHINES, naming Pablos Holman, Son Hong, Roderick A. Hyde, Muriel Y. Ishikawa, Jordin T. Kare, Max R. Levchin, Royce A. Levien, Richard T. Lord, Robert W. Lord, Mark A. Malamud, Nathan P. Myhrvold, Robert C. Petroski, Clarence T. Tegreene, Charles Whitmer, Lowell L. Wood, Jr., and Victoria Y. H. Wood, as inventors, filed 07, Mar. 2014 with attorney docket no. 0913-002-009-000000, which is currently co-pending or is an application of which a currently co-pending application is entitled to the benefit of the filing date, and which is a continuation of U.S. patent application Ser. No. 14/199,667, entitled DIRECTING ONE OR MORE USERS TO ONE OR MORE AUTOMATED CUSTOMIZED FOOD GENERATION MACHINES, naming Pablos Holman, Son Hong, Roderick A. Hyde, Muriel Y. Ishikawa, Jordin T. Kare, Max R. Levchin, Royce A. Levien, Richard T. Lord, Robert W. Lord, Mark A. Malamud, Nathan P. Myhrvold, Robert C. Petroski, Clarence T. Tegreene, Charles Whitmer, Lowell L. Wood, Jr., and Victoria Y. H. Wood, as inventors, filed 06, Mar. 2014 with attorney docket no. 0913-002-004-000000.

The present application constitutes a continuation-in-part of U.S. patent application Ser. No. 14/228,601, entitled IDENTIFYING ONE OR MORE SUBSTITUTE AUTOMATED CUSTOMIZED FOOD GENERATION MACHINES FOR GENERATING ONE OR MORE SUBSTITUTE CUSTOMIZED FOOD ITEMS, naming Pablos Holman, Son Hong, Roderick A. Hyde, Muriel Y. Ishikawa, Jordin T. Kare, Max R. Levchin, Royce A. Levien, Richard T. Lord, Robert W. Lord, Mark A. Malamud, Nathan P. Myhrvold, Robert C. Petroski, Clarence T. Tegreene, Charles Whitmer, Lowell L. Wood, Jr., and Victoria Y. H. Wood, as inventors, filed 28, Mar. 2014 with attorney docket no. 0913-002-010-000000, which is currently co-pending or is an application of which a currently co-pending application is entitled to the benefit of the filing date, and which is a continuation of U.S. patent application Ser. No. 14/227,027, entitled IDENTIFYING ONE OR MORE SUBSTITUTE AUTOMATED CUSTOMIZED FOOD GENERATION MACHINES FOR GENERATING ONE OR MORE SUBSTITUTE CUSTOMIZED FOOD ITEMS, naming Pablos Holman, Son Hong, Roderick A. Hyde, Muriel Y. Ishikawa, Jordin T. Kare, Max R. Levchin, Royce A. Levien, Richard T. Lord, Robert W. Lord, Mark A. Malamud, Nathan P. Myhrvold, Robert C. Petroski, Clarence T. Tegreene, Charles Whitmer, Lowell L. Wood, Jr., and Victoria Y. H. Wood, as inventors, filed 27, Mar. 2014 with attorney docket no. 0913-002-005-000000.

### RELATED APPLICATIONS

None as of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one or more various aspects, a method includes, but is not limited to, receiving a generic food request from a user for one or more food items, obtaining, in response to the reception of the generic food request, user preference information of the user that indicates one or more food customization preferences of the user including at least one or more ingredient integrity preferences of the user related to integrity of one or more ingredients, the user preference information to be obtained from one or more sources other than the user; and directing automated generation of one or more customized food items in response to the received generic food request and in accordance, at least in part, with the obtained user preference information. In various implementations, at least one of the above recited operations is performed by a machine or article of manufacture. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for receiving a generic food request from a user for one or more food items, means for obtaining, in response to the reception of the generic food request, user preference information of the user that indicates one or more food customization preferences of the user including at least one or more ingredient integrity preferences of the user related to integrity of one or more ingredients, the user preference information to be obtained from one or more sources other than the user and means for directing automated generation of one or more customized food items in response to the received generic food request and in accordance, at least in part, with the obtained user preference information. In addition to the foregoing, other system aspects are described in the claims, drawings, and text forming a part of the disclosure set forth herein.

In one or more various aspects, a system includes, but is not limited to, circuitry for receiving a generic food request from a user for one or more food items, circuitry for obtaining, in response to the reception of the generic food request, user preference information of the user that indicates one or more food customization preferences of the user including at least one or more ingredient integrity preferences of the user related to integrity of one or more ingredients, the user preference information to be obtained from one or more sources other than the user; and circuitry for directing automated generation of one or more customized food items in response to the received generic food request and in accordance, at least in part, with the obtained user preference information. In addition to the foregoing, other system aspects are described in the claims, drawings, and text forming a part of the disclosure set forth herein.

In one or more various aspects, a computer program product, comprising a signal bearing non-transitory storage medium, bearing one or more instructions including, but not limited to, receiving a generic food request from a user for one or more food items, obtaining, in response to the reception of the generic food request, user preference information of the user that indicates one or more food customization preferences of the user including at least one or more ingredient integrity preferences of the user related to integrity of one or more ingredients, the user preference information to be obtained from one or more sources other than the user, and directing automated generation of one or more customized food items in response to the received generic food request and in accordance, at least in part, with the obtained user preference information. In addition to the foregoing, other computer program product aspects are described in the claims, drawings, and text forming a part of the disclosure set forth herein.

In one or more various aspects, a system includes, but is not limited to, a generic food request obtaining module configured to obtain a generic food request for one or more food items, the generic food request to be obtained from a user; a user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request; and an automated customized food generation controlling module configured to control automated generation of one or more customized food items in response to the obtained generic food request and in accordance, at least in part, with the acquired user preference information.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1A illustrates an exemplary automated customized food generation machine 10* that is designed to generate customized food items in accordance with customization preferences of users.

FIG. 1B shows a user 13 in an example environment that includes multiple automated customized food generation machines.

FIG. 1C shows a user 13 in another example environment that includes multiple automated customized food generation machines.

FIG. 1D shows a user 13 in another example environment that includes multiple automated customized food generation machines.

FIG. 1E shows a user 13 in another example environment that includes multiple automated customized food generation machines.

FIG. 2A illustrates an exemplary screen for submitting a generic food request.

FIG. 2B illustrates another exemplary screen for submitting a generic food request.

FIG. 2C illustrates another exemplary screen for submitting a generic food request.

FIG. 2D illustrates an exemplary screen that includes an indicator that identifies an address for a compliant automated customized food generation machine that is able to generate one or more customized food items that are compliant with one or more food customization preferences of the user.

FIG. 2E illustrates an exemplary screen that includes an indicator that identifies directions for getting to an automated customized food generation machine.

FIG. 2F illustrates an exemplary screen that includes an indicator in the form of a map that identifies the location of an automated customized food generation machine relative to the location of a user.

FIG. 2G illustrates an exemplary screen that includes an indicator that identifies an address for a non-compliant automated customized food generation machine that is able to generate one or more non-compliant customized food items that are not in compliance with one or more food customization preferences of the user.

FIG. 3A shows a block diagram of a particular implementation of the automated customized food generation machine 10* of FIG. 1A illustrated as automated customized food generation machine 10a.

FIG. 3B shows a block diagram of another implementation of the automated customized food generation machine 10* of FIG. 1A illustrated as automated customized food generation machine 10b.

FIG. 3C shows a block diagram of another implementation of the automated customized food generation machine 10* of FIG. 1A illustrated as automated customized food generation machine 10c.

FIG. 3D shows a block diagram of a particular implementation of the network device 12* of FIG. 1B, 1C, or 1D illustrated as network device 12a.

FIG. 3E shows a block diagram of a particular implementation of the network device 12* of FIG. 1B, 1C, or 1D illustrated as network device 12b.

FIG. 4A shows another perspective of the generic food request obtaining module 302* of FIG. 3A, 3B, 3D, or 3E (e.g., the generic food request obtaining module 302′ of FIG. 3A, the generic food request obtaining module 302″ of FIG. 3B, the generic food request obtaining module 302′″ of FIG. 3D, or the generic food request obtaining module 302″″ of FIG. 3E) in accordance with various implementations.

FIG. 4B shows another perspective of the user preference information acquiring module 304* of FIG. 3A, 3B, 3D, or 3E (e.g., the user preference information acquiring module 304′ of FIG. 3A, the user preference information acquiring module 304″ of FIG. 3B, the user preference information acquiring module 304′″ of FIG. 3D, or the user preference information acquiring module 304″″ of FIG. 3E) in accordance with various implementations.

FIG. 4C shows another perspective of the automated customized food generation controlling module 306* of FIG. 3A, 3B, 3D, or 3E (e.g., the automated customized food generation controlling module 306′ of FIG. 3A, the automated customized food generation controlling module 306″ of FIG. 3B, the automated customized food generation controlling module 306′″ of FIG. 3D, or the automated customized food generation controlling module 306″″ of FIG. 3E) in accordance with various implementations.

FIG. 4D shows another perspective of the indicator presenting module 308* of FIG. 3A, 3B, 3D, or 3E (e.g., the indicator presenting module 308′ of FIG. 3A, the indicator presenting module 308″ of FIG. 3B, the indicator presenting module 308′″ of FIG. 3D, or the indicator presenting module 308″″ of FIG. 3E) in accordance with various implementations.

FIG. 5 is a high-level logic flowchart of a process, e.g., operational flow 500, according to some embodiments.

FIG. 6A is a high-level logic flowchart of a process depicting alternate implementations of the generic food request receiving operation 502 of FIG. 5.

FIG. 6B is a high-level logic flowchart of a process depicting alternate implementations of the generic food request receiving operation 502 of FIG. 5.

FIG. 6C is a high-level logic flowchart of a process depicting alternate implementations of the generic food request receiving operation 502 of FIG. 5.

FIG. 6D is a high-level logic flowchart of a process depicting alternate implementations of the generic food request receiving operation 502 of FIG. 5.

FIG. 7A is a high-level logic flowchart of a process depicting alternate implementations of the user preference information obtaining operation 504 of FIG. 5.

FIG. 7B is a high-level logic flowchart of a process depicting alternate implementations of the user preference information obtaining operation 504 of FIG. 5.

FIG. 7C is a high-level logic flowchart of a process depicting alternate implementations of the user preference information obtaining operation 504 of FIG. 5.

FIG. 7D is a high-level logic flowchart of a process depicting alternate implementations of the user preference information obtaining operation 504 of FIG. 5.

FIG. 8A is a high-level logic flowchart of a process depicting alternate implementations of the automated customized food generation directing operation 506 of FIG. 5.

FIG. 8B is a high-level logic flowchart of a process depicting alternate implementations of the automated customized food generation directing operation 506 of FIG. 5.

FIG. 8C is a high-level logic flowchart of a process depicting alternate implementations of the automated customized food generation directing operation 506 of FIG. 5.

FIG. 8D is a high-level logic flowchart of a process depicting alternate implementations of the automated customized food generation directing operation 506 of FIG. 5.

FIG. 8E is a high-level logic flowchart of a process depicting alternate implementations of the automated customized food generation directing operation 506 of FIG. 5.

FIG. 8F is a high-level logic flowchart of a process depicting alternate implementations of the automated customized food generation directing operation 506 of FIG. 5.

FIG. 8G is a high-level logic flowchart of a process depicting alternate implementations of the automated customized food generation directing operation 506 of FIG. 5.

FIG. 8H is a high-level logic flowchart of a process depicting alternate implementations of the automated customized food generation directing operation 506 of FIG. 5.

FIG. 8I is a high-level logic flowchart of a process depicting alternate implementations of the automated customized food generation directing operation 506 of FIG. 5.

FIG. 8J is a high-level logic flowchart of a process depicting alternate implementations of the automated customized food generation directing operation 506 of FIG. 5.

FIG. 8K is a high-level logic flowchart of a process depicting alternate implementations of the automated customized food generation directing operation 506 of FIG. 5.

FIG. 8L is a high-level logic flowchart of a process depicting alternate implementations of the automated customized food generation directing operation 506 of FIG. 5.

FIG. 8M is a high-level logic flowchart of a process depicting alternate implementations of the automated customized food generation directing operation 506 of FIG. 5.

FIG. 8N is a high-level logic flowchart of a process depicting alternate implementations of the automated customized food generation directing operation 506 of FIG. 5.

FIG. 9 is a high-level logic flowchart of another process, e.g., operational flow 900, according to some embodiments.

FIG. 10A is a high-level logic flowchart of a process depicting alternate implementations of the indicator presenting operation 908 of FIG. 9.

FIG. 10B is a high-level logic flowchart of a process depicting alternate implementations of the indicator presenting operation 908 of FIG. 9.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic, etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional external linking devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeroes and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media holds or transmits device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

The development and evolution of food vending machine technology has remained relatively stagnant over the last few decades even though there have been substantial technological advancements in the fields of microelectronics, automated manufacturing, and robotics. That is, today's food vending machines are not that different from vending machines of thirty or even forty years ago. With the exception of a very limited number of vending machines (such as coffee machines that allow users to make certain limited customizations of their order such as making their coffee sweeter or adding cream), the vast majority of today's food vending machines do not allow any customization of customer purchases. The vast majority of today's food vending machines only allow a user/customer to select and purchase a food item (e.g., candy bars, chips, sandwiches, drinks, and so forth) from a plurality of ready-to-eat or substantially ready-to-eat food items (note that some current food vending machines do offer food items that will need to be heated using a microwave oven) and that do not allow the user to customize their purchased food item.

With the advancement of microelectronics, robotics, and automated manufacturing technologies such as 3-D (three-dimensional) printing, it is envisioned that future food vending machines will not only be able to manufacture food items “on the spot” but will also be able to customize food items to the specific customization preferences of users. For example, with the development of 3-D (three-dimensional) printing technology, it is envisioned that customized food bars (e.g., customized energy bars) may be printed for users based on their preferences (e.g., if a user is allergic to peanuts, no peanut ingredients are used in forming an energy bar for the user). It is also envisioned that with the use of robotics, fully customized meals (e.g., customized sandwiches, breads, stews, soups, shakes, and so forth) may be manufactured using automated customized food vending machines that employ robotics or other forms of automation.

It should also be noted that many of today's sophisticated consumers are very concerned about the integrity (e.g., purity, cleanliness, sourcing, and so forth) of their food supplies. It seems as though that in recent years food supply contamination (e.g., salmonella, mad-cow disease, E. coli, and so forth) stories are being reported on a regular basis. That is, today's food supplies come from a vast number of food vendors located across the globe. For example, some food supplies originate from countries in the southern hemisphere that supply meats, fruits, and vegetables. There are also countless domestic farms and ranches throughout North America that supply chickens, pork, and beef. While the vegetable and fruit farms of California and Florida supplying the rest of America with a variety of produce. It is often very difficult for end consumers to ensure that the ingredients used to make, for example, ready-to-eat foods are of high purity and free of any disease or pesticides.

It is also envisioned that although future automated food vending machines will be able to generate customized food items that are customized for each customer/user, they will likely have limited ingredient supplies available for making customized food items. That is, because such machines will be relatively compact as is the case with current food vending machines, they will have limited ingredient supplies and may not always be able to fulfill the customization preferences of all users.

It is further envisioned that in the future, it may be desirable to have automated customized food vending machines that are able to generate customized food items for users with minimal input from the users. That is, it may be desirable to have a fully automated system that is capable of automatically generating one or more customized food items for a particular user in response to the particular user submitting a simple food request and without indicating any user customization preferences. In other words, it is envisioned that there may be a desirability for a “one-click” automated system that automatically generates one or more customized food items that are customized for a particular user and that are generated in response to the user submitting a simple request for food (e.g., a “generic food request”) with minimal or no food customization preferences of the user.

Accordingly, methods, systems, and articles of manufactures are presented herein that are designed to, among other things, receive a generic food request from a user for one or more food items, the generic food request to be received having no or minimal amount of user preference information of the user; obtaining from one or more sources other than the user and in response to the reception of the generic food request user preference information of the user that indicates one or more food customization preferences of the user including at least one or more ingredient integrity preferences of the user related to integrity of one or more ingredients; and directing the automated generation of one or more customized food items in response to the received generic food request and in accordance, at least in part, with the obtained user preference information. Thus, the one or more customized food items that are generated are personalized specifically for the particular user. As will be further described herein, in some embodiments such operations may be performed at an automated customized food generation machine (e.g., a vending machine that can dispense customized foods), while in other embodiments such operations may be performed at a network device (e.g., one or more servers, a workstation, and so forth) that may be in communication with one or more automated customized food generation machines.

The phrase “generic food request” as will be used herein may be in reference to user request or input that is a simple request for food with no or minimal additional information (e.g., minimal or no food customization preference information). In some cases, a “generic food request” may be submitted by a user through a “one-click” action by the user without the user providing any other additional input. As will be used herein, the phrase “customized food preference” or “customized food preferences” of a user may be in reference to the user's customization preferences for customizing a food item. Examples of customization preferences include, for example, preference for using beef ingredients from Kobe Japan and not from Britain, preference that aspartame be used as a sweetener, preferences that ingredients be included in the customized food item are free of tree nuts, sources of ingredients, such as beef, having been tested to be free of impurities such as certain bacterial agents, and so forth Other examples of customization preferences will be provided herein.

In various embodiments, references in the following to “compliant” automated customized food generation machine[s] may be in reference to automated customized food generation machines that have the capabilities (e.g., having, for example, sufficient amounts of preferred ingredients in sufficient quantities) to be able to presently generate at least one customized food item (herein “compliant” customized food item) that is in total compliance with the one or more customized food preferences of a user. In contrast, references in the following to “non-compliant” automated customized food generation machine[s] may be in reference to automated customized food generation machines that have capabilities to generate customized food items (herein “non-compliant” customized food items) that are partial or complete non-compliance with the one or more customized food preferences of a user.

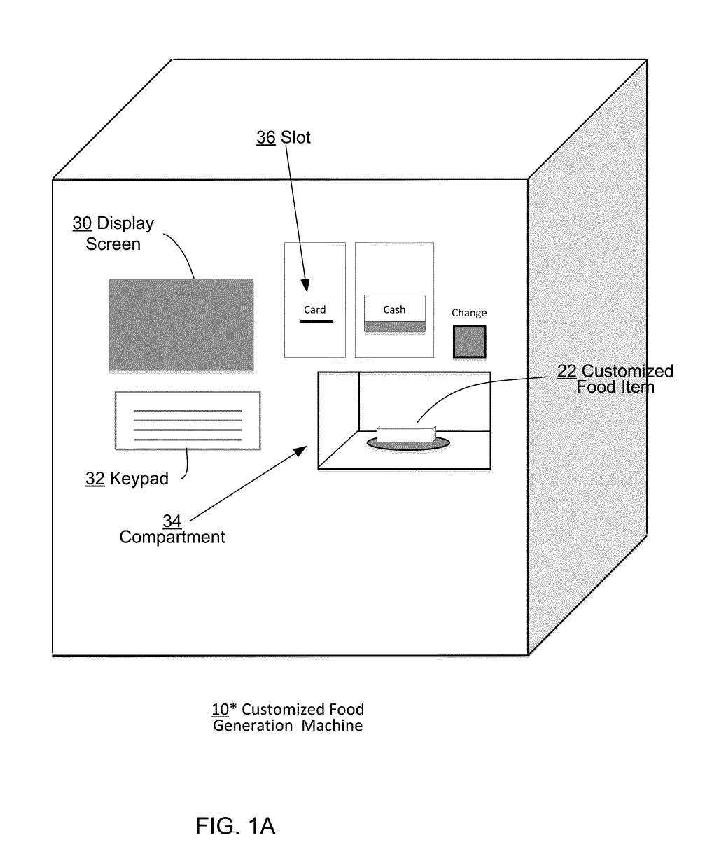

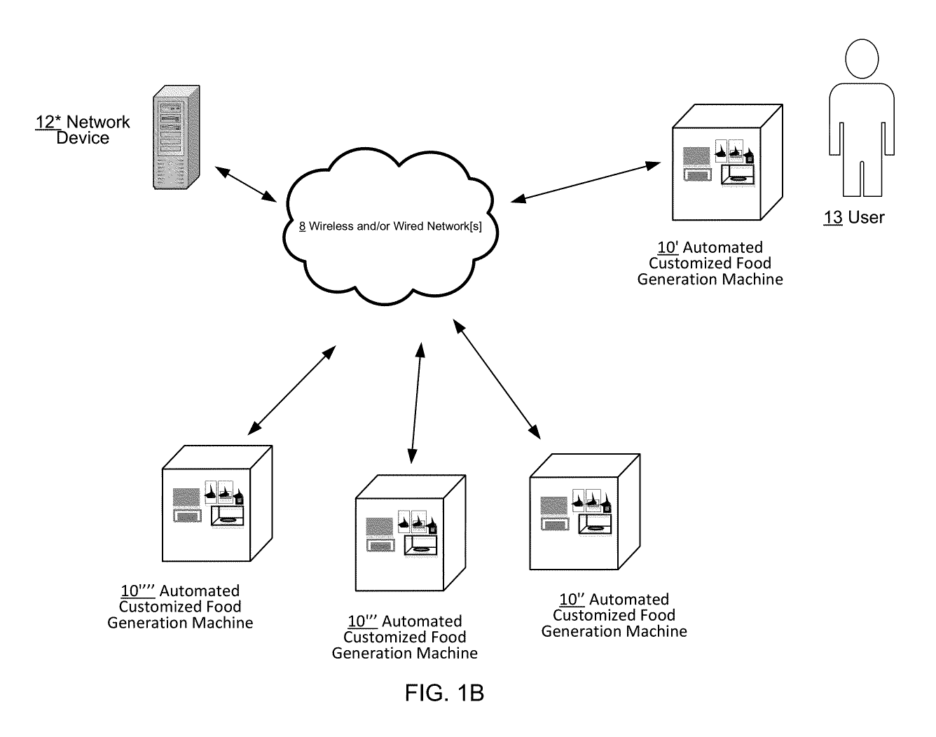

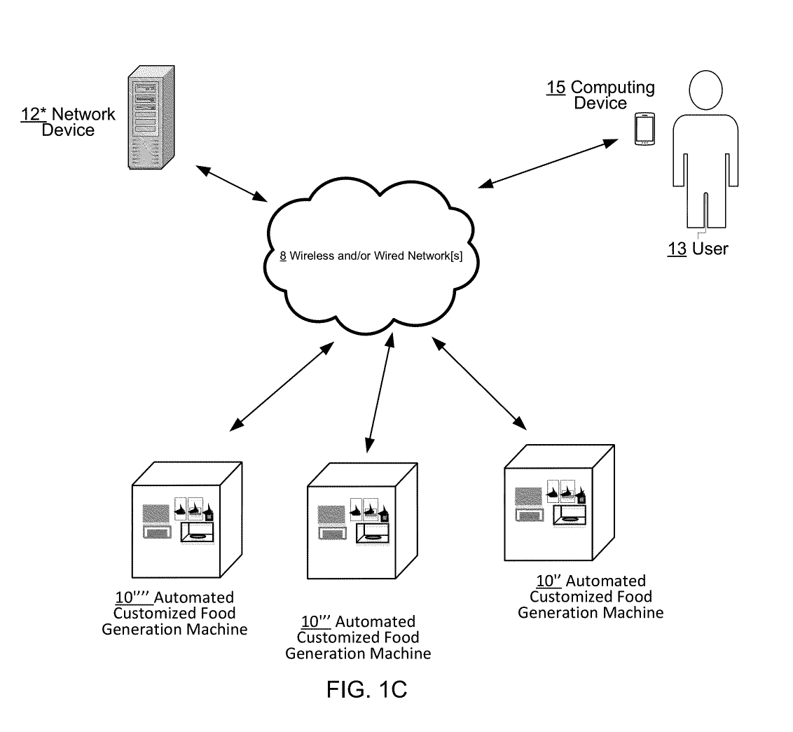

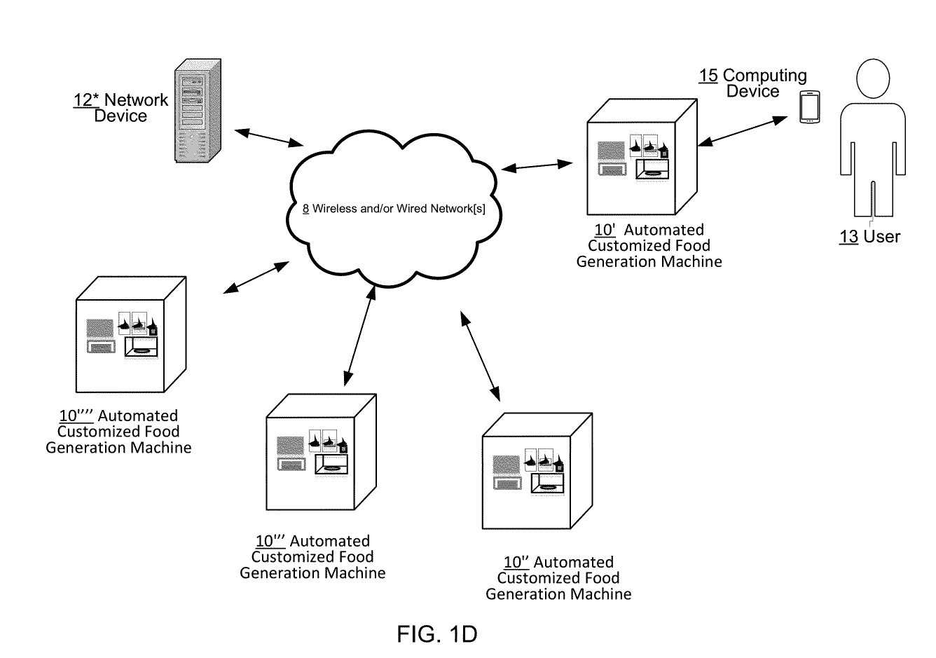

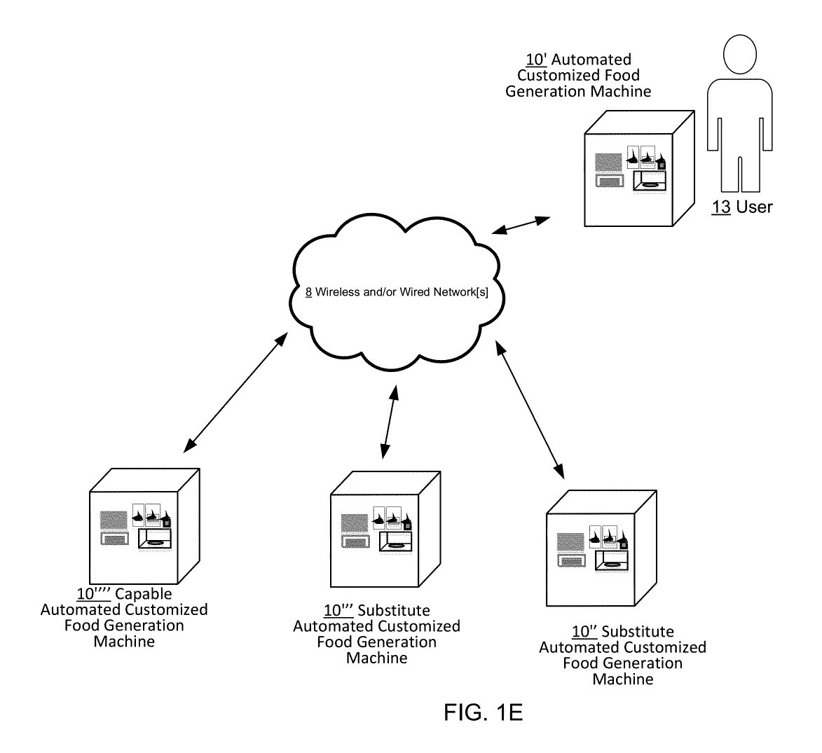

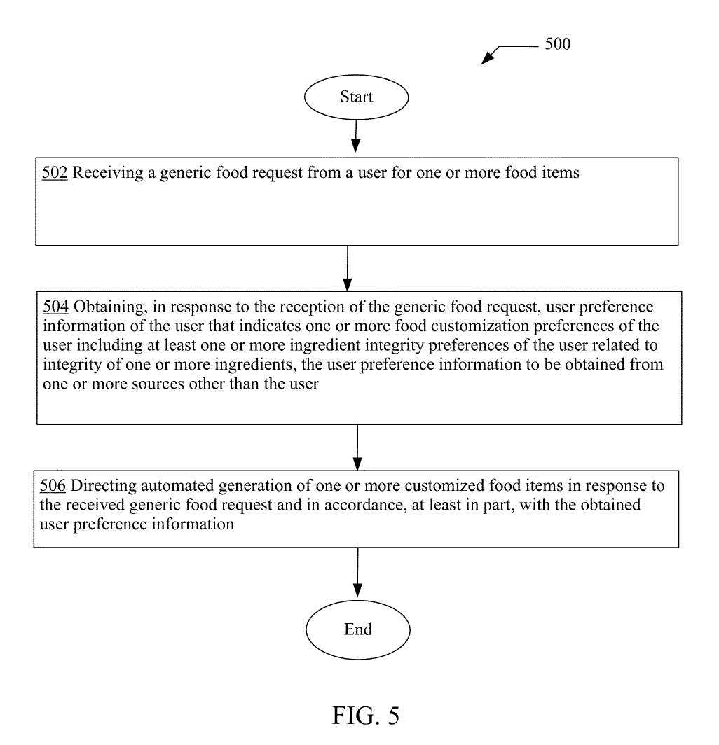

Referring now to FIG. 1A, which illustrates an exemplary automated customized food generation machine 10* that is designed to generate customized food items 22 in accordance with customization preferences of users. Note that although the exemplary automated customized food generation machine 10* illustrated in FIG. 1A is depicted as generating a customized food item 22 that is in the form of an energy bar, in alternative embodiments, the exemplary automated customized food generation machine 10* may generate other types of customized food items 22 (e.g., customized sandwiches such as customized burgers, customized stew, customized shakes, and so forth) having other food forms. In some embodiments, the exemplary automated customized food generation machine 10* may be a standalone system that is self-contained with all of the logic needed in order to execute the various operations to be described herein—see, for example, FIG. 5. Alternatively, at least some of the operations to be described herein may actually be executed by a network device 12* that may be in communication with the exemplary automated customized food generation machines 10* as illustrated, for example, in FIGS. 1B, 1C, and 1D.

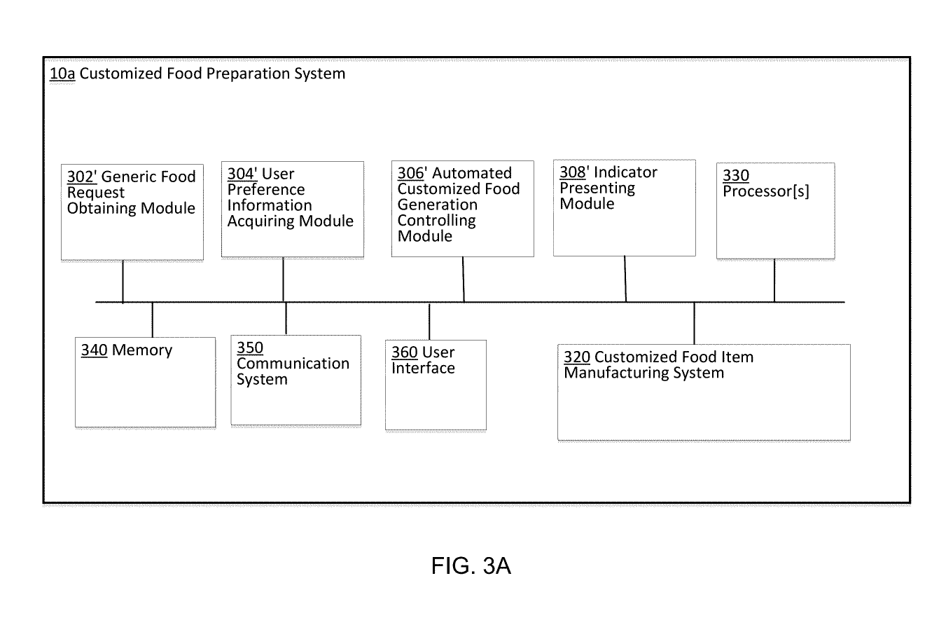

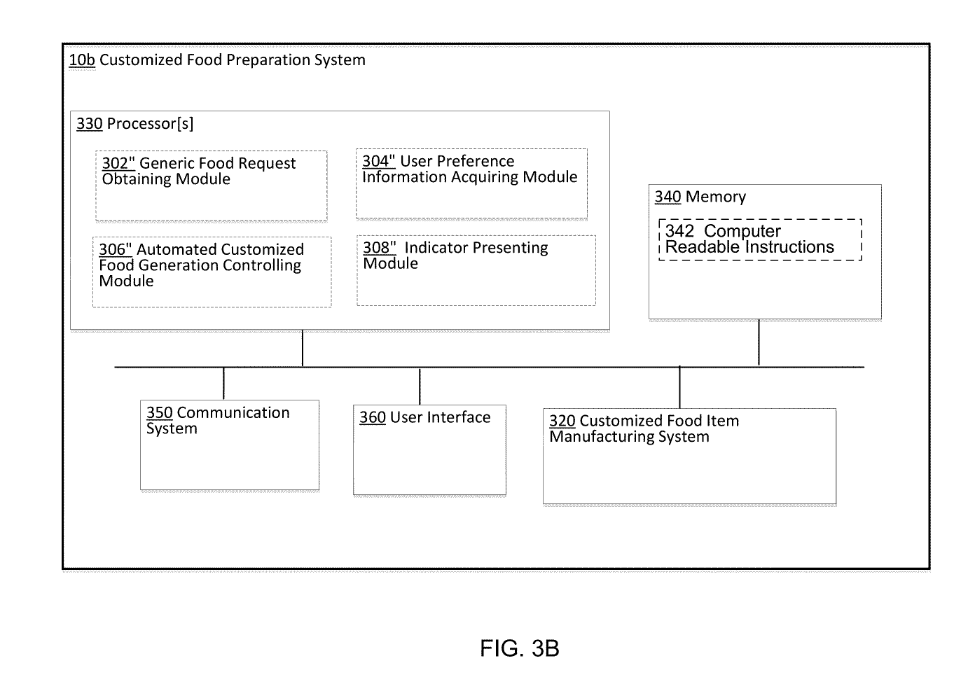

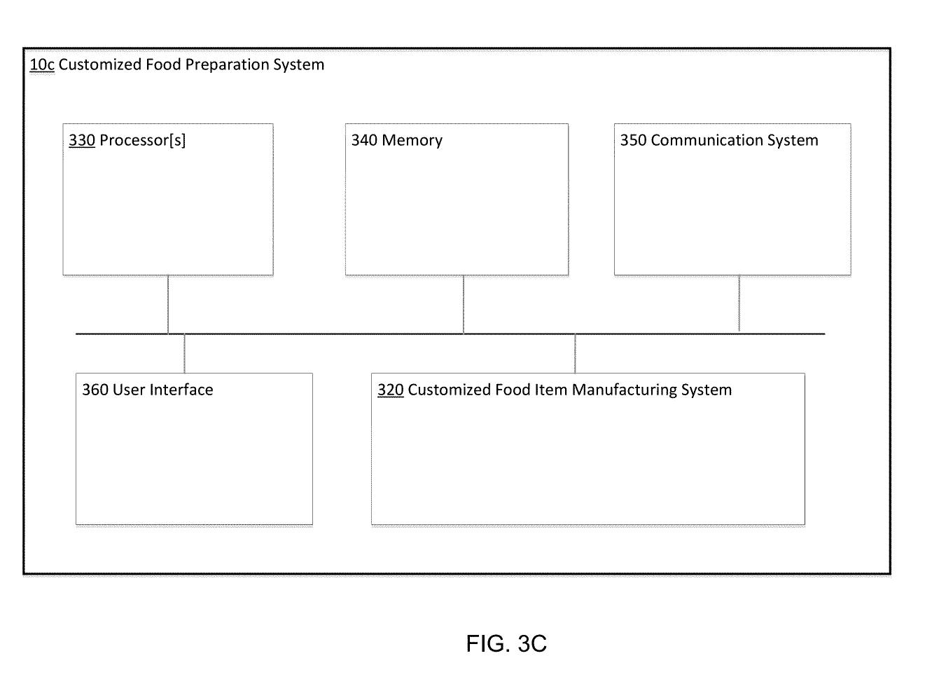

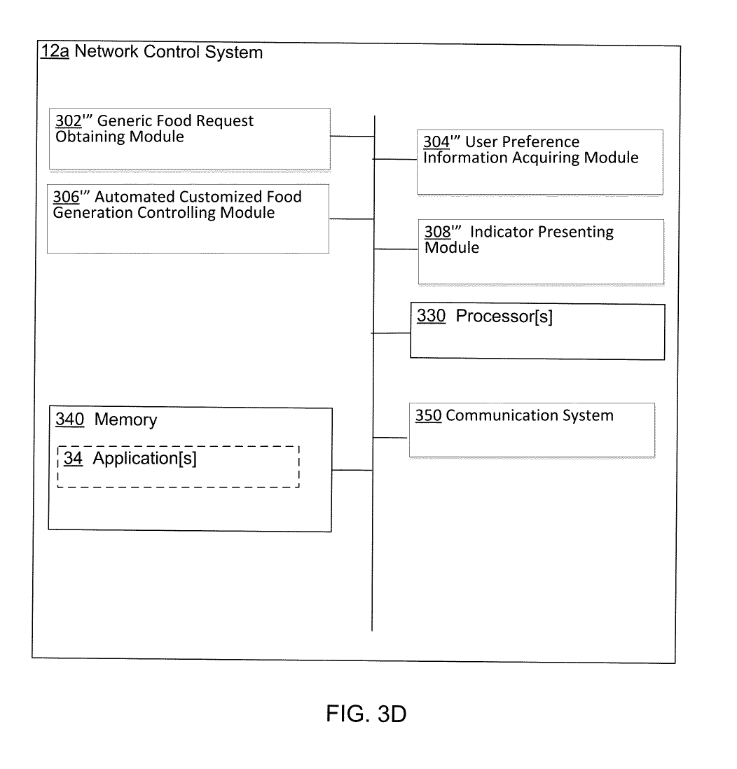

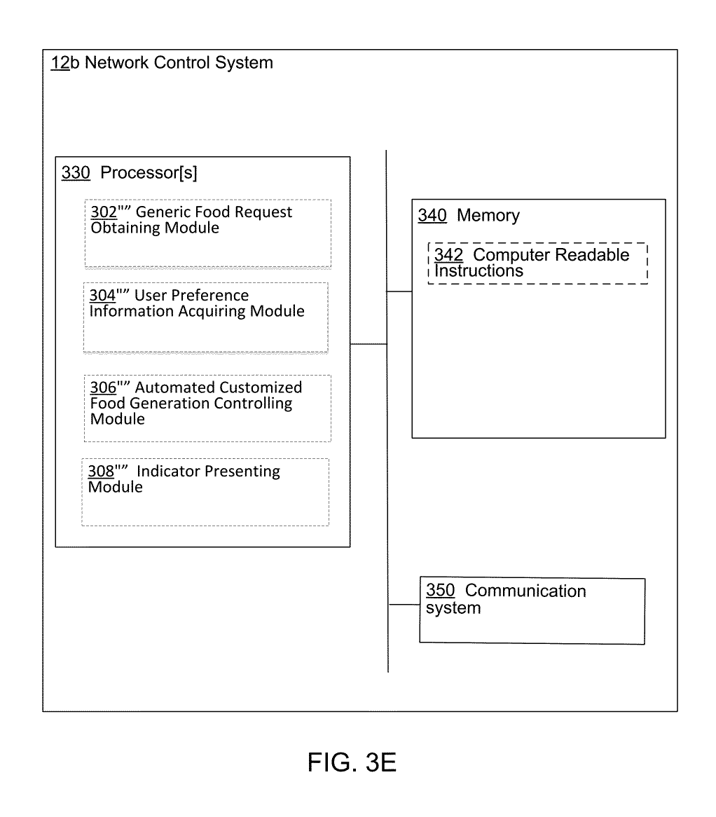

Note that FIGS. 3A, 3B, and 3C are three block diagrams of three different implementations of the exemplary automated customized food generation machine 10* of FIG. 1A illustrated in FIG. 3A as exemplary automated customized food generation machine 10a, illustrated in FIG. 3B as exemplary automated customized food generation machine 10b, and illustrated in FIG. 3C as exemplary automated customized food generation machine 10c. Further note that for purposes of the following description, “*” represents a wildcard. Thus, references in the following description to, for example, “automated customized food generation machine 10*” may be in reference to any one of, for example, the exemplary automated customized food generation machine 10a of FIG. 3A, to the exemplary automated customized food generation machine 10b of FIG. 3B, or to the exemplary automated customized food generation machine 10c of FIG. 3C (and/or to the automated customized food generation machine 10′, 10″, 10′″, or 10″″ of FIGS. 1B, 1C, 1D, and 1E.

Referring back to the exemplary automated customized food generation machine 10* of FIG. 1A, the exemplary automated customized food generation machine 10*, as illustrated, includes a display screen 30 (which may be a touchscreen), a keypad 32, a compartment 34 for dispensing one or more customized food items 22, and a slot 36 for inserting a credit card or a Smartcard.

Referring briefly now to FIGS. 3A and 3B, which illustrate two block diagrams of two different implementations of the exemplary automated customized food generation machine 10* of FIG. 1A when the exemplary automated customized food generation machine 10* is a “standalone” device that has, for example, most or all of the various logic needed in order to execute, for example, the various functionalities to be described herein. In particular, FIGS. 3A and 3B illustrate two extreme implementations of the standalone implementation of the automated customized food generation machine 10* of FIG. 1A in which all of the logic modules are implemented using purely hardware solutions (e.g., employing dedicated circuitry such as application specific integrated circuitry or ASIC) as illustrated in FIG. 3A (e.g., illustrated in FIG. 3A as automated customized food generation machine 10a) or in which all of the logic modules are implemented using software solutions (e.g., software executed by one or more processors or controllers) as illustrated in FIG. 3B (e.g., illustrated in FIG. 3B as automated customized food generation machine 10b).

Note that for purposes of simplicity and for ease of illustration, only the two extreme implementations (e.g., the “hardware” implementation as illustrated by the automated customized food generation machine 10a of FIG. 3A and the “software” implementation as illustrated by the automated customized food generation machine 10b of FIG. 3B) of the standalone automated customized food generation machine 10* are presented here. However, it is recognized that any combination of software and hardware solutions are possible and may be employed in various alternative embodiments. In any event, the “standalone” automated customized food generation machine 10a depicted in FIG. 3A is the “hard” implementation of the standalone implementation of the automated customized food generation machine 10* of FIG. 1A where all of the logic modules (e.g., the generic food request obtaining module 302′, the user preference information acquiring module 304′, the automated customized food generation controlling module 306′, and the indicator presenting module 308′) are implemented using purely hardware solutions (e.g., circuitry such as application specific integrated circuit or ASIC). In contrast, the automated customized food generation machine 10b of FIG. 3B is the soft implementation of the standalone implementation of the automated customized food generation machine 10* of FIG. 1A where all of the logic modules (e.g., the generic food request obtaining module 302″, the user preference information acquiring module 304″, the automated customized food generation controlling module 306″, and the indicator presenting module 308″) are implemented using software solutions (e.g., programmable instructions in the form of computer readable instructions 342 being executed by hardware such as one or more processors 330) as illustrated in, for example, FIG. 3B. Note that FIG. 3C illustrates a block diagram (illustrated in FIG. 3C as automated customized food generation machine 10c) of a particular implementation of the automated customized food generation machine 10* of FIG. 1 when the automated customized food generation machine 10* is not a standalone device (e.g., when one or more logic modules may be remotely located, such as at a network device 12*, as illustrated in FIG. 1B)

Turning now to FIGS. 1B, 1C, 1D, and 1E, which illustrate various exemplary scenarios of a user 13 interacting with a network device 12* and/or with one or more automated customized food generation machines 10* in accordance with various embodiments. These scenarios are presented herein in order to facilitate understanding of various operations and concepts to be described herein. Note that in the exemplary scenarios illustrated in FIGS. 1B, 1C, 1D, and 1E, the network device 12* or one of the automated customized food generation machines 10* (e.g., the automated customized food generation machine 10′ that the user 13 is interfacing with as illustrated, for example, in FIG. 1B) may actually implement the various operations to be described herein—see, for example, operational flow 500 of FIG. 5.

In the example scenario of FIG. 1B, the network device 12* (e.g., one or more servers, a workstation, and so forth) is illustrated as being in communication with a plurality of automated customized food generation machines 10* (e.g., automated customized food generation machines 10′, 10″, 10′″, and 10″″) via one or more wireless and/or wired networks 8 (e.g., local area network or LAN, wireless local area network or WLAN, wide area network or WAN, cellular data network—Ethernet, public switch telephone network, and so forth). FIG. 1B also shows a user 13 directly interfacing or interacting with an automated customized food generation machine 10′ (herein “interfacing” automated customized food generation machine 10′) by submitting a simple generic food request through the user interface (e.g., a touchscreen or keyboard) of the interfacing automated customized food generation machine 10′. In some implementations, the user 13 may submit a generic food request (a request for one or more generic food items) that includes minimal or no user preference information of the user 13 that indicates food customization preferences of the user 13. For example, in some cases, the generic food request may merely be a request that the user 13 be fed, while in other cases, the generic food request may simply identify a request for a particular meal (e.g., breakfast, lunch, afternoon snack, and so forth). In still other cases, the generic food request may merely identify a particular type of food item (e.g., a request for “energy bar,” a request for “hamburger,” and so forth without any additional customization information).

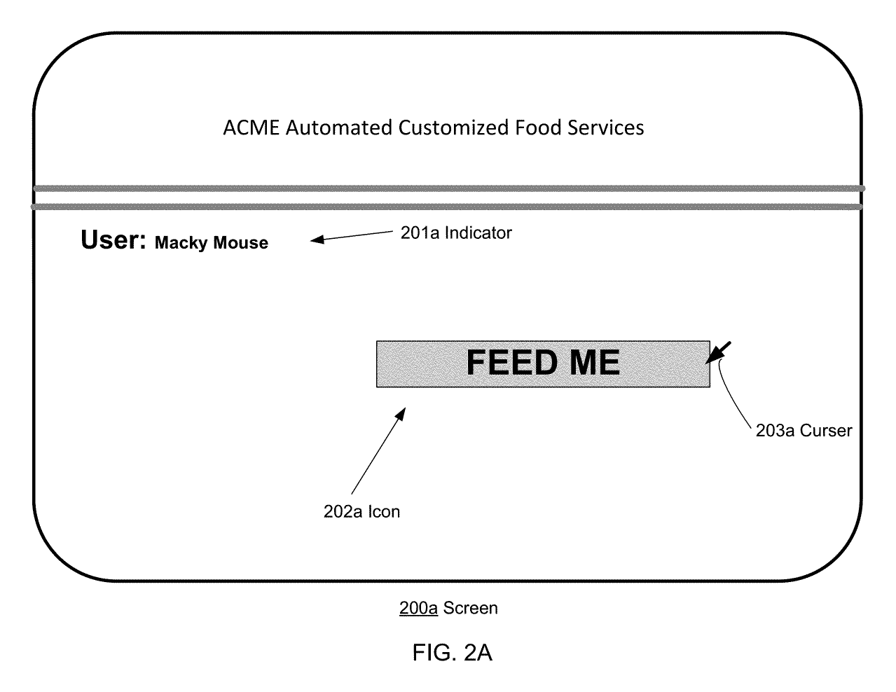

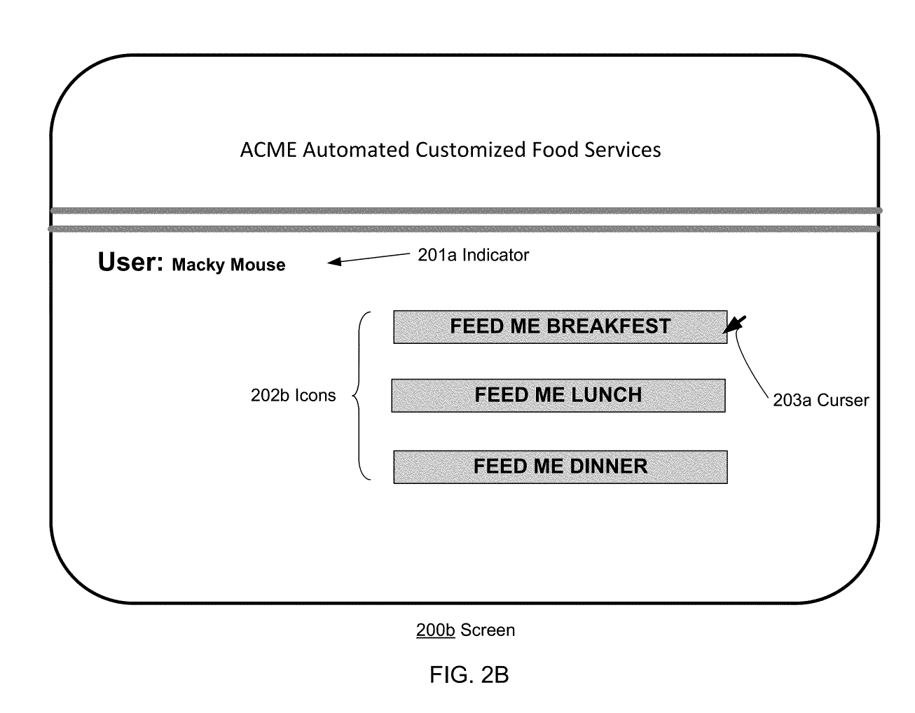

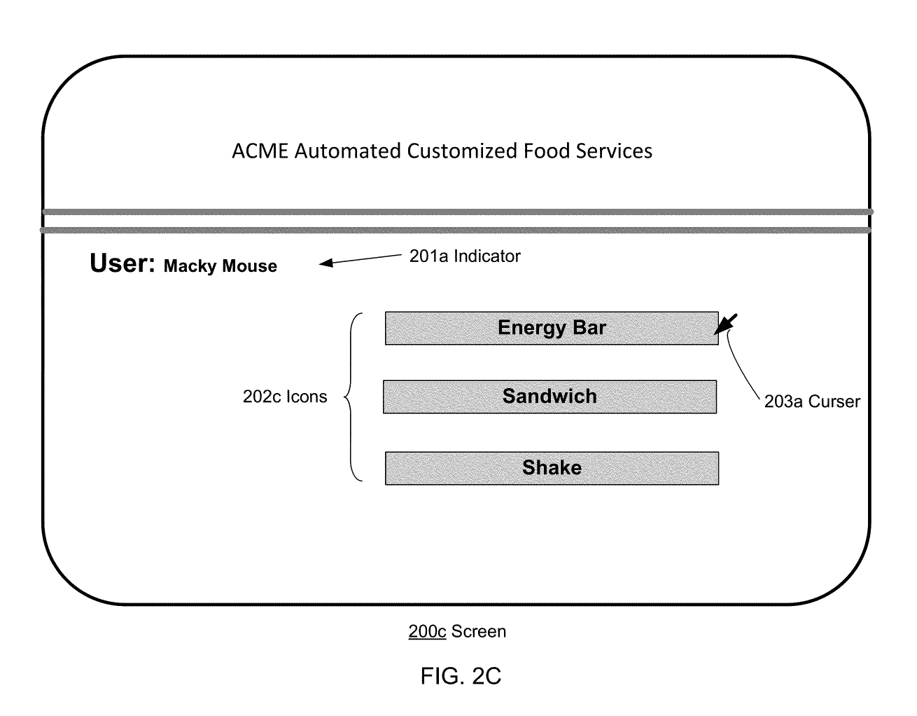

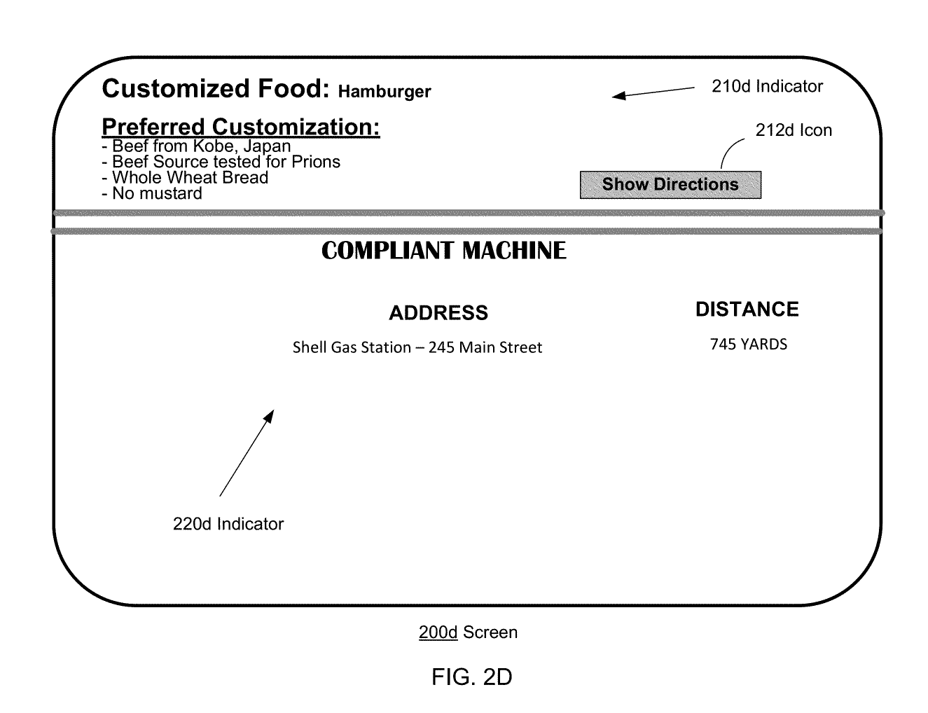

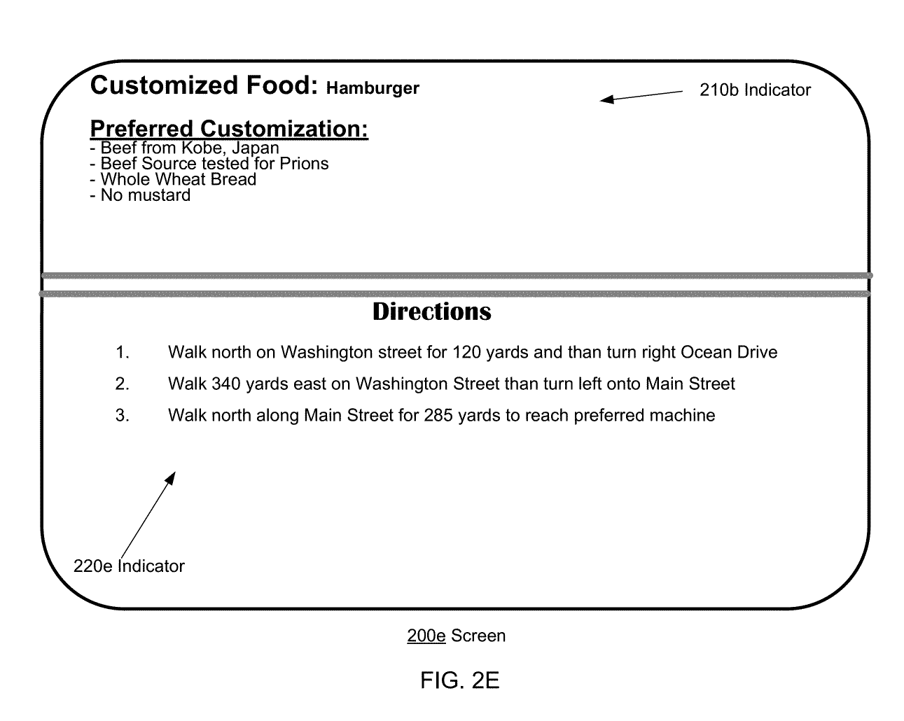

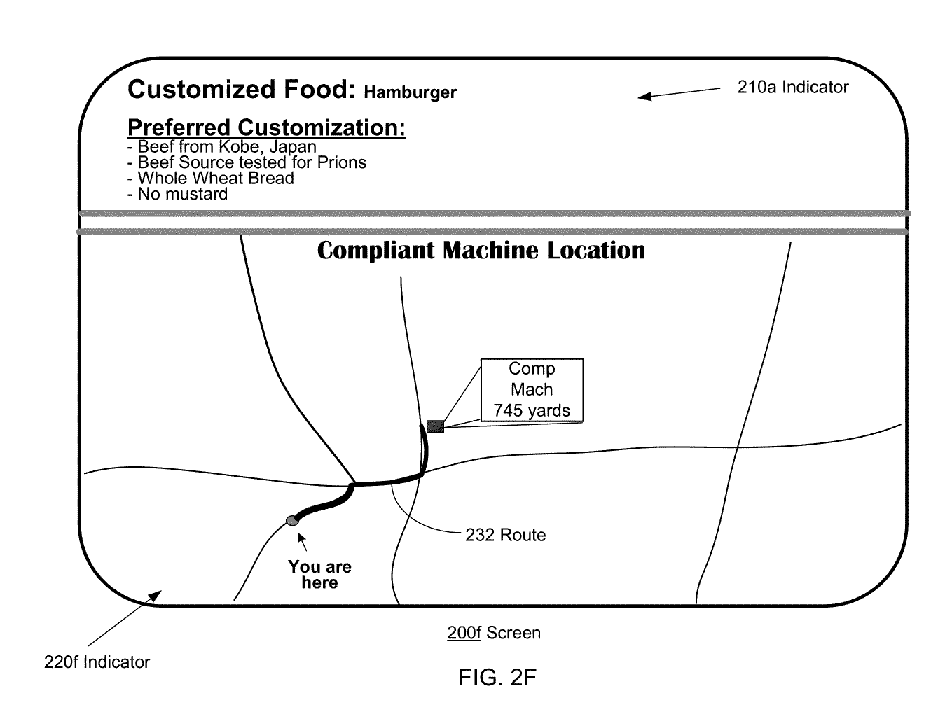

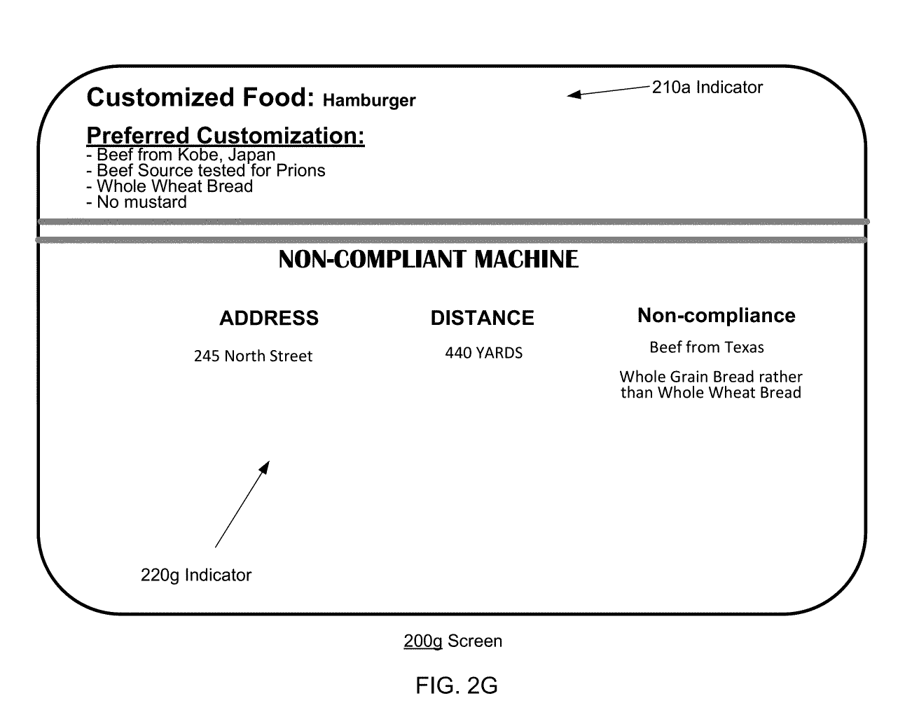

In order to facilitate the automated retrieval of user food customization preference information of the user 13, the user 13 may provide user identification information (e.g., provide username and/or password by directly inputting such information through a keyboard or touchscreen, inputting such information via Smartcard or credit card, or by biometric verification) to the automated customized food generation machine 10′. In some cases, the generic food request may be submitted by the user 13 when the user 13 “clicks” an onscreen button as displayed through a display 30 of the interfacing automated customized food generation machine 10′. Note that FIGS. 2A, 2B, and 2C illustrate exemplary screens 200a, 200b, and 200c that may be displayed by the automated customized food generation machine 10′ and that includes one or more onscreen buttons (e.g., icons 202a, 202b, and 202c) that may be “clicked” by the user 13 in order to submit a generic food request.

Upon receiving the generic food request from the user 13, the interfacing automated customized food generation machine 10′ may notify the network device 12* of the submission of the generic food request by the user 13 (in some cases, by simply passing the generic food request to the network device 12*). In response to the submission of the generic food request, the network device 12* may obtain user preference information of the user 13 from one or more sources other than the user 13 (e.g., obtaining from memory 340 or from the Internet) that indicates one or more food customization preferences of the user 13 including at least one or more ingredient integrity preferences of the user 13 related to integrity of one or more ingredients for use in generating one or more customized food items for the user 13.

If the network device 12* determines that the interfacing automated customized food generation machine 10′ that the user 13 is interfacing with is a “compliant” machine (e.g., a compliant automated customized food generation machine) capable of currently (e.g., capable at the time of the determination) generating one or more customized food items 22 that are in full compliance with the one or more food customization preferences of the user 13 then the network device 12* may direct or instruct the interfacing automated customized food generation machine 10′ to generate one or more “compliant” customized food items 22. Alternatively, if the network device 12* determines that the automated customized food generation machine 10′ that the user 13 is interfacing with is a “non-compliant” machine (e.g., a non-compliant automated customized food generation machine) that is incapable of currently generating one or more fully compliant customized food items 22, then the network device 12* may determine which, if any, of the other automated customized food generation machines 10″, 10′″, and 10″″ that are near the user 13 are compliant machines.

If the network device 12* finds that at least one of the other automated customized food generation machines 10″, 10′″, and 10″″ is a compliant machine, then the network device 12*, via the user interface (e.g., display 30) of the interfacing automated customized food generation machine 10′, may direct or instruct the user 13 to go to the compliant machine (e.g., the automated customized food generation machine 10″, 10′″, or 10″″). Upon detecting that the user 13 has traveled to and reached the compliant machine (e.g., automated customized food generation machine 10″, 10′″, or 10″″), the network device 12* may direct the compliant machine to generate one or more compliant customized food items 22. The detection as to whether a user 13 has reached the compliant machine may be accomplished by a variety of means including through biometric sensing means (e.g., facial or fingerprint recognition) or by simply detecting the inputting by the user 13 of username/password at the compliant machine.

Note that for any particular user and for any particular food item, any one of the automated customized food generation machines 10′, 10″, 10′″, and 10″″ may be a “compliant” or a “non-compliant” machine. That is whether a particular automated customized food generation machine 10′, 10″, 10′″, or 10″″ is a compliant machine will depend on the food customization preferences of the particular user 13 and in some cases, the type of meal the user 13 is requesting. Note also that food customization preferences of a particular user 13 may not only be specific to the particular user 13 but may be specific to a particular meal or type of dish. For example, a user 13 may have one set of food customization preferences for lunch, and another set of food customization preferences for dinner. Alternatively, the same user 13 may have a set of food customization preferences for hamburgers (e.g., use only beef ingredients from the U.S.) and another set of food customization preferences for an energy bar (e.g., prefer peanut-chocolate chip bars).

There are a number of ways to determine which ones of the plurality of automated customized food generation machines 10* (e.g., automated customized food generation machines 10′, 10″, 10′″, and 10″″) are compliant or non-compliant machines with respect to one or more food customization preferences of the user 13. For example, in some embodiments, the network device 12* may make such a determination based on ingredient supply status data of each of the automated customized food generation machines 10* that may be stored in memory 340 (see FIG. 3D or 3E). Alternatively, the network device 12* may query each of the automated customized food generation machines 10* in order to determine whether any of the automated customized food generation machines 10* has the right ingredients in sufficient quantities to currently generate one or more compliant customized food items that are in compliance with one or more food customization preferences of the user 13.

Alternatively or additionally, such queries may allow the network device 12* to determine which of the automated customized food generation machines 10* are able to currently generate partially compliant or completely non-compliant customized food items that are partially or fully non-compliant with the one or more food customization preferences of the user 13. That is, in some cases, the user 13 may be directed to a fully compliant machine (e.g., a compliant automated customized food generation machine 10* that is able to currently generate one or more customized food items 22 in full compliance with the one or more food customization preferences of the user 13) while in other cases, the user 13 may be directed to a non-compliant machine (e.g., a non-compliant automated customized food generation machine 10* that is only able to currently generate one or more non-compliant customized food items that are only in partial compliance with or totally not in compliance with the one or more food customization preferences of the user 13).

Turning now to FIG. 1C, which illustrates another scenario that is a slight variation from the scenario illustrated in FIG. 1B. In this example scenario of FIG. 1C, a user 13 is shown interacting with the network device 12* via a computing device 15 (e.g., a Smartphone, a tablet computer, a workstation, a laptop, and so forth). Thus, the computing device 15 performs some of the same functions (e.g., receiving a generic food request and directing the user 13 to a compliant or non-compliant machine) that is performed by the interfacing automated customized food generation machine 10′ of FIG. 1B. As in the example scenario of FIG. 1B, the network device 12* may further be in communication with a plurality of automated customized food generation machines 10″, 10′″, and 10″″ via one or more wireless and/or wired networks 8. Thus, the only difference between this example scenario of FIG. 1C and example scenario depicted in FIG. 1B is that the user 13 is shown communicating with the network device 10* via the computing device 15 rather than through the interfacing automated customized food generation machine 10′ as was illustrated in FIG. 1B.

In the example scenario of FIG. 1C, the user 13 may transmit to the network device 12*, via the computing device 15, the generic food request with minimal or no food customization preferences of the user 13. The user 13, via the computing device 15, may also provide to the network device 12* user verification (e.g., username and/or password, biometric verification, and so forth). In some cases, the user 13 may submit such a generic food request by clicking an on-screen button that is displayed on the user display of the computing device 15 as illustrated, for example, in FIGS. 2A, 2B, and 2C. In response to receiving the generic food request, the network device 12* and based on user verification information may retrieve user preference information of the user 13 that indicates one or more food customization preferences (e.g., ingredient preferences) of the user 13 including at least one or more ingredient integrity preferences (e.g., ingredient purity or sourcing preferences) of the user 13.

Based on the obtained user preference information and based on ingredient supply statuses of each of the automated customized food generation machines 10′, 10″, and 10′″, the network device 12* may direct (via the computing device 15) the user 13 to one of the automated customized food generation machines 10′, 10″, and 10′″. In some cases, the network device 12* may direct the user 13 to a compliant machine, while in other cases, such as when there are no compliant machines located near the user 13 (e.g., within one mile of the current location of the user 13), the network device 12* may direct the user 13 to a non-compliant machine (which may be able to generate one or more partially compliant customized food items). Once the user 13 is detected (e.g., via user name/password entry by the user 13 or via biometric verification) as being at the compliant or non-compliant machine (e.g., the compliant or non-compliant automated customized food generation machine 10*), the compliant or non-compliant machine will be automatically directed to generate the one or more compliant or non-compliant customized food items 22.

Turning now to FIG. 1D, which illustrate yet another exemplary scenario that is a slight variation of the exemplary scenarios illustrated in FIGS. 1B and 1C. In this example scenario, the user 13 at least initially communicates with an interfacing automated customized food generation machine 10′ via a computing device 15 (e.g., a mobile device such as a Smartphone or tablet computer, or a workstation). In some cases and for this particular scenario, the automated customized food generation machine 10′ may act as a simple conduit channeling information between the computing device 15 and the network device 12*, which may perform its previously described functionalities (e.g., retrieving the user preference information of the user 13 in response to submission of a generic food request from the user 13, determining which of the automated customized food generation machines 10* are compliant or non-compliant machines, and directing the user 13 to a compliant or non-compliant machine). Alternatively, some of the functionalities (e.g., determining which of the automated customized food generation machines 10* are compliant or non-compliant machines and directing the user 13 to a compliant or non-compliant machine) may actually be performed by the interfacing automated customized food generation machine 10′.

The computing device 15 may again be used to submit a generic food request, and to identify a compliant or non-compliant automated customized food generation machine 10*. In some cases, the computing device 15 may supply to the automated customized food generation machine 10′ and/or the network device 12* location data (e.g., GPS data) in order to identify the current location of the user 13. Such information may be useful in some cases in order to determine which automated customized food generation machine 10* the user 13 should be directed to after the user 13 has submitted a generic food request. That is, in many cases, it is generally preferable to direct the user 13 to a nearby machine (e.g., nearby automated customized food generation machine 10*) rather than a machine that is far away from the user 13. It may also be generally preferable at least in some cases to direct the user 13 to an automated customized food generation machine 10* (compliant or non-compliant machine) that is located along or near the historical travel paths of the user 13 (e.g., usually a user will prefer going to locations that he or she is familiar with rather than places that he or she is unfamiliar with).

Referring now to the example scenario of FIG. 1E, in which the various functionalities (e.g., retrieving the user preference information of the user 13 in response to submission of a generic food request from the user 13, determining which of the automated customized food generation machines 10* are compliant or non-compliant machines, and directing the user 13 to a compliant or non-compliant machine) that are performed by the network device 12* of FIG. 1B may be performed by the interfacing automated customized food generation machine 10′ of FIG. 1E. That is, there is no network device 12* in this example scenario of FIG. 1E. Instead, the interface automated customized food generation machine 10′ may be in communication with the other automated customized food generation machines 10″, 10′″, and 10″″ via one or more wireless and/or wired networks 8. In some cases, if the interfacing automated customized food generation machine 10′ determines that it is unable to currently generate one or more compliant food items 22 for the user 13 that are in full compliance with the one or more food customization preferences of the user 13, then the interfacing automated customized food generation machine 10′ may direct or instruct the user 13 to go to one of the other automated customized food generation machines 10″, 10′″, and 10″″ that have been determined to be, for example, a compliant or partially compliant machine (e.g., an automated customized food generation machine 10* that is able to currently generate one or more customized food items 22 that are fully or partially compliant with one or more food customization preferences of the user 13 that are related to the food requested through the generic food request).

If the interfacing automated customized food generation machine 10′ does indeed direct the user 13 to one of the other automated customized food generation machines 10″, 10′″, and 10″″, then the automated customized food generation machine 10′ may instruct the destination machine (e.g., automated customized food generation machine 10″, 10′″, or 10″″) to only generate the fully compliant or partially compliant customized food items 22 only when the user 13 is detected as being at or approaching the destination machine (e.g., the automated customized food generation machine 10″, 10′″, or 10″″).

Note that in various embodiments, the interfacing automated customized food generation machine 10′ may be in communication with the other automated customized food generation machines 10″, 10′″, and 10″″ in order to at least determine their capabilities (e.g., ingredient supply statuses of the other automated customized food generation machines 10″, 10′″, and 10″″). That is, in some cases, the interfacing automated customized food generation machine 10′ may be intermittently or continuously provided by the other automated customized food generation machines 10″, 10′″, and 10″″ the ingredient supply status data of the other automated customized food generation machines 10″, 10′″, and 10″″. Alternatively, the interfacing automated customized food generation machine 10′ may query the other automated customized food generation machines 10″, 10′″, and 10″″ for such ingredient supply data only when needed (e.g., such as when it determines that it is unable to generate customized food items 22 that are in full compliance with the one or more food customization preferences of the user 13). In still other embodiments, the interfacing automated customized food generation machine 10′ may query the other automated customized food generation machines 10″, 10′″, and 10″″ as to whether the other automated customized food generation machines 10″, 10′″, and 10″″ are able to generate a particular identified customized food item 22 (e.g., identifying only the food customization preferences of the user 13 such as a preference for breakfast that includes sausage from Oscar Meyer and preference for eggs from a farm that has been tested to be free of bacterial or viral agents).

Referring now to FIGS. 2A, 2B, and 2C, which illustrate three example screens 200a, 200b, and 200c that may be displayed to a user 13 through the interfacing automated customized food generation machine 10′ of FIG. 1B or 1E or through the computing device 15 of FIG. 1C or 1D. In various embodiments, the three example screens 200a, 200b, and 200c may be used by a user 13 in order to submit a generic food request. Turning particularly now to FIG. 2A illustrating example screen 200a that includes indicator 201a that indicates the name of a user 13 (e.g., “Macky Mouse”), an icon 202a that is a “feed me” button that a user 13 may click in order to submit a generic food request, and a cursor 203a for selecting and clicking the “feed me” button (e.g., icon 202a) using a mouse. Note that by simply clicking the “feed me” button, the user 13 submits a generic food request that does not identify any specific food item or any food customization preferences.

Turning to FIG. 2B, which illustrates another example screen 200b that may be displayed by the interfacing automated customized food generation machine 10′ of FIG. 1B or 1E or by the computing device 15 of FIG. 1C or 1D. In this example screen 200b, there are three icons 202b that allow a user 13 to select from three different meal options (e.g., “feed me breakfast,” “feed me lunch,” or “feed me dinner”). Note that for this particular user 13 (e.g., Macky Mouse”), there may be three sets of customized food preferences associated with each type of meal (e.g., customized food preferences for breakfast, customized food preferences for lunch, and customized food preferences for dinner). Thus, if the user 13 selects or clicks the “feed me breakfast” button, then the network device 12* of FIG. 1B, 1C, or 1D or the interfacing automated customized food generation machine 10′ of FIG. 1D or 1E may only retrieve the food customization preferences of the user 13 related to breakfast.

Based, at least in part, on the retrieved food customization preferences of the user 13 related to breakfast (as well as the ingredient supply status data of the automated customized food generation machines 10*), the network device 12* of FIG. 1B, 1C, or 1D or the interfacing automated customized food generation machine 10′ of FIG. 1D or 1E may determine which of the automated customized food generation machines 10* that are determined to be near the user 13 including the interfacing automated customized food generation machine 10′ is a compliant, partially compliant, or completely non-compliant machine. Note that by selecting one of the options (e.g., feed me breakfast, feed me lunch, or feed me dinner), the user submits a generic food request with very limited food customization preference information (e.g., only information that indicates a preference that the user 13 be fed one of a breakfast, a lunch, or a dinner).

Referring to FIG. 2C, which illustrates yet another example screen 200c that may be displayed by the interfacing automated customized food generation machine 10′ of FIG. 1B or 1E or by the computing device 15 of FIG. 1C or 1D. In this example screen 200c, there are three icons 202c that allow a user 13 to select from three different food type options (e.g., “energy bar,” “sandwich,” or “shake”). Note that for this particular user 13 (e.g., Macky Mouse”), there may be three sets of customized food preferences associated with each type of foods (e.g., customized food preferences for energy bars, customized food preferences for sandwiches, and customized food preferences for shakes). Thus, if the user 13 selects or clicks the “energy bar” button, then the network device 12* of FIG. 1B, 1C, or 1D or the interfacing automated customized food generation machine 10′ of FIG. 1D or 1E may only retrieve the food customization preferences of the user 13 related to energy bars.

Based, at least in part, on the retrieved food customization preferences of the user 13 related to energy bars (as well as the ingredient supply status data of the automated customized food generation machines 10*), the network device 12* of FIG. 1B, 1C, or 1D or the interfacing automated customized food generation machine 10′ of FIG. 1D or 1E may determine which of the automated customized food generation machines 10* that are determined to be near the user 13 including the interfacing automated customized food generation machine 10′ is a compliant, partially compliant, or completely non-compliant machine. Note that by selecting one of the options (e.g., energy bar, sandwich, or shake), the user submits a generic food request with very limited food customization preference information (e.g., only information that indicates a preference that the user 13 wants an energy bar, a sandwich, or a shake).

Referring now to FIGS. 2D, 2E, 2F, and 2G, which illustrate exemplary screens that may be displayed through a computing device 15 (see, for example, FIG. 1C or 1D) or through an automated customized food generation machine 10′ (see, for example, FIG. 1B or 1E) in order to direct a user 13 to, for example, a compliant or non-compliant automated customized food generation machine 10*. Referring particularly now to FIG. 2D, which illustrates an example screen 200d that includes indicator 210d that indicates the customized food item (e.g., hamburger) requested by the user 13 and that indicates various food customization preferences (e.g., preferences that beef from Kobe, Japan, be used, preference that the beef source be tested for prions, that whole wheat bread be used, and that no mustard be used) of the user 13. Example screen 200d further includes an indicator 220d that indicates the location (e.g., the address) of a compliant machine and the distance to the compliant machine from the current location of the user 13.

Example screen 200d further includes icon 212d, which may be “clicked” or selected by the user 13 in order to display directions or instructions for reaching the compliant machine from a current location of the user 13 as illustrated in FIG. 2E. That is, FIG. 2E illustrates an example screen 200e that may be displayed once the “show directions” icon 212d of FIG. 2D is selected or “clicked.” Alternatively, such a screen 200e may be automatically displayed without requiring the user 13 to first click or select, for example, an icon 212d of a preceding screen 200d. As illustrated, the example screen 200e includes indicator 220e that is in textual form that indicates directions/instructions to the compliant machine from the current location of the user 13.

Turning now to FIG. 2F, which illustrates another example screen 200f that shows the mapped location of a compliant machine relative to the current location of a user 13. That is, screen 200f includes an indicator 220f in graphical form of a map that indicates the location of a compliant machine and that indicates a route 232 from the current location of the user 13 to the location of the compliant machine that the user 13 may use in order to reach the compliant machine.

Referring now to FIG. 2G, which shows an example screen 200g that identifies the location of a non-compliant machine. In particular, the example screen 200g includes indicator 220g that textually indicates the address (e.g., 245 North Street) of the non-compliant machine, the distance (e.g., 440 yards) to the non-compliant machine from the current location of a user 13, and the non-compliance (e.g., beef from Texas and whole grain bread rather than whole wheat bread) of the customized food item (e.g., hamburger) that may be generated by the non-compliant machine.

Referring now to FIGS. 3A and 3B, which as briefly described above, illustrate two block diagrams of two different implementations of the automated customized food generation machine 10* of FIG. 1A when the automated customized food generation machine 10* is a standalone device with all of the necessary logic to perform the various operations to be described below with respect to the flow process of FIG. 5. In particular, and as will be further described herein, FIG. 3A illustrates an automated customized food generation machine 10a that is the “hardwired” or “hard” implementation of a standalone automated customized food generation system that can implement the operations and processes to be described herein. The automated customized food generation machine 10a may comprise certain logic modules including, for example, a generic food request obtaining module 302′, a user preference information acquiring module 304′, an automated customized food generation controlling module 306′, and/or an indicator presenting module 308′ that are implemented using purely hardware or circuitry components (e.g., application specific integrated circuit or “ASIC”). In contrast, FIG. 3B illustrates a standalone automated customized food generation machine 10b that is the “soft” implementation of an automated customized food generation system that can implement the operations and processes to be described herein. In various embodiments, the automated customized food generation machine 10b may also include certain logic modules including, for example, a generic food request obtaining module 302″, a user preference information acquiring module 304″, an automated customized food generation controlling module 306″, and/or an indicator presenting module 308″ that are implemented using electronic circuitry (e.g., one or more processors 330 including one or more microprocessors, controllers, etc.) executing one or more programming instructions (e.g., software in the form of computer readable instructions 342—see FIG. 3B).

The embodiments of the standalone automated customized food generation machine 10* illustrated in FIGS. 3A and 3B are two extreme implementations of a standalone automated customized food generation system in which all of the logic modules (e.g., the generic food request obtaining module 302′, the user preference information acquiring module 304′, the automated customized food generation controlling module 306′, and the indicator presenting module 308′) are implemented using purely hardware solutions (e.g., circuitry such as ASIC) as illustrated in, for example, FIG. 3A or in which all of the logic modules (e.g., the generic food request obtaining module 302″, the user preference information acquiring module 304″, the automated customized food generation controlling module 306″, and the indicator presenting module 308″) are implemented using software solutions (e.g., programmable instructions in the form of computer readable instructions 342 being executed by hardware such as one or more processors 330) as illustrated in, for example, FIG. 3B. Since there are many ways of combining hardware, software, and/or firmware in order to implement the various logic modules (e.g., the generic food request obtaining module 302*, the user preference information acquiring module 304*, the automated customized food generation controlling module 306*, and the indicator presenting module 308*), only the two extreme implementations (e.g., the purely hardware solution as illustrated in FIG. 3A and the software solution of FIG. 3B) are illustrated here. It should be noted here that with respect to the “soft” implementation illustrated in FIG. 3B, hardware in the form of circuitry such as one or more processors 330 are still needed in order to execute the software. Further details related to the two implementations of the standalone automated customized food generation machine 10* illustrated in FIGS. 3A and 3B will be provided in greater detail below.

In still other implementations, the automated customized food generation machine 10* of FIG. 1A may not actually include the various logic modules (e.g., the generic food request obtaining module 302*, the user preference information acquiring module 304*, the automated customized food generation controlling module 306*, and the indicator presenting module 308*) that implement the various operations/processes described herein. For example, the automated customized food generation machine 10c of FIG. 3C illustrates such a device that does not have the various logic modules (e.g., a generic food request obtaining module 302*, a user preference information acquiring module 304*, an automated customized food generation controlling module 306*, and an indicator presenting module 308*) included in the automated customized food generation machine 10a and 10b of FIGS. 3A and 3B. Instead, such logic modules may be located in a remote device such as at a network device 12* as illustrated, for example, in FIGS. 3D and 3E. In such implementations, the other device (e.g., network device 12*) may be endowed with the various logic modules (e.g., a generic food request obtaining module 302*, a user preference information acquiring module 304*, an automated customized food generation controlling module 306*, and an indicator presenting module 308*) in order to be able to perform at least some of the processes and operations to be described herein. In various implementations, the network device 12* may be a network computing device (e.g., a server or a workstation) or a plurality of network devices (e.g., the cloud).

FIGS. 3D and 3E illustrates two extreme implementations of the network device 12* of FIGS. 1B, 1C, and 1D in which all of the logic modules (e.g., the generic food request obtaining module 302′, the user preference information acquiring module 304′″, the automated customized food generation controlling module 306′″, and the indicator presenting module 308′) are implemented using purely hardware solutions (e.g., circuitry such as ASIC) as illustrated in, for example, FIG. 3D, or in which all of the logic modules (e.g., the generic food request obtaining module 302″″, the user preference information acquiring module 304″″, the automated customized food generation controlling module 306″″, and the indicator presenting module 308″″) are implemented using software solutions (e.g., programmable instructions in the form of computer readable instructions 342 being executed by hardware such as one or more processors 330) as illustrated in, for example, FIG. 3E. Again, although there are many ways to combine hardware, software, and/or firmware in order to implement the various logic modules (e.g., the generic food request obtaining module 302*, the user preference information acquiring module 304*, the automated customized food generation controlling module 306*, and the indicator presenting module 308*), for ease of illustration only the two extreme implementations (e.g., the purely hardware solution as illustrated in FIG. 3D and the software solution of FIG. 3E) are illustrated here.

In some instances, one or more components may be referred to herein as “configured to,” “configured by,” “configurable to,” “operable/operative to,” “adapted/adaptable,” “able to,” “conformable/conformed to,” “designed to,” etc. Those skilled in the art will recognize that such terms (e.g., “configured to”) generally encompass active-state components and/or inactive-state components and/or standby-state components, unless context requires otherwise.

Referring back to FIG. 3A, which illustrates a block diagram of an automated customized food generation machine 10a that includes a generic food request obtaining module 302′, a user preference information acquiring module 304′, an automated customized food generation controlling module 306′, and an indicator presenting module 308′, memory 340, a communication system 350 (e.g., a network interface card, a transceiver, and so forth), a user interface 360 (e.g., a display, a speaker, and so forth), one or more processors 330 (e.g., one or more microprocessors), and a customized food item manufacturing system 320. In some embodiments, the memory 340 may store ingredient supply data that indicates ingredient supply information of one or more automated customized food generation machines 10* (which in this case, may also indicate the supply information of the automated customized food generation machine 10a) and/or user preference information indicating food customization preferences of one or more users 13. In various embodiments, the customized food item manufacturing system 320 may be an automated system that is designed to generate or manufactured customized food items. For these embodiments, the customized food item manufacturing system 320 may include one or more ingredient supplies, and components for manufacturing customized food items including, for example, robotic components, 3-D printing components, heating and/or cooling components, ingredient mixing components, molding components, and so forth for producing or manufacturing one or more customized food items in accordance with customized food preferences of one or more users. In some embodiments, the user interface 360 may include a display screen 30 such as a touchscreen, a keypad 32, and so forth.

In various embodiments, the generic food request obtaining module 302′ of the automated customized food generation machine 10a of FIG. 3A is a logic module that may be designed to, among other things, obtain a generic food request for one or more food items 22, the generic food request to be obtained from a user 13. In contrast, the user preference information acquiring module 304′ of FIG. 3A is a logic module that may be configured to acquire, from one or more sources other than the user 13, user preference information of the user 13 that indicates one or more food customization preferences of the user 13 including at least one or more ingredient integrity preferences of the user 13 related to integrity of one or more ingredients, the user preference information to be acquired in response to obtaining the generic food request. The automated customized food generation controlling module 306′ is a logic module that may be configured to, among other things, control automated generation of one or more customized food items 22 in response to the obtained generic food request and in accordance, at least in part, with the acquired user preference information. The indicator presenting module 308′ of FIG. 3A, on the other hand, is a logic module that may be configured to, among other things, present one or more indicators 220* that identify an automated customized food generation machine 10* that will generate the one or more customized food items 22, the presentation of the one or more indicators 220* to be performed prior to the control by the automated customized food generation controlling module 306′ of the automated generation of the one or more customized food items 22.

Turning now to FIG. 3B, which illustrates a block diagram of another automated customized food generation machine 10b that can implement the operations and processes to be described herein. As indicated earlier, the automated customized food generation machine 10b in FIG. 3B is merely the “soft” version of the automated customized food generation machine 10a of FIG. 3A because the various logic modules: the generic food request obtaining module 302″, the user preference information acquiring module 304″, the automated customized food generation controlling module 306″, and the indicator presenting module 308″ are implemented using one or more processors 330 (e.g., one or more microprocessors or controllers) executing software (e.g., computer readable instructions 342) rather than being implemented using purely hardware (e.g., ASIC) solutions as was the case in the automated customized food generation machine 10a of FIG. 3A. Thus, the generic food request obtaining module 302″, the user preference information acquiring module 304″, the automated customized food generation controlling module 306″, and the indicator presenting module 308″ of FIG. 3B may be designed to execute the same or similar functions as the generic food request obtaining module 302′, the user preference information acquiring module 304′, the automated customized food generation controlling module 306′, and the indicator presenting module 308′ of FIG. 3A. The automated customized food generation machine 10b, as illustrated in FIG. 3B, may include other components (e.g., the user interface 360, the communication system 350, the memory 340 that stores ingredient supply data of one or more automated customized food generation machines 10*, user preference information indicating food customization preferences of one or more users 13, and the computer readable instructions 342, the customized food item manufacturing system 320, and so forth) that are the same or similar to the other components that may be included in the automated customized food generation machine 10a of FIG. 3A. Note that in the embodiment of the automated customized food generation machine 10b illustrated in FIG. 3B, the various logic modules (e.g., the generic food request obtaining module 302″, the user preference information acquiring module 304″, the automated customized food generation controlling module 306″, and the indicator presenting module 308″) may be implemented by the one or more processors 330 (or other types of circuitry such as field programmable gate arrays or FPGAs) executing one or more computer readable instructions 342 stored in memory 340.

In various embodiments, the memory 340 of the automated customized food generation machine 10a of FIG. 3A and the automated customized food generation machine 10b of FIG. 3B may comprise one or more of mass storage device, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices.

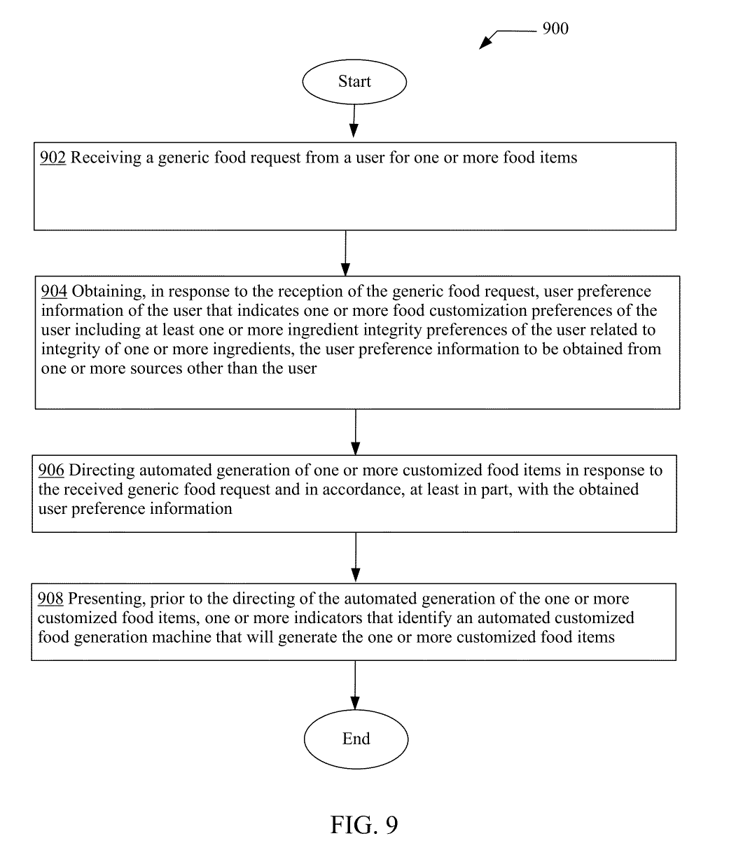

FIG. 3C illustrates the automated customized food generation machine 10* of FIG. 1A (e.g., illustrated in FIG. 3C as automated customized food generation machine 10c) when the automated customized food generation machine 10* of FIG. 1A is not a standalone device but instead, relies on another device (e.g., the network device 12* of FIG. 1B, 1C, or 1D) to provide the various logic needed in order to, for example, execute the various operations to be described herein (e.g., see FIG. 5 or 9). In contrast, FIGS. 3D and 3E illustrate two extreme implementations (e.g., in which all of the logic modules are implemented using hardware solutions as illustrated in the network device 12a of FIG. 3D or in which all of the logic modules are implemented using software solutions as illustrated in the network device 12b of FIG. 3E) of the network device 12* of FIG. 1B, 1C, and 1D. Note that both the network device 12a of FIG. 3D and the network device 12b of FIG. FIG. 3E have the same logic modules as those logic modules included in the automated customized food generation machines 10a and 10b of FIGS. 3A and 3B performing the same or similar functionalities.

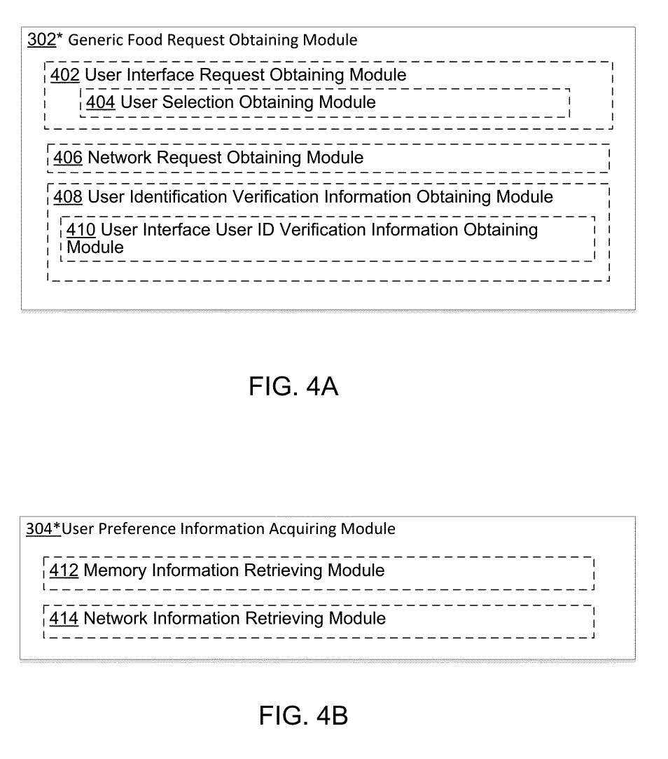

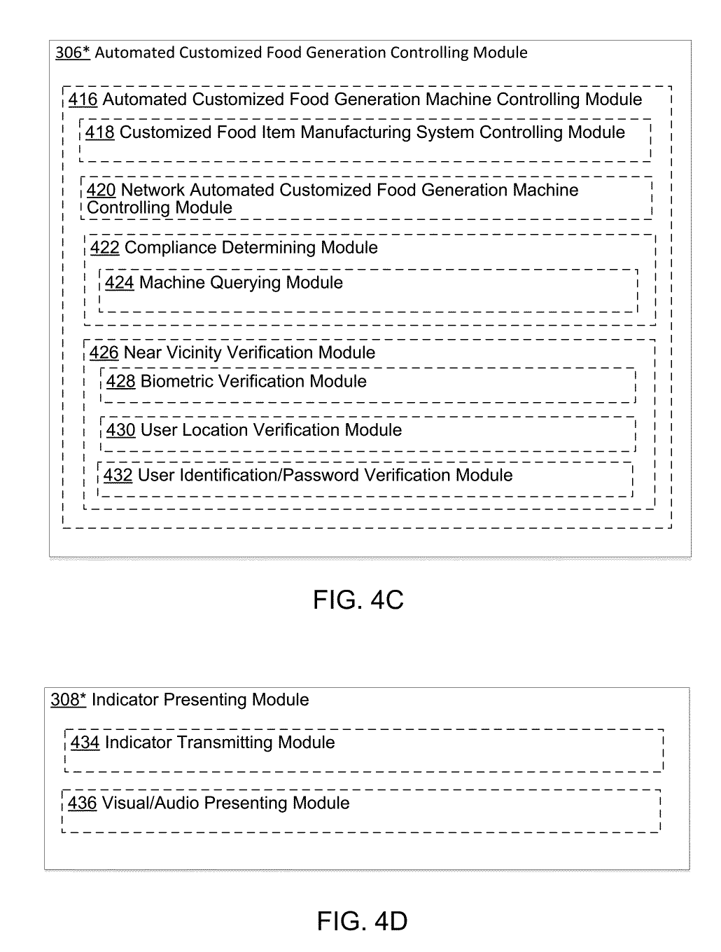

Turning now to FIG. 4A illustrating a particular implementation of the generic food request obtaining module 302* (e.g., the generic food request obtaining module 302′, the generic food request obtaining module 302″, the generic food request obtaining module 302′″, or the generic food request obtaining module 302″″) of FIG. 3A, 3B, 3D, or 3E. As illustrated, the generic food request obtaining module 302* may include one or more sub-logic modules in various alternative implementations. For example, in various embodiments, the generic food request obtaining module 302* may include a user interface request obtaining module 402 (which may further include a user selection obtaining module 404), a network request obtaining module 406, and/or a user identification verification information obtaining module 408 (which may further include a user interface user ID verification information obtaining module 410). Specific details related to the generic food request obtaining module 302* as well as the above-described sub-modules of the generic food request obtaining module 302* will be provided below with respect to the various operations and processes to be described herein.

Turning now to FIG. 4B illustrating a particular implementation of the user preference information acquiring module 304* (e.g., the user preference information acquiring module 304′, the user preference information acquiring module 304″, the user preference information acquiring module 304′″, or the user preference information acquiring module 304″″) of FIG. 3A, 3B, 3D, or 3E. As illustrated, the user preference information acquiring module 304* may include one or more sub-logic modules in various alternative implementations. For example, in various embodiments, the user preference information acquiring module 304* may include a memory information retrieving module 412 and/or a network information retrieving module 414. Specific details related to the user preference information acquiring module 304* as well as the above-described sub-modules of the user preference information acquiring module 304* will be provided below with respect to the various operations and processes to be described herein.

Turning now to FIG. 4C illustrating a particular implementation of the automated customized food generation controlling module 306* (e.g., the automated customized food generation controlling module 306′, the automated customized food generation controlling module 306′″, the automated customized food generation controlling module 306″, or the automated customized food generation controlling module 306″″) of FIG. 3A, 3B, 3D, or 3E. As illustrated, the automated customized food generation controlling module 306* may include one or more sub-logic modules in various alternative implementations. For example, in various embodiments, the automated customized food generation controlling module 306* may include an automated customized food generation machine controlling module 416 that may further include a customized food item manufacturing system controlling module 418, a network automated customized food generation machine controlling module 420, a compliance determining module 422 (which may further include a machine querying module 424), and/or a near vicinity verification module 426 (which may further include a biometric verification module 428, a user location verification module 430, and/or a user identification/password verification module 432). Specific details related to the automated customized food generation controlling module 306* as well as the above-described sub-modules of the automated customized food generation controlling module 306* will be provided below with respect to the various operations and processes to be described herein.

Referring to FIG. 4D, which illustrates a particular implementation of the indicator presenting module 308* (e.g., the indicator presenting module 308′, the indicator presenting module 308″″, the indicator presenting module 308′″, or the indicator presenting module 308″″) of FIG. 3A, 3B, 3D, or 3E. As illustrated, the indicator presenting module 308* may include one or more sub-logic modules in various alternative implementations. For example, in various embodiments, the indicator presenting module 308* may include an indicator transmitting module 434 and/or a visual/audio presenting module 436. Specific details related to the indicator presenting module 308* as well as the above-described sub-modules of the indicator presenting module 308* will be provided below with respect to the various operations and processes to be described herein.

In the following, various operations are presented in accordance with various embodiments that may be implemented by the automated customized food generation machine 10* (e.g., the automated customized food generation machine 10a or the automated customized food generation machine 10b) of FIG. 3A or 3B, or that may be implemented by the network device 12* (e.g., the network device 12a or the network device 12b) of FIG. 3D or 3E. FIG. 5, for example, illustrates an operational flow 500 representing example computationally-implemented operations for, among other things, directing the automated generation of one or more customized food items that are customized for a particular user in response receiving a generic food request from the user and in accordance with user preference information that indicates one or more food customization preferences of the user that was obtained in response to the received generic food request.

In FIG. 5 and in the following figures that include various examples of operational flows, discussions and explanations will be provided with respect to the automated customized food generation machine 10* or the network device 12* described above and as illustrated in FIGS. 3A, 3B, 3C, 3D, 3E, 4A, 4B, 4C, and 4D, and/or with respect to other examples (e.g., as provided in FIGS. 1A, 1B, 1C, 1D, 1E, 2A, 2B, 2C, and 2D) and contexts. However, it should be understood that the operational flows may be executed in a number of other environments and contexts, and/or in modified versions of FIGS. 1A, 1B, 1C, 1D, 1E, 2A, 2B, 2C, 2D, 2E, 2F, 2G, 3A, 3B, 3C, 3D, 3E, 4A, 4B, 4C, and 4D. Also, although the various operational flows are presented in the sequence(s) illustrated, it should be understood that the various operations may be performed in orders other than those which are illustrated, or may be performed concurrently.

Further, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 5 as well as the other operations to be described herein are performed by at least one of a machine, an article of manufacture, or a composition of matter unless indicated otherwise.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

In any event, after a start operation, the operational flow 500 of FIG. 5 may move to a generic food request receiving operation 502 for receiving a generic food request from a user for one or more food items. For instance, and as illustration, the generic food request obtaining module 302* of the automated customized food generation machine 10* of FIG. 3A or 3B (e.g., the generic food request obtaining module 302′ of FIG. 3A or the generic food request obtaining module 302″ of FIG. 3B) or of the network device 12* of FIG. 3D or 3E (e.g., the generic food request obtaining module 302′″ of FIG. 3D or the generic food request obtaining module 302″″ of FIG. 3E) receiving or obtaining a generic food request from a user 13 for one or more food items. In various implementations, the “generic food request” to be received may be a simple and general request for a food item with no additional information (e.g., no food customization preference of the user 13, no preference for specific ingredients, or other user preferences) other than a request for a general food item (e.g., in some cases, such a generic food request may have been submitted by the user 13 when the user 13 executed a “one-click” action via a graphical user interface (e.g., the user 13 clicking a “feed me” button as illustrated for, example, in FIG. 2A. 2B, or 2C).

Operational flow 500 may also include a user preference information obtaining operation 504 for obtaining, in response to the reception of the generic food request, user preference information of the user that indicates one or more food customization preferences of the user including at least one or more ingredient integrity preferences of the user related to integrity of one or more ingredients, the user preference information to be obtained from one or more sources other than the user. For instance, the user preference information acquiring module 304* of the automated customized food generation machine 10* of FIG. 3A or 3B (e.g., the user preference information acquiring module 304′ of FIG. 3A or the user preference information acquiring module 304″ of FIG. 3B) or of the network device 12* of FIG. 3D or 3E (e.g., the user preference information acquiring module 304′″ of FIG. 3D or the user preference information acquiring module 304″″ of FIG. 3E) obtaining or acquiring, in response at least in part to the reception of the generic food request, user preference information of the user 13 that indicates one or more food customization preferences (e.g., ingredient preferences, ingredient sourcing preferences, and so forth) of the user 13 including at least one or more ingredient integrity preferences of the user 13 related to integrity (e.g., purity or sourcing) of one or more ingredients, the user preference information to be obtained from one or more sources (e.g., a memory 340, the cloud, and forth) other than obtaining the information from the user 13.

Operational flow 500 may further include an automated customized food generation directing operation 506 for directing automated generation of one or more customized food items in response to the received generic food request and in accordance, at least in part, with the obtained user preference information. For instance, the automated customized food generation controlling module 306* of the automated customized food generation machine 10* of FIG. 3A or 3B (e.g., the automated customized food generation controlling module 306′ of FIG. 3A or the automated customized food generation controlling module 306″ of FIG. 3B) or of the network device 12* of FIG. 3D or 3E (e.g., the automated customized food generation controlling module 306′″ of FIG. 3D or the automated customized food generation controlling module 306″″ of FIG. 3E) directing or controlling automated generation of one or more customized food items 22 (e.g., a customized energy bar, a customized sandwich such as a customized burger, a customized shake, a customized meal such as meatball spaghetti, and so forth) in response to the received generic food request and in accordance, at least in part, with the obtained user preference information (e.g., ingredient preference information, ingredient purity preference information, and so forth).

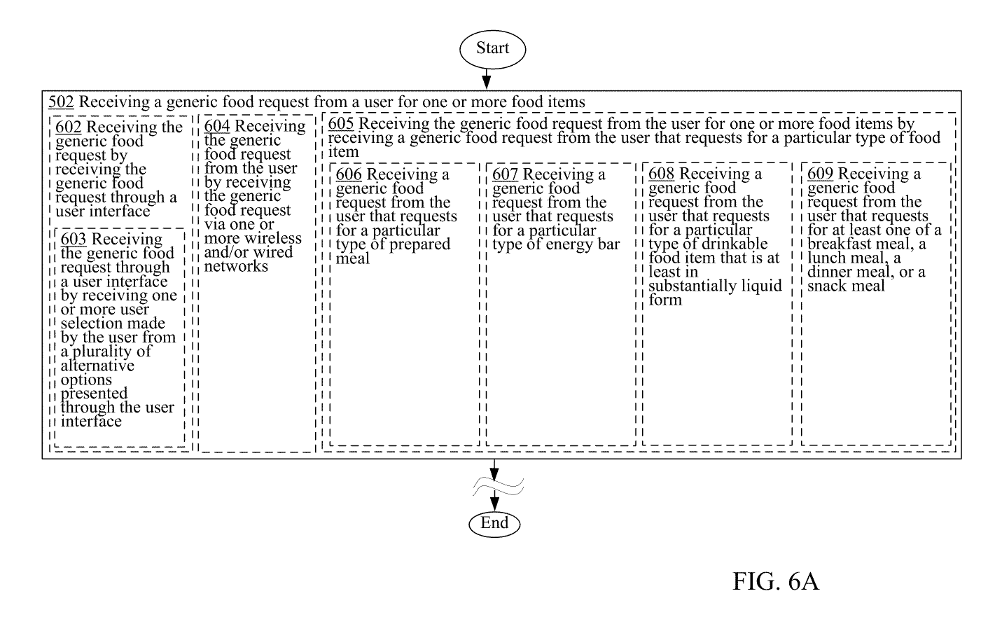

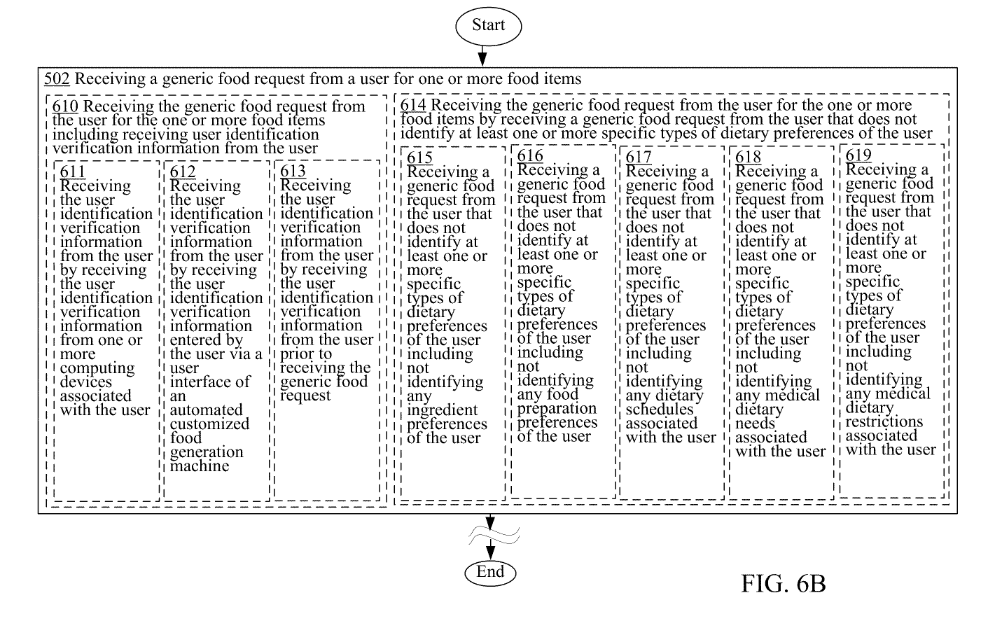

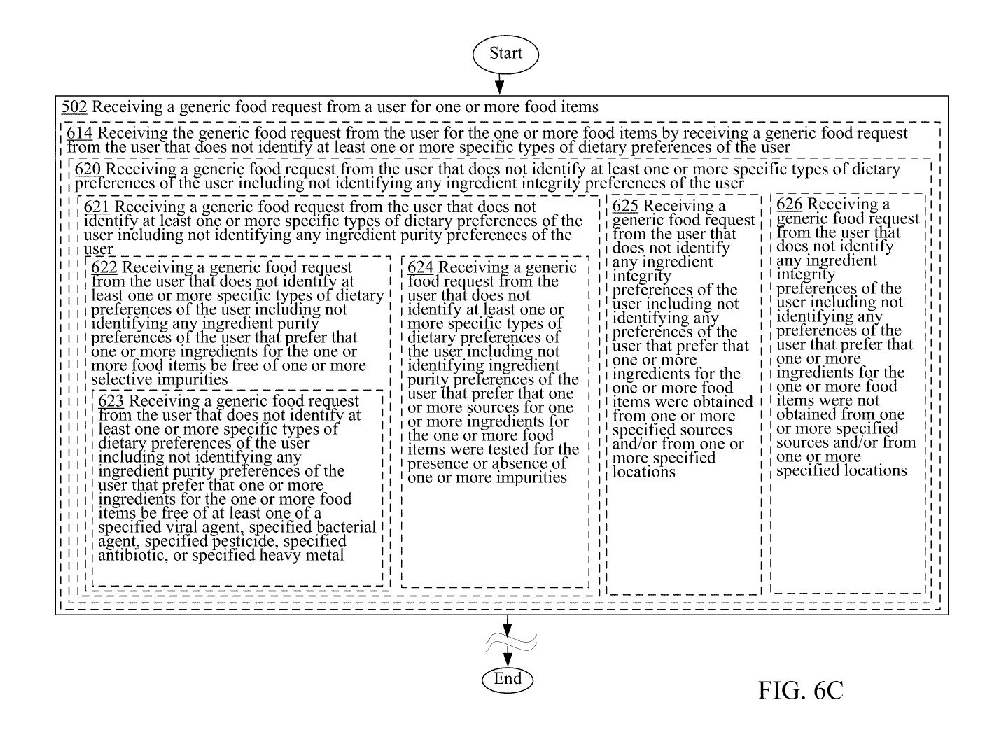

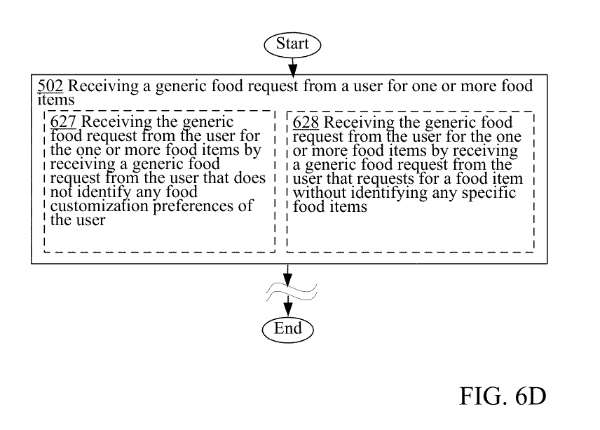

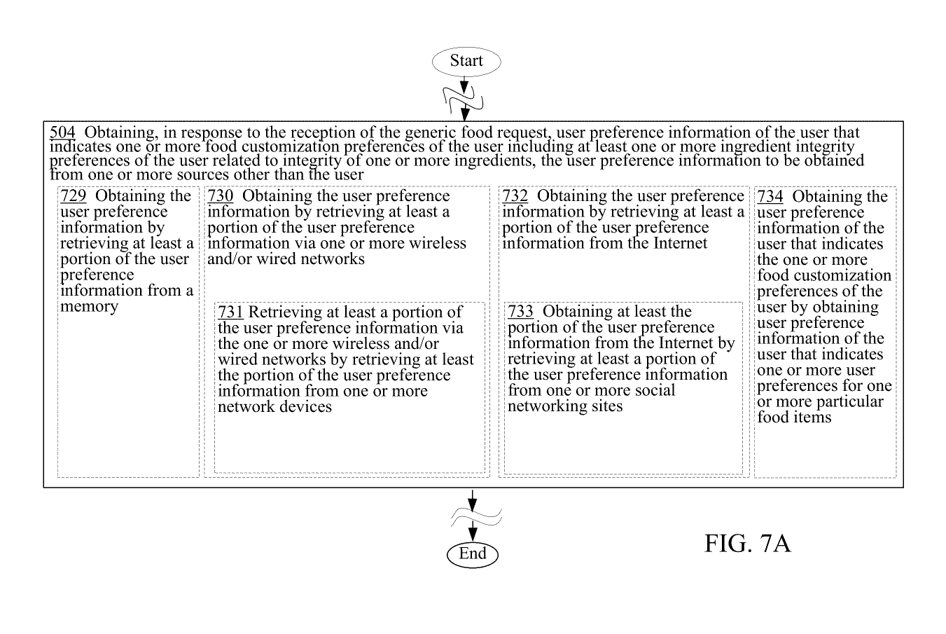

As will be described below, the generic food request receiving operation 502, the user preference information obtaining operation 504, and the automated customized food generation directing operation 506 may be executed in a variety of different ways in various alternative implementations. FIGS. 6A, 6B, 6C, and 6D, for example, illustrate at least some of the alternative ways that the generic food request receiving operation 502 of FIG. 5 may be implemented in various alternative implementations. In some cases, for example, the generic food request receiving operation 502 may include an operation 602 for receiving the generic food request by receiving the generic food request through a user interface as illustrated in FIG. 6A. For instance, the generic food request obtaining module 302* including the user interface request obtaining module 402 (see, for example, FIG. 4A) of the automated customized food generation machine 10a or 10b of FIG. 3A or 3B (or of the network device 12a or 12b of FIG. 3D or 3E) receiving the generic food request when the user interface request obtaining module 402 receives or obtains the generic food request through a user interface (e.g., a touchscreen, a keyboard, and so forth, that may be disposed on, for example, an automated customized food generation machine 10*).

In various implementations, operation 602 may further include an operation 603 for receiving the generic food request through a user interface by receiving one or more user selection made by the user from a plurality of alternative options presented through the user interface. For instance, the user interface request obtaining module 402 including the user selection obtaining module 404 (see FIG. 4A) of the automated customized food generation machine 10a or 10b of FIG. 3A or 3B (or of the network device 12a or 12b of FIG. 3D or 3E) receiving the generic food request through a user interface by having the user selection obtaining module 404 receive or obtain one or more user selection made by the user 13 from a plurality of alternative options presented through the user interface (see, for example, the example screens 200b and 200c of FIGS. 2B and 2C, which provides to the user 13 different selectable options).

In some implementations, the generic food request receiving operation 502 may include an operation 604 for receiving the generic food request from the user by receiving the generic food request via one or more wireless and/or wired networks. For instance, the generic food request obtaining module 302* including the network request obtaining module 406 (see FIG. 4A) of the automated customized food generation machine 10a or 10b of FIG. 3A or 3B (or of the network device 12a or 12b of FIG. 3D or 3E) receiving the generic food request from the user 13 by having the network request obtaining module 406 receive or obtain the generic food request via one or more wireless and/or wired networks 8 (e.g., cellular data network, PTSN, LAN, WLAN, and so forth).

In the same or alternative implementations, the generic food request receiving operation 502 may include an operation 605 for receiving the generic food request from the user for one or more food items by receiving a generic food request from the user that requests for a particular type of food item. For instance, the generic food request obtaining module 302* of the automated customized food generation machine 10a or 10b of FIG. 3A or 3B (or of the network device 12a or 12b of FIG. 3D or 3E) receiving the generic food request from the user 13 for one or more food items by receiving or obtaining a request from the user 13 that requests for a particular type of food item (e.g., request for energy bar, request for a shake, request for a sandwich, and so forth). Note that in various implementations, no additional information related to food preferences or food customization preferences of the user 13 may be provided through the request.

As further illustrated in FIG. 6A, in various implementations, operation 605 may actually involve an operation 606 for receiving a generic food request from the user that requests for a particular type of prepared meal. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that requests for a particular type of prepared meal (e.g., a breakfast meal, a lunch meal, a dinner meal, a snack, a sandwich, a stew, and so forth). FIGS. 2B and 2C illustrate example screens 200b and 200c that may be displayed to the user 13 and that may be used by the user 13 to select a particular type of meal.

In some implementations, operation 605 may actually involve an operation 607 for receiving a generic food request from the user that requests for a particular type of energy bar. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that requests for a particular type of energy bar (e.g., chocolate chip energy bar, peanut granola energy bar, and so forth). In various implementations, no additional user preference information, such as ingredient purity preferences of the user 13, may be included in the generic food request.

In some implementations, operation 605 may actually involve an operation 608 for receiving a generic food request from the user that requests for a particular type of drinkable food item that is at least in substantially liquid form. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that requests for a particular type of drinkable food item (e.g., a smoothie, a soup, a shake, and so forth) that is at least in substantially liquid form.

In some implementations, operation 605 may actually involve an operation 609 for receiving a generic food request from the user that requests for at least one of a breakfast meal, a lunch meal, a dinner meal, or a snack meal. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that requests for at least one of a breakfast meal, a lunch meal, a dinner meal, or a snack meal (see, for example, FIG. 2B).

Turning to FIG. 6B, in various implementations, the generic food request receiving operation 502 of FIG. 5 may include an operation 610 for receiving the generic food request from the user for the one or more food items including receiving user identification verification information from the user. For instance, the generic food request obtaining module 302* including the user identification verification information obtaining module 408 (see FIG. 4A) of the automated customized food generation machine 10a or 10b of FIG. 3A or 3B (or of the network device 12a or 12b of FIG. 3D or 3E) receiving the generic food request from the user 13 for the one or more food items including having the user identification verification information obtaining module 408 obtain or receive user identification verification information (e.g., password, username, user ID number, and so forth) from the user 13. In various embodiments, such identification verification information may be needed for subsequently obtaining user preference information of the user 13. That is, the identity of the user 13 may need to be verified before retrieving the correct user preference information.

In some implementations, operation 610 may actually involve an operation 611 for receiving the user identification verification information from the user by receiving the user identification verification information from one or more computing devices associated with the user. For instance, the user identification verification information obtaining module 408 of the automated customized food generation machine 10a or 10b of FIG. 3A or 3B (or of the network device 12a or 12b of FIG. 3D or 3E) receiving the user identification verification information from the user 13 by receiving or obtaining the user identification verification information from one or more computing devices 15 (e.g., a Smartphone, a tablet computer, a desktop computer, and so forth) associated with the user 13 (see, for example, the example scenarios illustrated in FIGS. 1C and 1D).

In some implementations, operation 610 may actually involve an operation 612 for receiving the user identification verification information from the user by receiving the user identification verification information entered by the user via a user interface of an automated customized food generation machine. For instance, the user identification verification information obtaining module 408 including the user interface user ID verification information obtaining module 410 (see FIG. 4A) of the automated customized food generation machine 10a or 10b of FIG. 3A or 3B (or of the network device 12a or 12b of FIG. 3D or 3E) receiving the user identification verification information from the user 13 when the user interface user ID verification information obtaining module 410 receives or obtains the user identification verification information entered by the user 13 via a user interface (e.g., a touchscreen, a keypad, a camera, or a microphone) of an automated customized food generation machine 10* (e.g., see, for example, the example scenario of FIG. 1B). In some cases, a user 13 may provide the user identification verification information by providing biometric data (e.g., fingerprints or facial image).

In some implementations, operation 610 may actually involve an operation 613 for receiving the user identification verification information from the user by receiving the user identification verification information from the user prior to receiving the generic food request. For instance, the user identification verification information obtaining module 408 of the automated customized food generation machine 10a or 10b of FIG. 3A or 3B (or of the network device 12a or 12b of FIG. 3D or 3E) receiving the user identification verification information from the user 13 by receiving or obtaining the user identification verification information from the user 13 prior to receiving the generic food request. In some cases, it may be preferable to verify the identity of the user 13 before accepting a generic food request from the user 13.

In the same or alternative implementations, the generic food request receiving operation 502 of FIG. 5 may include an operation 614 for receiving the generic food request from the user for the one or more food items by receiving a generic food request from the user that does not identify at least one or more specific types of dietary preferences of the user. For instance, the generic food request obtaining module 302* of the automated customized food generation machine 10a or 10b of FIG. 3A or 3B (or of the network device 12a or 12b of FIG. 3D or 3E) receiving the generic food request from the user 13 for the one or more food items by receiving or obtaining a generic food request from the user 13 that does not identify at least one or more specific types of dietary preferences of the user 13.

In some implementations, operation 614 may include an operation 615 for receiving a generic food request from the user that does not identify at least one or more specific types of dietary preferences of the user including not identifying any ingredient preferences of the user. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying any ingredient preferences of the user 13.

In the same or alternative implementations, operation 614 may additionally or alternatively include an operation 616 for receiving a generic food request from the user that does not identify at least one or more specific types of dietary preferences of the user including not identifying any food preparation preferences of the user. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying any food preparation preferences (e.g., preferences that meat be well cooked) of the user 13.

In the same or alternative implementations, operation 614 may additionally or alternatively include an operation 617 for receiving a generic food request from the user that does not identify at least one or more specific types of dietary preferences of the user including not identifying any dietary schedules associated with the user. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying any dietary schedules associated with the user 13.

In the same or alternative implementations, operation 614 may additionally or alternatively include an operation 618 for receiving a generic food request from the user that does not identify at least one or more specific types of dietary preferences of the user including not identifying any medical dietary needs associated with the user. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying any medical dietary needs (e.g., high fiber content ingredients, vitamin enriched ingredients, and so forth) associated with the user 13.

In the same or alternative implementations, operation 614 may additionally or alternatively include an operation 619 for receiving a generic food request from the user that does not identify at least one or more specific types of dietary preferences of the user including not identifying any medical dietary restrictions associated with the user. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying any medical dietary restrictions (e.g., low-sodium diet, low-sugar diet, low-fat diet, no peanuts, no seafood, and so forth) associated with the user 13.

In the same or alternative implementations, operation 614 may additionally or alternatively include an operation 620 for receiving a generic food request from the user that does not identify at least one or more specific types of dietary preferences of the user including not identifying any ingredient integrity preferences of the user as illustrated in FIG. 6C. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying any ingredient integrity preferences (e.g., ingredient purity or sourcing preferences) of the user 13.

As further illustrated in FIG. 6C, in some cases, operation 620 may further include an operation 621 for receiving a generic food request from the user that does not identify at least one or more specific types of dietary preferences of the user including not identifying any ingredient purity preferences of the user. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying any ingredient purity preferences of the user 13.

Operation 621, in turn, may further include an operation 622 for receiving a generic food request from the user that does not identify at least one or more specific types of dietary preferences of the user including not identifying any ingredient purity preferences of the user that prefer that one or more ingredients for the one or more food items be free of one or more selective impurities in various implementations. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying any ingredient purity preferences of the user 13 that prefer that one or more ingredients for the one or more food items be free of one or more selective impurities (e.g., prions, salmonella, E. coli, Norovirus, and so forth).

As further illustrated in FIG. 6C, in some cases, operation 622 may further include an operation 623 for receiving a generic food request from the user that does not identify at least one or more specific types of dietary preferences of the user including not identifying any ingredient purity preferences of the user that prefer that one or more ingredients for the one or more food items be free of at least one of a specified viral agent, specified bacterial agent, specified pesticide, specified antibiotic, or specified heavy metal. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying any ingredient purity preferences of the user 13 that prefer that one or more ingredients for the one or more food items be free of at least one of a specified viral agent (e.g., rotavirus or norovirus), specified bacterial agent (e.g., salmonella), specified pesticide (e.g., DDT), specified antibiotic, or specified heavy metal (e.g. lead).

In the same or alternative implementations, operation 621 may additionally or alternatively include an operation 624 for receiving a generic food request from the user that does not identify at least one or more specific types of dietary preferences of the user including not identifying ingredient purity preferences of the user that prefer that one or more sources for one or more ingredients for the one or more food items were tested for the presence or absence of one or more impurities. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify at least one or more specific types of dietary preferences of the user 13 including not identifying ingredient purity preferences of the user 13 that prefer that one or more sources (e.g., a cattle or a cattle herd, or a vegetable crop) for one or more ingredients (e.g., beef ingredient or vegetable ingredient) for the one or more food items were tested for the presence or absence of one or more impurities.

In various implementations, operation 620 for receiving a generic food request from the user that does not identify at least one or more specific types of dietary preferences of the user including not identifying any ingredient integrity preferences of the user may actually include an operation 625 for receiving a generic food request from the user that does not identify any ingredient integrity preferences of the user including not identifying any preferences of the user that prefer that one or more ingredients for the one or more food items were obtained from one or more specified sources and/or from one or more specified locations. For instance, the generic food request obtaining module 302* of the automated customized food generation machine 10a or 10b of FIG. 3A or 3B (or of the network device 12a or 12b of FIG. 3D or 3E) receiving a generic food request from the user 13 that does not identify any ingredient integrity preferences of the user 13 including not identifying any preferences of the user 13 that prefer that one or more ingredients (e.g., chicken ingredients) for the one or more food items (e.g., chicken noodle soup) were obtained from one or more specified sources (e.g., Tysons) and/or from one or more specified locations.

In the same or alternative implementations, operation 620 may additionally or alternatively include an operation 626 for receiving a generic food request from the user that does not identify any ingredient integrity preferences of the user including not identifying any preferences of the user that prefer that one or more ingredients for the one or more food items were not obtained from one or more specified sources and/or from one or more specified locations. For instance, the generic food request obtaining module 302* of the automated customized food generation machine 10a or 10b of FIG. 3A or 3B (or of the network device 12a or 12b of FIG. 3D or 3E) receiving or obtaining a generic food request from the user 13 that does not identify any ingredient integrity preferences of the user 13 including not identifying any preferences of the user 13 that prefer that one or more ingredients (e.g., beef ingredients) for the one or more food items (e.g., hamburger) were not obtained from one or more specified sources and/or from one or more specified locations (e.g., Britain where the outbreak of the mad cow disease occurred).

Turning now to FIG. 6D, in various implementations, the generic food request receiving operation 502 of FIG. 5 may include an operation 627 for receiving the generic food request from the user for the one or more food items by receiving a generic food request from the user that does not identify any food customization preferences of the user. For instance, the generic food request obtaining module 302* of the automated customized food generation machine 10a or 10b of FIG. 3A or 3B (or of the network device 12a or 12b of FIG. 3D or 3E) receiving the generic food request from the user 13 for the one or more food items by receiving or obtaining a generic food request from the user 13 that does not identify any food customization preferences of the user 13.

In some implementations, the generic food request receiving operation 502 may include an operation 628 for receiving the generic food request from the user for the one or more food items by receiving a generic food request from the user that requests for a food item without identifying any specific food items. For instance, the generic food request obtaining module 302* of the automated customized food generation machine 10a or 10b of FIG. 3A or 3B (or of the network device 12a or 12b of FIG. 3D or 3E) receiving the generic food request from the user 13 for the one or more food items by receiving or obtaining a generic food request from the user 13 that requests for a food item without identifying any specific food items. For example, the user 13 may “click” a “feed me” button as illustrated, for example, by the example screen 200a of FIG. 2A.

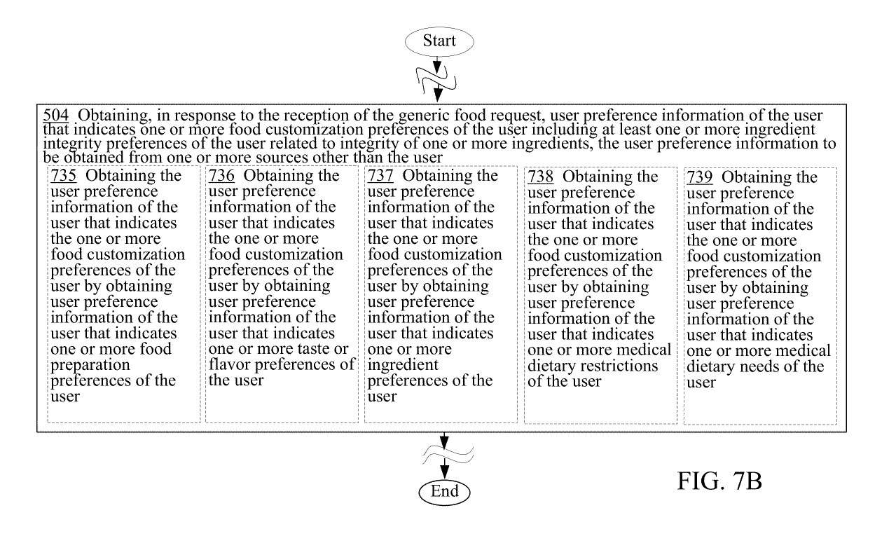

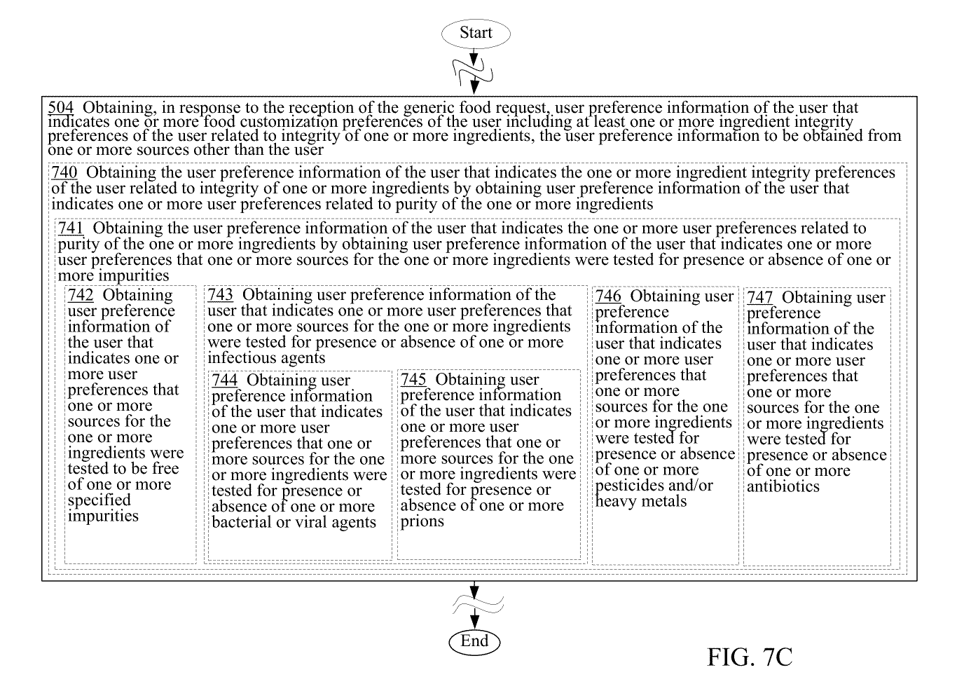

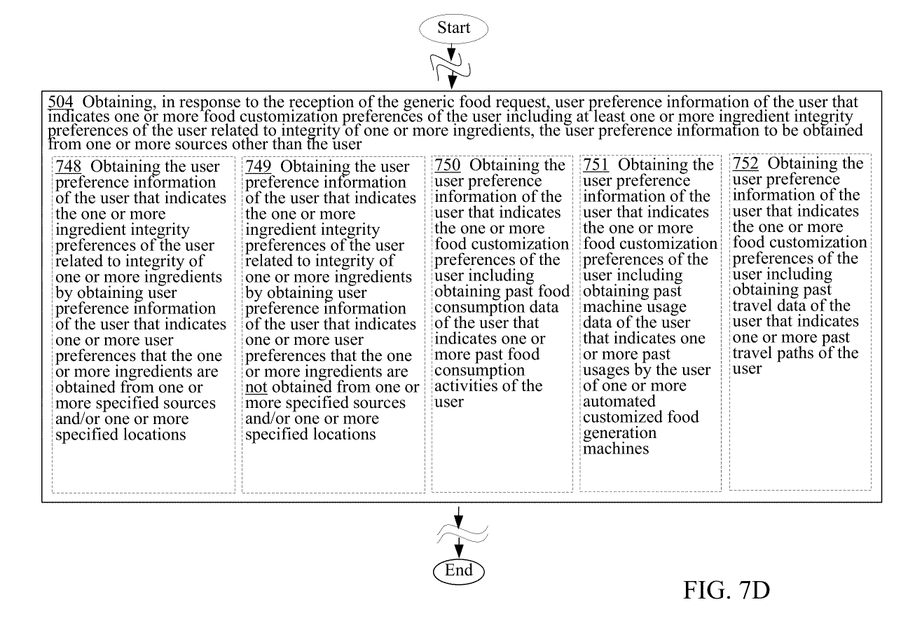

Referring back to the user preference information obtaining operation 504 of FIG. 5, the user preference information obtaining operation 504 similar to the generic food request receiving operation 502 of FIG. 5 may be executed in a number of different ways in various alternative embodiments as illustrated, for example, in FIGS. 7A, 7B, 7C, and 7D. In some cases, for example, the user preference information obtaining operation 504 may actually include or involve an operation 729 for obtaining the user preference information by retrieving at least a portion of the user preference information from a memory as illustrated in FIG. 7A. For instance, the user preference information acquiring module 304* including the memory information retrieving module 412 (see FIG. 4B) of the automated customized food generation machine 10a or 10b of FIG. 3A or 3B (or of the network device 12a or 12b of FIG. 3D or 3E) obtaining the user preference information by having the memory information retrieving module 412 retrieve at least a portion of the user preference information from a memory 340.

In the same or alternative implementations, the user preference information obtaining operation 504 may include an operation 730 for obtaining the user preference information by retrieving at least a portion of the user preference information via one or more wireless and/or wired networks. For instance, the user preference information acquiring module 304* including the network information retrieving module 414 (see FIG. 4B) of the automated customized food generation machine 10a or 10b of FIG. 3A or 3B (or of the network device 12a or 12b of FIG. 3D or 3E) obtaining the user preference information by having the network information retrieving module 414 retrieve at least a portion of the user preference information via one or more wireless and/or wired networks 8 (e.g., retrieve portion of the user preference information from the cloud).

As further illustrated in FIG. 7A, operation 730 may further include an operation 731 for retrieving at least the portion of the user preference information via the one or more wireless and/or wired networks by retrieving at least the portion of the user preference information from one or more network devices. For instance, the network information retrieving module 414 of the automated customized food generation machine 10a or 10b of FIG. 3A or 3B (or of the network device 12a or 12b of FIG. 3D or 3E) retrieving at least the portion of the user preference information via the one or more wireless and/or wired networks 8 by retrieving at least the portion of the user preference information from one or more network devices (e.g., servers, workstations, automated customized food generation machines 10*, and so forth).

In various implementations, the user preference information obtaining operation 504 may include an operation 732 for obtaining the user preference information by retrieving at least a portion of the user preference information from the Internet. For instance, the user preference information acquiring module 304* of the automated customized food generation machine 10a or 10b of FIG. 3A or 3B (or of the network device 12a or 12b of FIG. 3D or 3E) obtaining the user preference information by retrieving or acquiring at least a portion of the user preference information from the Internet.

In some cases, operation 732 may, in turn, further include an operation 733 for retrieving at least the portion of the user preference information from the Internet by retrieving at least a portion of the user preference information from one or more social networking sites. For instance, the user preference information acquiring module 304* of the automated customized food generation machine 10a or 10b of FIG. 3A or 3B (or of the network device 12a or 12b of FIG. 3D or 3E) retrieving at least the portion of the user preference information from the Internet by retrieving or acquiring at least a portion of the user preference information from one or more social networking sites (e.g., Twitter or Facebook).

The user preference information to be obtained in the user preference information obtaining operation 504 of FIG. 5 may indicate one or more of a variety of food customization preferences of the user 13. For example, in some implementations, the user preference information obtaining operation 504 may include an operation 734 for obtaining the user preference information of the user that indicates the one or more food customization preferences of the user by obtaining user preference information of the user that indicates one or more user preferences for one or more particular food items. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more food customization preferences of the user 13 by obtaining or acquiring user preference information of the user 13 that indicates one or more user preferences for one or more particular food items (e.g., preference for chocolate chip granola bar, preference for beef stew, preference for low-fat strawberry shake, and so forth).

In the same or different implementations, the user preference information obtaining operation 504 may include an operation 735 for obtaining the user preference information of the user that indicates the one or more food customization preferences of the user by obtaining user preference information of the user that indicates one or more food preparation preferences of the user as illustrated in FIG. 7B. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more food customization preferences of the user 13 by obtaining or acquiring user preference information of the user 13 that indicates one or more food preparation preferences (e.g., well cooked meat ingredients) of the user 13.

In the same or different implementations, the user preference information obtaining operation 504 may include an operation 736 for obtaining the user preference information of the user that indicates the one or more food customization preferences of the user by obtaining user preference information of the user that indicates one or more taste or flavor preferences of the user. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more food customization preferences of the user 13 by obtaining or acquiring user preference information of the user 13 that indicates one or more taste or flavor preferences (e.g., preference for sweeter flavor, preference for spicy flavor, and so forth) of the user 13.

In the same or different implementations, the user preference information obtaining operation 504 may include an operation 737 for obtaining the user preference information of the user that indicates the one or more food customization preferences of the user by obtaining user preference information of the user that indicates one or more ingredient preferences of the user. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more food customization preferences of the user 13 by obtaining or acquiring user preference information of the user 13 that indicates one or more ingredient preferences (e.g., preference for lean beef as meat ingredient, preference for aspartame as sweetener, and so forth) of the user 13.

In the same or different implementations, the user preference information obtaining operation 504 may include an operation 738 for obtaining the user preference information of the user that indicates the one or more food customization preferences of the user by obtaining user preference information of the user that indicates one or more medical dietary restrictions of the user. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more food customization preferences of the user 13 by obtaining or acquiring user preference information of the user 13 that indicates one or more medical dietary restrictions (e.g., preference that no ingredients containing peanuts be used, preference that only non-dairy ingredients be used, and so forth) of the user 13.

In the same or different implementations, the user preference information obtaining operation 504 may include an operation 739 for obtaining the user preference information of the user that indicates the one or more food customization preferences of the user by obtaining user preference information of the user that indicates one or more medical dietary needs of the user. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more food customization preferences of the user 13 by obtaining or acquiring user preference information of the user 13 that indicates one or more medical dietary needs (e.g., preference for vitamin enriched ingredients, preference for fiber enriched ingredients, and so forth) of the user 13.

Referring now to FIG. 7C, in the same or alternative implementations, the user preference information obtaining operation 504 may additionally or alternatively include an operation 740 for obtaining the user preference information of the user that indicates the one or more ingredient integrity preferences of the user related to integrity of one or more ingredients by obtaining user preference information of the user that indicates one or more user preferences related to purity of the one or more ingredients. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more ingredient integrity preferences of the user 13 related to integrity of one or more ingredients by obtaining or acquiring user preference information of the user 13 that indicates one or more user preferences related to purity of the one or more ingredients (e.g., beef ingredients, vegetable ingredients, processed ingredients such as sugar or flour, and so forth).

As further illustrated in FIG. 7C, operation 740 may further include one or more additional operations including, in some cases, an operation 741 for obtaining the user preference information of the user that indicate the one or more user preferences related to purity of the one or more ingredients by obtaining user preference information of the user that indicates one or more user preferences that one or more sources for the one or more ingredients were tested for presence or absence of one or more impurities. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicate the one or more user preferences related to purity of the one or more ingredients by obtaining or acquiring user preference information of the user 13 that indicates one or more user preferences that one or more sources (e.g., farm or crop) for the one or more ingredients (e.g., vegetable ingredients) were tested for presence or absence of one or more impurities (e.g., salmonella or E. coli).

In some cases, operation 741 may, in turn, further include an operation 742 for obtaining user preference information of the user that indicates one or more user preferences that one or more sources for the one or more ingredients were tested to be free of one or more specified impurities. For instance, the user preference information acquiring module 304* of the automated customized food generation machine 10a or 10b of FIG. 3A or 3B (or of the network device 12a or 12b of FIG. 3D or 3E) obtaining or acquiring user preference information of the user 13 that indicates one or more user preferences that one or more sources (e.g., crop) for the one or more ingredients (e.g., flour) were tested to be free of one or more specified impurities (e.g., animal feces such as rat feces).

In the same or alternative implementations, operation 741 may include an operation 743 for obtaining user preference information of the user that indicates one or more user preferences that one or more sources for the one or more ingredients were tested for presence or absence of one or more infectious agents. For instance, the user preference information acquiring module 304* of the automated customized food generation machine 10a or 10b of FIG. 3A or 3B (or of the network device 12a or 12b of FIG. 3D or 3E) obtaining or acquiring user preference information of the user 13 that indicates one or more user preferences that one or more sources (e.g., harvested crop or cattle herd) for the one or more ingredients (e.g., vegetable or meat ingredients) were tested for presence or absence of one or more infectious agents (e.g., bacteria, protozoans, viruses, and so forth).

As further illustrated in FIG. 7C, in some cases, operation 743 may further include an operation 744 for obtaining user preference information of the user that indicates one or more user preferences that one or more sources for the one or more ingredients were tested for presence or absence of one or more bacterial or viral agents. For instance, the user preference information acquiring module 304* of the automated customized food generation machine 10a or 10b of FIG. 3A or 3B (or of the network device 12a or 12b of FIG. 3D or 3E) obtaining or acquiring user preference information of the user 13 that indicates one or more user preferences that one or more sources for the one or more ingredients were tested for presence or absence of one or more bacterial or viral agents (e.g., salmonella, staphylococcus aureus, clostridium botulinum, E. coli, and so forth).

Alternatively or additionally, operation 743 may alternatively or additionally include an operation 745 for obtaining user preference information of the user that indicates one or more user preferences that one or more sources for the one or more ingredients were tested for presence or absence of one or more prions. For instance, the user preference information acquiring module 304* of the automated customized food generation machine 10a or 10b of FIG. 3A or 3B (or of the network device 12a or 12b of FIG. 3D or 3E) obtaining or acquiring user preference information of the user 13 that indicates one or more user preferences that one or more sources (e.g., a cow or cattle herd) for the one or more ingredients (e.g., beef ingredients) were tested for presence or absence of one or more prions.

In the same or alternative implementations, operation 741 may include an operation 746 for obtaining user preference information of the user that indicates one or more user preferences that one or more sources for the one or more ingredients were tested for presence or absence of one or more pesticides and/or heavy metals. For instance, the user preference information acquiring module 304* of the automated customized food generation machine 10a or 10b of FIG. 3A or 3B (or of the network device 12a or 12b of FIG. 3D or 3E) obtaining or acquiring user preference information of the user 13 that indicates one or more user preferences that one or more sources for the one or more ingredients were tested for presence or absence of one or more pesticides (e.g., DDT) and/or heavy metals (e.g., lead or mercury).

In the same or alternative implementations, operation 741 may include an operation 747 for obtaining user preference information of the user that indicates one or more user preferences that one or more sources for the one or more ingredients were tested for presence or absence of one or more antibiotics. For instance, the user preference information acquiring module 304* of the automated customized food generation machine 10a or 10b of FIG. 3A or 3B (or of the network device 12a or 12b of FIG. 3D or 3E) obtaining or acquiring user preference information of the user that indicates one or more user preferences that one or more sources for the one or more ingredients were tested for presence or absence of one or more antibiotics (e.g., Amikacin, Gentamicin, Rifaximin, Doripenem, and so forth).

Turning to FIG. 7D, in various implementations, the user preference information obtaining operation 504 may include an operation 748 for obtaining the user preference information of the user that indicates the one or more ingredient integrity preferences of the user related to integrity of one or more ingredients by obtaining user preference information of the user that indicates one or more user preferences that the one or more ingredients are obtained from one or more specified sources and/or one or more specified locations. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more ingredient integrity preferences of the user 13 related to integrity of one or more ingredients by obtaining or acquiring user preference information of the user 13 that indicates one or more user preferences that the one or more ingredients are obtained from one or more specified sources (e.g., Oscar Meyer or Del Monte) and/or one or more specified locations (e.g., Texas or Hawaii).

As further illustrated in FIG. 7D, in the same or alternative implementations the user preference information obtaining operation 504 may additionally or alternatively include an operation 749 for obtaining the user preference information of the user that indicates the one or more ingredient integrity preferences of the user related to integrity of one or more ingredients by obtaining user preference information of the user that indicates one or more user preferences that the one or more ingredients are not obtained from one or more specified sources and/or one or more specified locations. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more ingredient integrity preferences of the user 13 related to integrity of one or more ingredients by obtaining or acquiring user preference information of the user 13 that indicates one or more user preferences that the one or more ingredients (e.g., beef ingredients) are not obtained from one or more specified sources (e.g., Farmland) and/or one or more specified locations (e.g., Britain).

In the same or alternative implementations, the user preference information obtaining operation 504 may additionally or alternatively include an operation 750 for obtaining the user preference information of the user that indicates the one or more food customization preferences of the user including obtaining past food consumption data of the user that indicates one or more past food consumption activities of the user. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more food customization preferences of the user 13 including obtaining or acquiring past food consumption data of the user 13 that indicates one or more past food consumption activities of the user 13. In some embodiments, the past food consumption data may be useful in determining the one or more customized food items 22 to be generated for the user 13. That is, by comparing the past food consumption activities of the user 13 with the dietary schedule of the user 13, the appropriate customized food item or items 22 may be generated for the user 13.

In the same or alternative implementations, the user preference information obtaining operation 504 may additionally or alternatively include an operation 751 for obtaining the user preference information of the user that indicates the one or more food customization preferences of the user including obtaining past machine usage data of the user that indicates one or more past usages by the user of one or more automated customized food generation machines. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more food customization preferences of the user 13 including obtaining or acquiring past machine usage data of the user 13 that indicates one or more past usages by the user 13 of one or more automated customized food generation machines 10*. In some cases, the past machine usage data of the user 13 may indicate which automated customized food generation machine 10* is the user 13 familiar with or may prefer to use. Thus, when there are multiple automated customized food generation machines 10* in the nearby vicinity of the user 13 that can generate a customized food item 22 in full compliance with the food customization preferences of the user 13, then the user 13 may be directed (e.g., via the user's mobile device) to the automated customized food generation machines 10* that the user 13 has previously used.

In the same or alternative implementations, the user preference information obtaining operation 504 may additionally or alternatively include an operation 752 for obtaining the user preference information of the user that indicates the one or more food customization preferences of the user including obtaining past travel data of the user that indicates one or more past travel paths of the user. For instance, the user preference information acquiring module 304* of the automated customized food generation machine 10a or 10b of FIG. 3A or 3B (or of the network device 12a or 12b of FIG. 3D or 3E) obtaining the user preference information of the user 13 that indicates the one or more food customization preferences of the user 13 including obtaining or acquiring past travel data of the user 13 that indicates one or more past travel paths of the user 13. The past travel data of the user 13 may be useful in directing the user 13 to the “best fit” automated customized food generation machine 10* when a determination is made that multiple automated customized food generation machines 10* that are near the user 13 are capable of currently generating a customized food item 22 in full compliance with customized food preferences of the user 13. That is, based on such information, the user 13 may be directed to an automated customized food generation machine 10* that is on a historical travel path of the user 13.

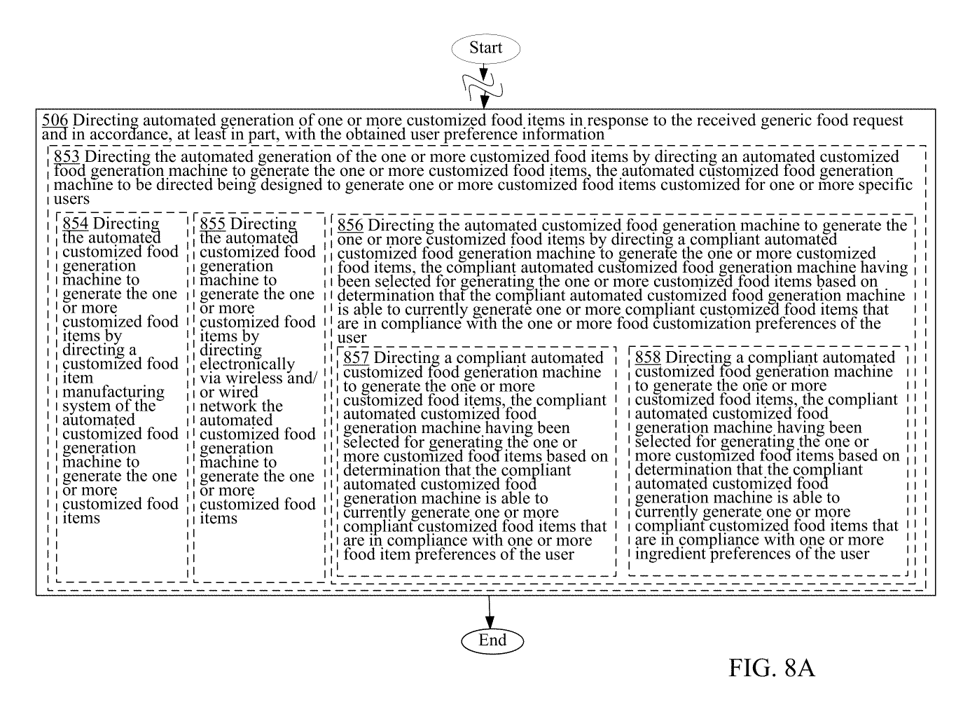

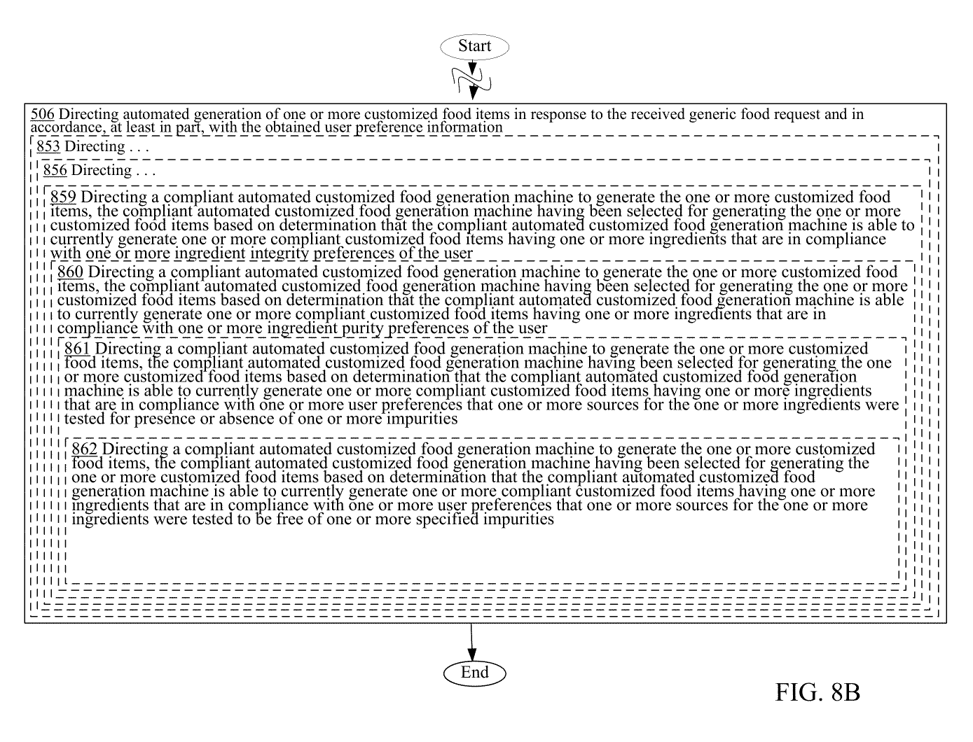

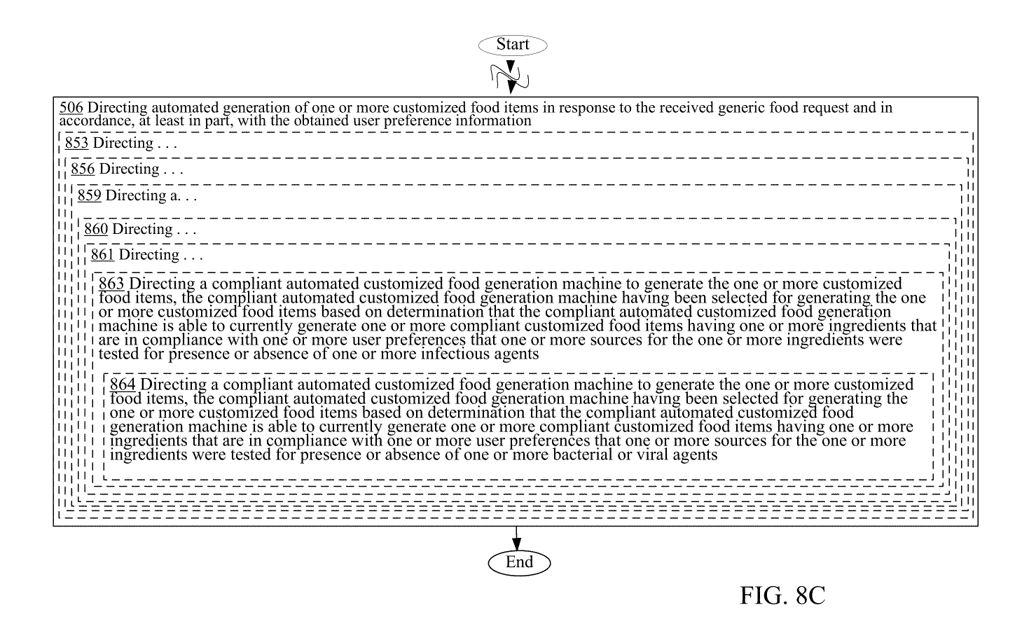

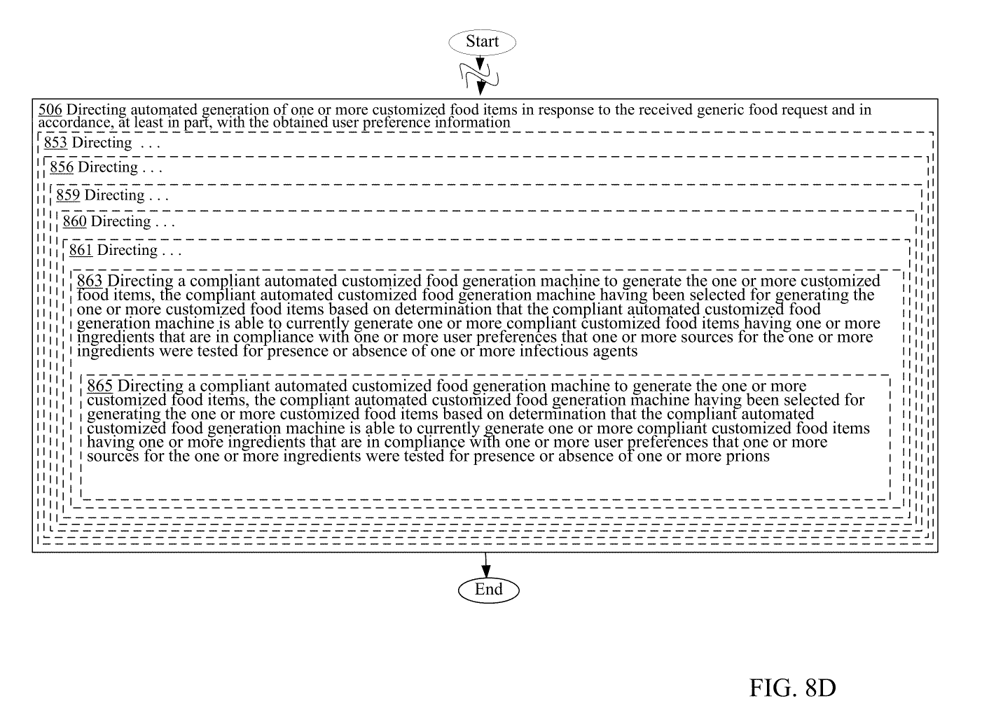

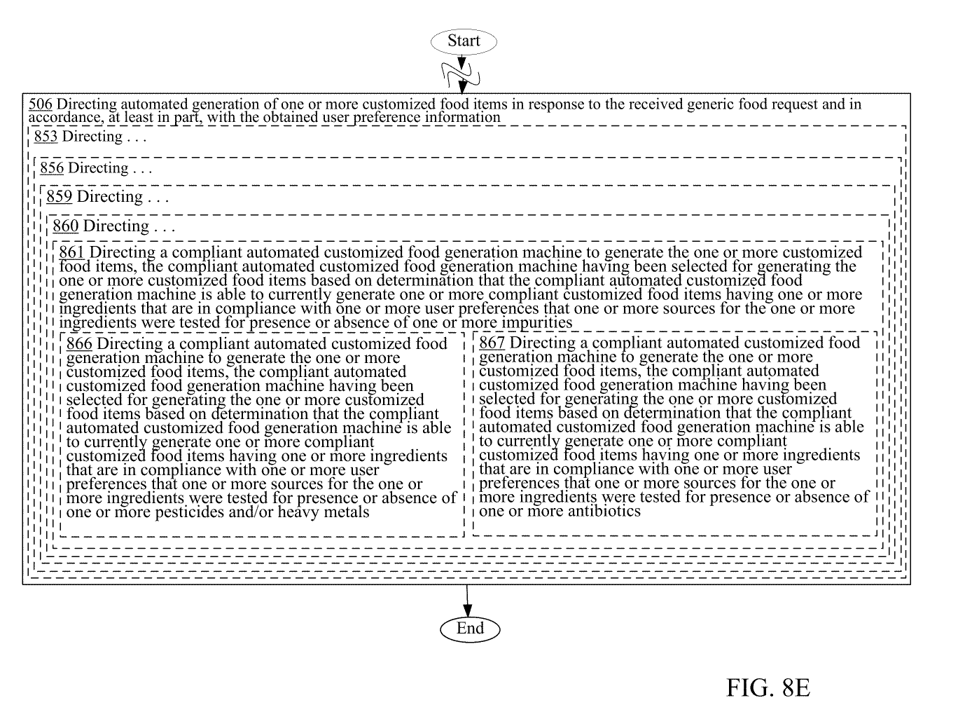

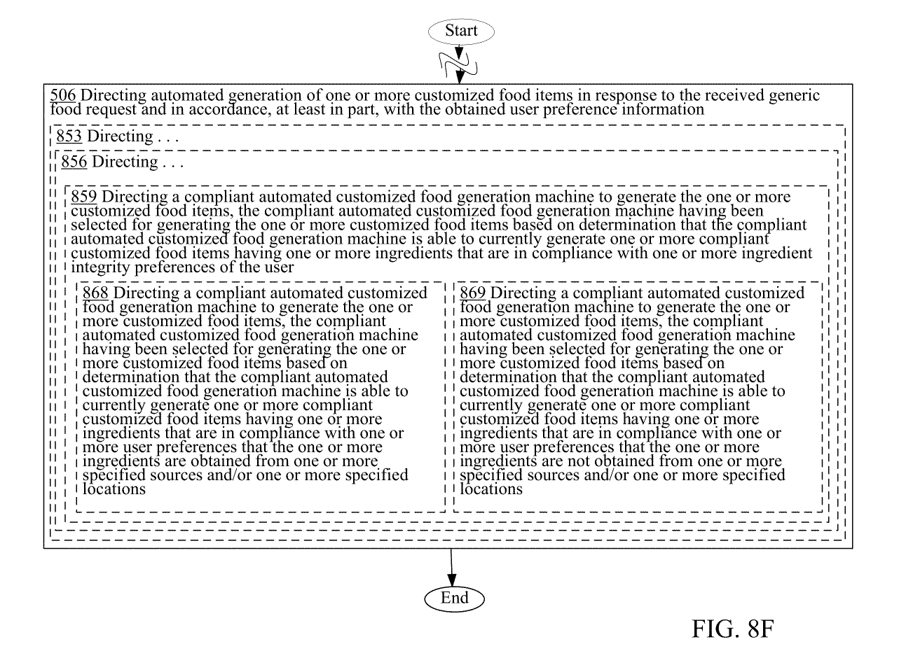

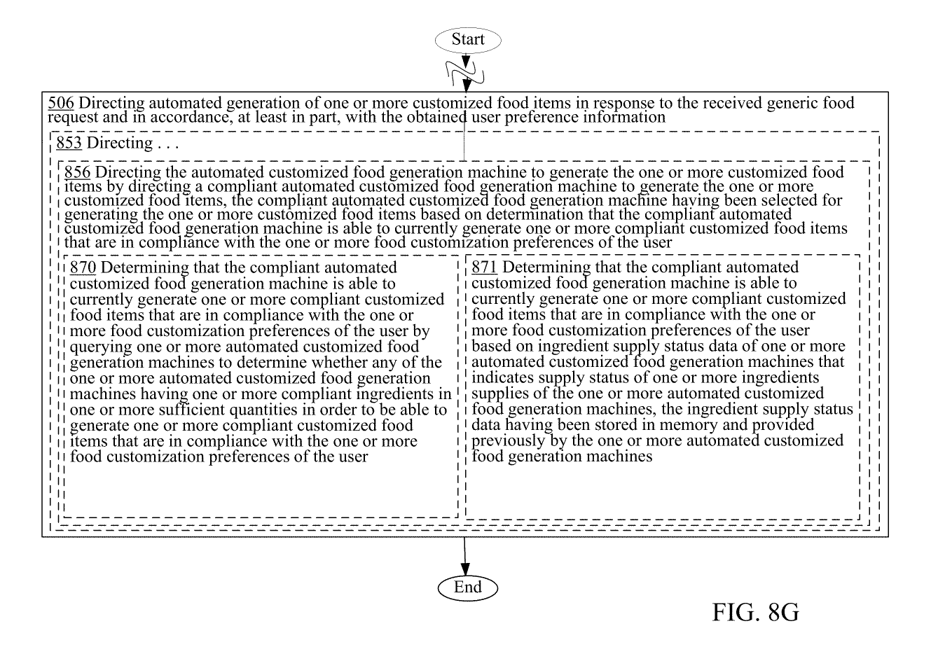

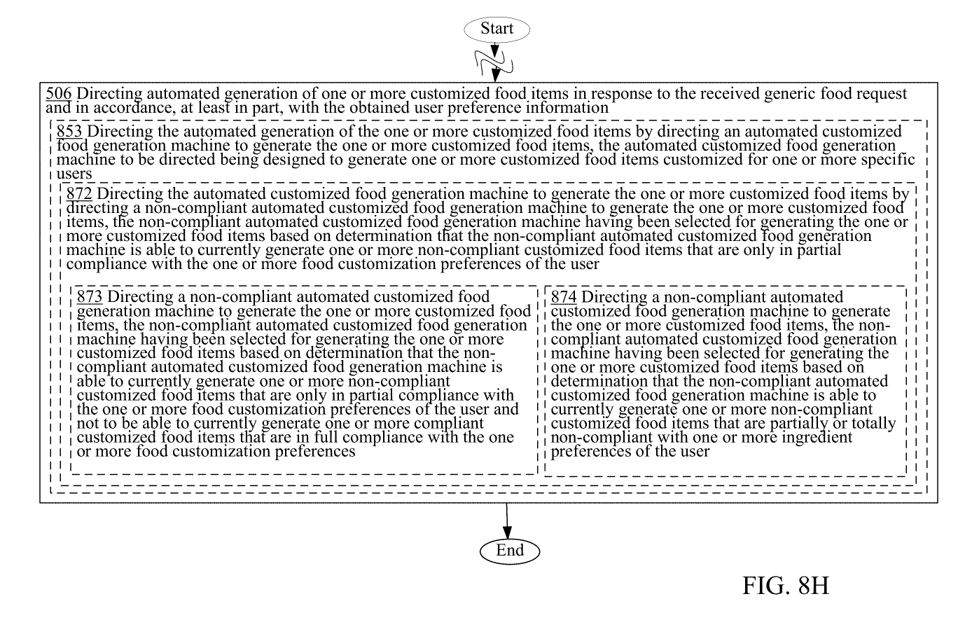

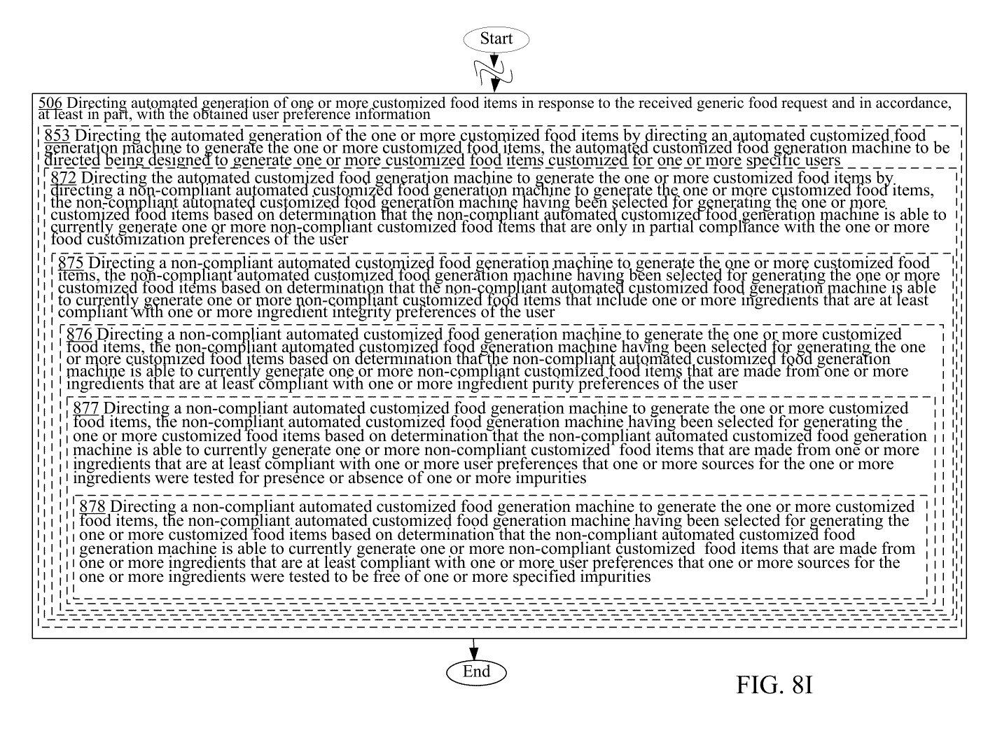

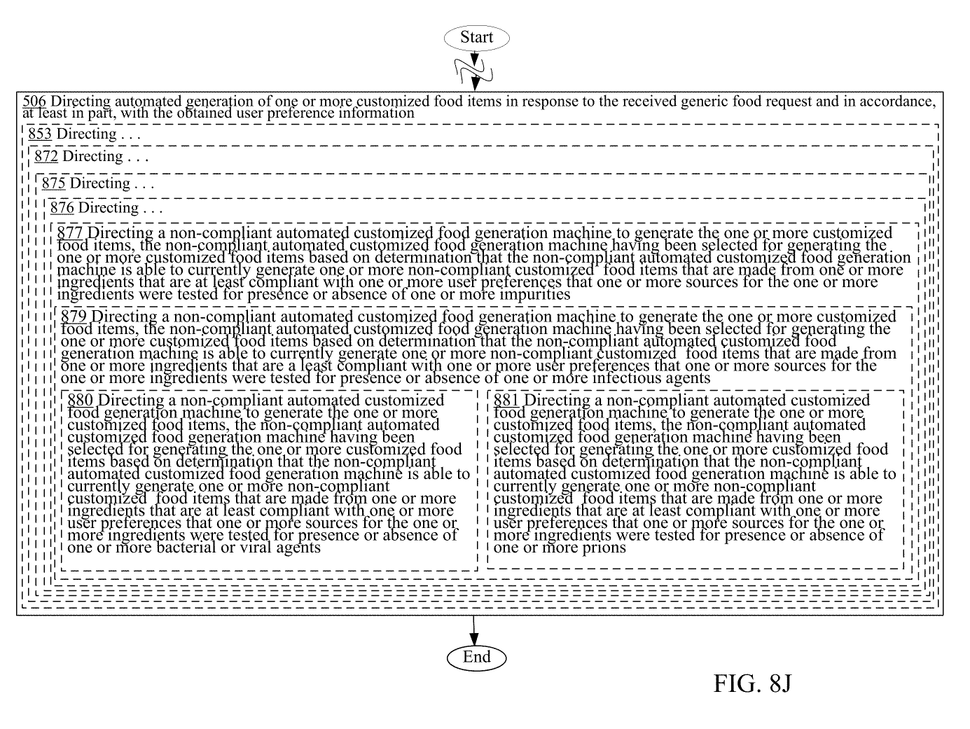

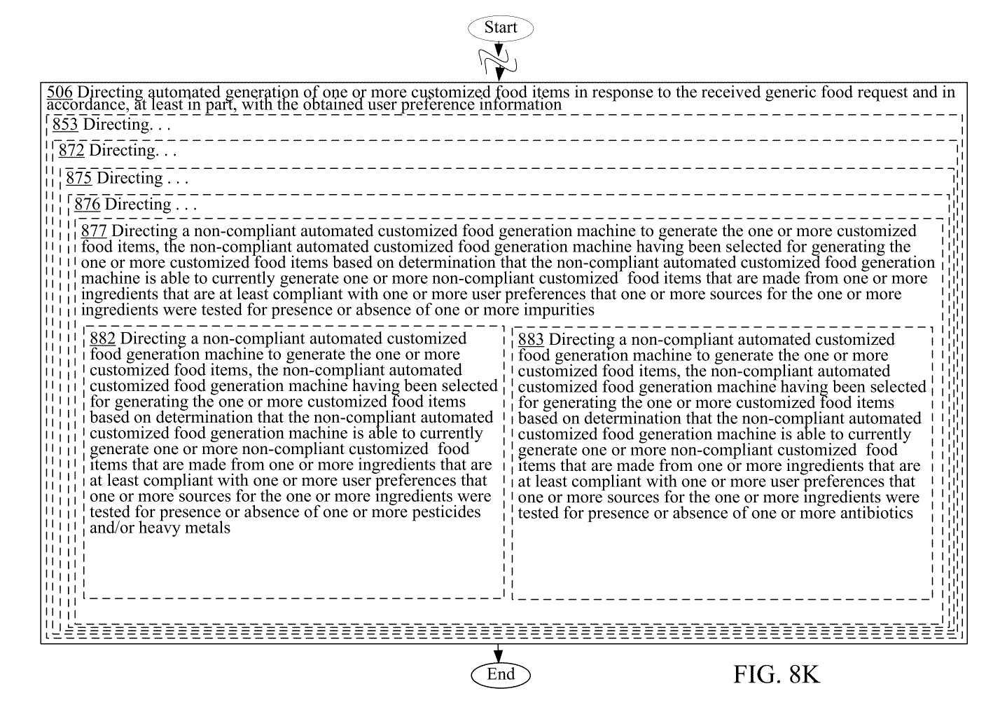

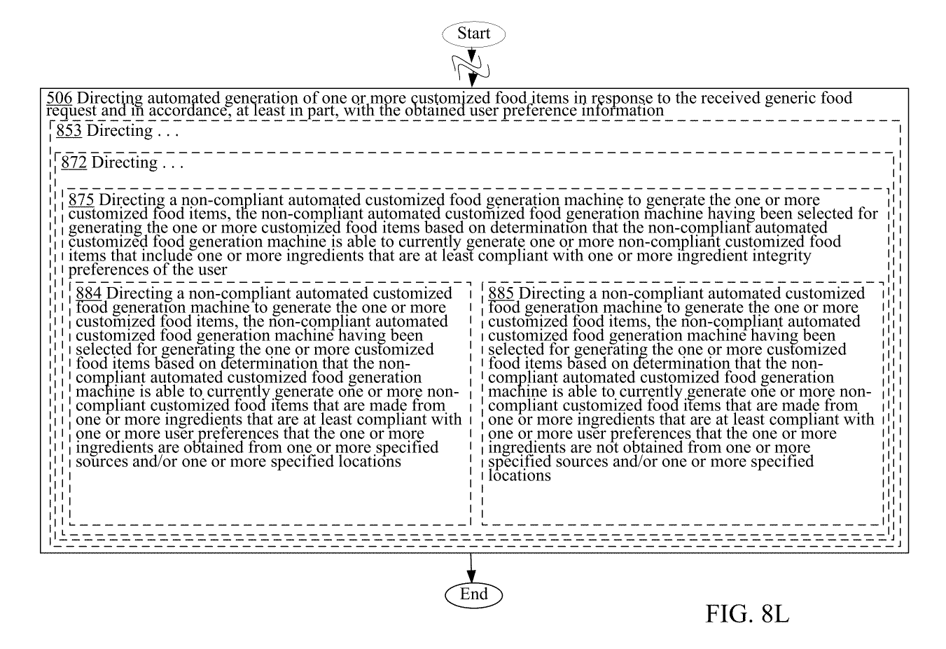

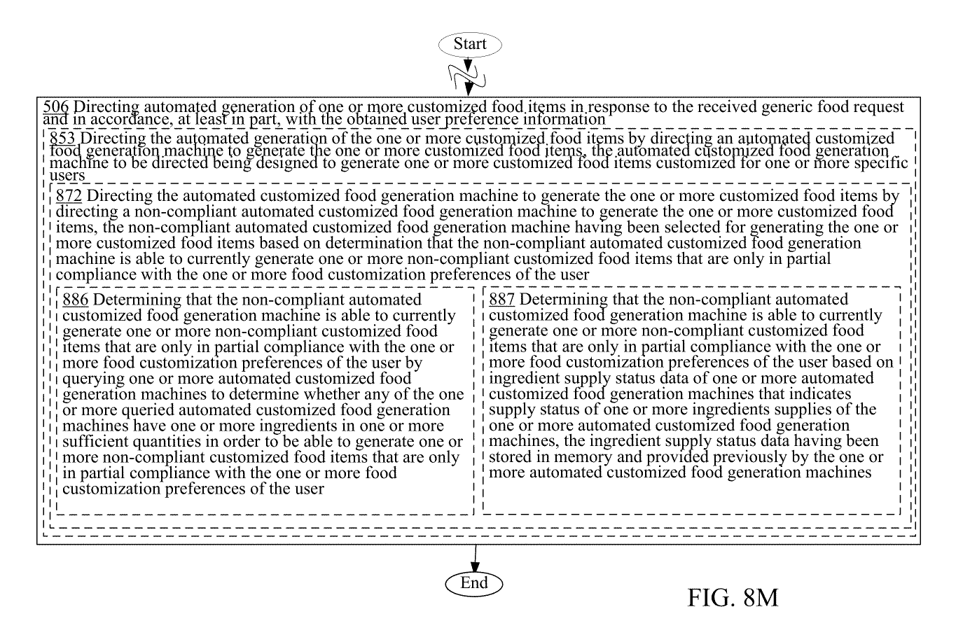

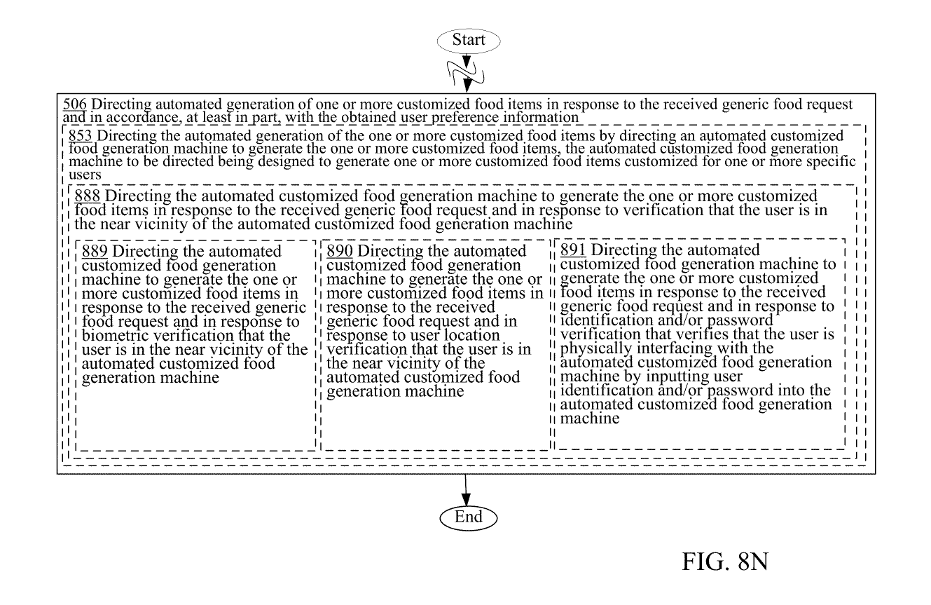

Referring back to the automated customized food generation directing operation 506 of FIG. 5, the automated customized food generation directing operation 506 similar to the generic food request receiving operation 502 and the user preference information obtaining operation 504 of FIG. 5 may be executed in a number of different ways in various alternative embodiments as illustrated, for example, in FIGS. 8A, 8B, 8C, 8D, 8E, 8F, 8G, 8H, 8I, 8J, 8K, 8L, 8M, and 8N. In some cases, for example, the automated customized food generation directing operation 506 may actually include or involve an operation 853 for directing the automated generation of the one or more customized food items by directing an automated customized food generation machine to generate the one or more customized food items, the automated customized food generation machine to be directed being designed to generate one or more customized food items customized for one or more specific users. For instance, the automated customized food generation controlling module 306* including the automated customized food generation machine controlling module 416 (see FIG. 4C) of the automated customized food generation machine 10a or 10b of FIG. 3A or 3B (or of the network device 12a or 12b of FIG. 3D or 3E) directing the automated generation of the one or more customized food items 22 by having the automated customized food generation machine controlling module 416 direct or control an automated customized food generation machine 10* to generate the one or more customized food items 22, the automated customized food generation machine 10* to be directed or controlled being designed to generate one or more customized food items 22 (e.g., a customized energy bar, a customized sandwich, a customized shake or smoothie, and so froth) customized for one or more specific users 13.

As further illustrated in FIGS. 8A, 8B, 8C, 8D, 8E, 8F, 8G, 8H, 8I, 8J, 8K, 8L, 8M, and 8N, operation 853 may further include one or more additional operations in various alternative implementations. For example, in some implementations, operation 853 may include an operation 854 for directing the automated customized food generation machine to generate the one or more customized food items by directing a customized food item manufacturing system of the automated customized food generation machine to generate the one or more customized food items as illustrated in FIG. 8A. For instance, automated customized food generation machine controlling module 416 including the customized food item manufacturing system controlling module 418 (see FIG. 4C) of the automated customized food generation machine 10a or 10b of FIG. 3A or 3B (or of the network device 12a or 12b of FIG. 3D or 3E) directing the automated customized food generation machine 10* to generate the one or more customized food items by having the customized food item manufacturing system controlling module 418 direct or control a customized food item manufacturing system 320 (e.g., a system that employs one or more of 3-D printing technology, robotic technology, or other technologies in order to generate customized food items) of the automated customized food generation machine 10* to generate the one or more customized food items 22.

In the same or alternative implementations, operation 853 may include an operation 855 for directing the automated customized food generation machine to generate the one or more customized food items by directing electronically via wireless and/or wired network the automated customized food generation machine to generate the one or more customized food items. For instance, the automated customized food generation machine controlling module 416 including the network automated customized food generation machine controlling module 420 (see FIG. 4C) of the automated customized food generation machine 10a or 10b of FIG. 3A or 3B (or of the network device 12a or 12b of FIG. 3D or 3E) directing the automated customized food generation machine 10* to generate the one or more customized food items 22 by having the network automated customized food generation machine controlling module 420 directing or controlling electronically, via wireless and/or wired network 8, the automated customized food generation machine 10* to generate the one or more customized food items 22. In some cases, such an operation may be executed by transmitting electronic instructions to the automated customized food generation machine 10* via the wireless and/or wired network 8 to automatically generate the one or more customized food items 22.

In some cases, operation 853 for directing an automated customized food generation machine 10* to generate the one or more customized food items 22 may actually involve directing a compliant automated customized food generation machine 10*, which is able to currently generate one or more compliant customized food items 22 in full compliance with one or more food customization preferences of the user 13, to generate the one or more customized food items 22 that are in compliance with one or more food customization preferences of the user 13. For example, in some implementations, operation 853 may include an operation 856 for directing the automated customized food generation machine to generate the one or more customized food items by directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items that are in compliance with the one or more food customization preferences of the user. For instance, the automated customized food generation machine controlling module 416 including the compliance determining module 422 (see FIG. 4C) of the automated customized food generation machine 10a or 10b of FIG. 3A or 3B (or of the network device 12a or 12b of FIG. 3D or 3E) directing the automated customized food generation machine 10* to generate the one or more customized food items 22 by directing or controlling a compliant automated customized food generation machine 10* to generate the one or more customized food items 22, the compliant automated customized food generation machine 10* having been selected by, for example, the automated customized food generation machine controlling module 416 for generating the one or more customized food items 22 based on determination, by the compliance determining module 422, that the compliant automated customized food generation machine 10* is able to currently (e.g., at the time of the determination) generate one or more compliant customized food items 22 that are in compliance with the one or more food customization preferences of the user 13. In some cases, the user 13 may be directed to the compliant automated customized food generation machine 10* (e.g., directed via the user's mobile device 13 or through the interface of a non-compliant automated customized food generation machine 10* that the user 13 is interfacing with and that is unable to generate a fully compliant customized food item 22 in compliance with the one or more food customization preferences of the user 13) prior to the compliant automated customized food generation machine 10* being directed to generate the one or more customized food items 22.

In some implementations, operation 856 may include an operation 857 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items that are in compliance with one or more food item preferences of the user. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected (e.g., selected by, for example, the automated customized food generation machine controlling module 416) for generating the one or more customized food items 22 based on determination, by the compliance determining module 422, that the compliant automated customized food generation machine 10* is able to currently generate one or more compliant customized food items 22 that are in compliance with one or more food item preferences of the user 13 (e.g., preference for an energy bar, preference for a strawberry smoothie, preference for a beef burger, and so forth).

In the same or alternative implementations, operation 856 may include an operation 858 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items that are in compliance with one or more ingredient preferences of the user. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected (e.g., selected by, for example, the automated customized food generation machine controlling module 416) for generating the one or more customized food items 22 based on determination, by the compliance determining module 422, that the compliant automated customized food generation machine 10* is able to currently generate one or more compliant customized food items 22 that are in compliance with one or more ingredient preferences (e.g., preference that aspartame be used as a sweetener, preference that no beef ingredient from Britain be used, and so forth) of the user 13.

In the same or alternative implementations, operation 856 may include an operation 859 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more ingredient integrity preferences of the user as illustrated in FIG. 8B. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected (e.g., selected by, for example, the automated customized food generation machine controlling module 416) for generating the one or more customized food items 22 based on determination, by the compliance determining module 422, that the compliant automated customized food generation machine 10* is able to currently (e.g., at the time of the determination) generate one or more compliant customized food items 22 having one or more ingredients that are in compliance with one or more ingredient integrity preferences (e.g., ingredity purity preferences and/or ingredient sourcing preferences) of the user 13.

As further illustrated in FIG. 8B, in some cases, operation 859 may further include an operation 860 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more ingredient purity preferences of the user. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected for generating the one or more customized food items 22 based on determination, by the compliance determining module 422, that the compliant automated customized food generation machine 10* able to currently generate one or more compliant customized food items 22 having one or more ingredients that are in compliance with one or more ingredient purity preferences (e.g., preference that one or more ingredients to be free of impurities such as infectious agents, viral or bacterial agents, heavy metals, pesticides, and so forth) of the user 13.

In some cases, operation 860 may, in turn, further include an operation 861 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more user preferences that one or more sources for the one or more ingredients were tested for presence or absence of one or more impurities. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected (e.g., selected by, for example, the automated customized food generation machine controlling module 416) for generating the one or more customized food items based on determination, by the compliance determining module 422, that the compliant automated customized food generation machine 10* is able to currently generate one or more compliant customized food items 22 having one or more ingredients that are in compliance with one or more user preferences that one or more sources (e.g., processed batch) for the one or more ingredients (e.g., processed ingredients such as flour or sugar) were tested for presence or absence of one or more impurities (e.g., heavy metals such as mercury or lead).

In some cases, operation 861 may further include an operation 862 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more user preferences that one or more sources for the one or more ingredients were tested to be free of one or more specified impurities. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected for generating the one or more customized food items based on determination, by the compliance determining module 422, that the compliant automated customized food generation machine 10* is able to currently generate one or more compliant customized food items 22 having one or more ingredients that are in compliance with one or more user preferences that one or more sources (e.g., slaughtered cow) for the one or more ingredients (e.g., beef ingredients) were tested to be free of one or more specified impurities (e.g., prions).

In the same or alternative implementations, operation 861 may additionally or alternatively include an operation 863 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more user preferences that one or more sources for the one or more ingredients were tested for presence or absence of one or more infectious agents as illustrated in FIG. 8C. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected for generating the one or more customized food items based on determination, by the compliance determining module 422, that the compliant automated customized food generation machine 10* is able to currently generate one or more compliant customized food items 22 having one or more ingredients that are in compliance with one or more user preferences that one or more sources for the one or more ingredients (e.g., meat ingredients) were tested for presence or absence of one or more infectious agents (e.g., staphylococcus aureus and clostridium botulinum).

As further illustrated in FIG. 8C, in some cases, operation 863 may further include an operation 864 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more user preferences that one or more sources for the one or more ingredients were tested for presence or absence of one or more bacterial or viral agents. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected for generating the one or more customized food items based on determination, by the compliance determining module 422, that the compliant automated customized food generation machine 10* is able to currently generate one or more compliant customized food items 22 having one or more ingredients that are in compliance with one or more user preferences that one or more sources for the one or more ingredients were tested for presence or absence of one or more bacterial or viral agents (e.g., E. coli or norovirus).

In some implementations, operation 863 may include an operation 865 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more user preferences that one or more sources for the one or more ingredients were tested for presence or absence of one or more prions as illustrated in FIG. 8D. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected for generating the one or more customized food items based on determination, by the compliance determining module 422, that the compliant automated customized food generation machine 10* is able to currently generate one or more compliant customized food items 22 having one or more ingredients that are in compliance with one or more user preferences that one or more sources (e.g., cattle herd) for the one or more ingredients (e.g., beef ingredients) were tested for presence or absence of one or more prions.

Referring to FIG. 8E, in some implementations, operation 861 may include an operation 866 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more user preferences that one or more sources for the one or more ingredients were tested for presence or absence of one or more pesticides and/or heavy metals. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected for generating the one or more customized food items based on determination, by the compliance determining module 422, that the compliant automated customized food generation machine 10* is able to currently generate one or more compliant customized food items 22 having one or more ingredients that are in compliance with one or more user preferences that one or more sources (e.g., harvested crop) for the one or more ingredients (e.g., vegetable ingredients) were tested for presence or absence of one or more pesticides (e.g., DDT) and/or heavy metals (e.g., lead).

In some implementations, operation 861 may additionally or alternatively include an operation 867 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more user preferences that one or more sources for the one or more ingredients were tested for presence or absence of one or more antibiotics. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 22* having been selected for generating the one or more customized food items based on determination, by the compliance determining module 422, that the compliant automated customized food generation machine 10* is able to currently generate one or more compliant customized food items 22 having one or more ingredients that are in compliance with one or more user preferences that one or more sources (e.g., slaughtered cattle) for the one or more ingredients (e.g., beef ingredients) were tested for presence or absence of one or more antibiotics. That is, many of today's consumers prefer that the foods that they consume be free of antibiotics and/or artificial hormones.

Turning now to FIG. 8F, in some implementations, operation 859 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more ingredient integrity preferences of the user may include an operation 868 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more user preferences that the one or more ingredients are obtained from one or more specified sources and/or one or more specified locations. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected for generating the one or more customized food items based on determination, by the compliance determining module 422, that the compliant automated customized food generation machine 10* is able to currently generate one or more compliant customized food items 22 having one or more ingredients that are in compliance with one or more user preferences that the one or more ingredients are obtained from one or more specified sources (e.g., Oscar Meyer) and/or one or more specified locations (e.g., U.S.A.).

In the same or alternative implementations, operation 859 may include an operation 869 for directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items having one or more ingredients that are in compliance with one or more user preferences that the one or more ingredients are not obtained from one or more specified sources and/or one or more specified locations. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a compliant automated customized food generation machine 10* to generate the one or more customized food items 22, the compliant automated customized food generation machine 10* having been selected for generating the one or more customized food items based on determination, by the compliance determining module 422, that the compliant automated customized food generation machine 10* is able to currently generate one or more compliant customized food items 22 having one or more ingredients that are in compliance with one or more user preferences that the one or more ingredients (meat ingredients) are not obtained from one or more specified sources (e.g., Tyson Foods) and/or one or more specified locations (e.g., Britain).

Referring now to FIG. 8G, in various implementations, operation 856 for directing the automated customized food generation machine to generate the one or more customized food items by directing a compliant automated customized food generation machine to generate the one or more customized food items, the compliant automated customized food generation machine having been selected for generating the one or more customized food items based on determination that the compliant automated customized food generation machine is able to currently generate one or more compliant customized food items that are in compliance with the one or more food customization preferences of the user may further include an operation 870 for determining that the compliant automated customized food generation machine is able to currently generate one or more compliant customized food items that are in compliance with the one or more food customization preferences of the user by querying one or more automated customized food generation machines to determine whether any of the one or more automated customized food generation machines having one or more compliant ingredients in one or more sufficient quantities in order to be able to generate one or more compliant customized food items that in compliance with the one or more food customization preferences of the user. For instance, the compliance determining module 422 including the machine querying module 424 (see FIG. 4C) of the automated customized food generation machine 10a or 10b of FIG. 3A or 3B (or of the network device 12a or 12b of FIG. 3D or 3E) determining that the compliant automated customized food generation machine 10* is able to currently generate one or more compliant customized food items 22 that are in compliance with the one or more food customization preferences of the user 13 by having the machine querying module 424 query electronically via one or more wireless and/or wired networks 8 one or more automated customized food generation machines 10* to determine whether any of the one or more automated customized food generation machines 10* having one or more compliant ingredients in one or more sufficient quantities in order to be able to generate one or more compliant customized food items 22 that are in compliance with the one or more food customization preferences of the user 13.

In some alternative implementations, operation 856 may include an operation 871 for determining that the compliant automated customized food generation machine is able to currently generate one or more compliant customized food items that are in compliance with the one or more food customization preferences of the user based on ingredient supply status data of one or more automated customized food generation machines that indicates supply status of one or more ingredients supplies of the one or more automated customized food generation machines, the ingredient supply status data having been stored in memory and provided previously by the one or more automated customized food generation machines. For instance, the compliance determining module 422 of the automated customized food generation machine 10a or 10b of FIG. 3A or 3B (or of the network device 12a or 12b of FIG. 3D or 3E) determining that the compliant automated customized food generation machine 10* is able to currently generate one or more compliant customized food items 22 that are in compliance with the one or more food customization preferences of the user 13 based on ingredient supply status data stored in memory 340 of one or more automated customized food generation machines 10* that indicates supply status of one or more ingredients supplies of the one or more automated customized food generation machines 10*, the ingredient supply status data having been previously provided in the memory 340 by the one or more automated customized food generation machines 10*.

Turning now to FIG. 8H, in various implementations, operation 853 for directing the automated generation of the one or more customized food items by directing an automated customized food generation machine to generate the one or more customized food items, the automated customized food generation machine to be directed being designed to generate one or more customized food items customized for one or more specific users may include an operation 872 for directing the automated customized food generation machine to generate the one or more customized food items by directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are only in partial compliance with the one or more food customization preferences of the user. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing the automated customized food generation machine 10* to generate the one or more customized food items by directing or controlling a non-compliant automated customized food generation machine 10* to generate the one or more customized food items 22, the non-compliant automated customized food generation machine 10* having been selected by, for example, the automated customized food generation machine controlling module 416 for generating the one or more customized food items based on determination, by the compliance determining module 422, that the non-compliant automated customized food generation machine 10* is able to currently generate one or more non-compliant customized food items 22 that are only in partial compliance with the one or more food customization preferences of the user 13 (e.g., not being in compliance with user preference for beef ingredients by using chicken ingredients but being in compliance with ingredient purity preferences of the user 13 that sources for meat ingredients were tested to be free of certain impurities).

As further illustrated in FIG. 8H, operation 872 may, in some implementations, further include an operation 873 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are only in partial compliance with the one or more food customization preferences of the user and not to be able to currently generate one or more compliant customized food items that are in full compliance with the one or more food customization preferences. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected (e.g., selected by, for example, the automated customized food generation machine controlling module 416) for generating the one or more customized food items based on determination, by the compliance determining module 422, that the non-compliant automated customized food generation machine 10* is able to currently generate one or more non-compliant customized food items 22 that are only in partial compliance with the one or more food customization preferences of the user 13 and not to be able to currently generate one or more compliant customized food items 22 that are in full compliance with the one or more food customization preferences. That is, the non-compliant automated customized food generation machine 10* that is to be directed or controlled in order to generate the one or more customized food items 22 is ascertained not to be able to currently generate a customized food item 22 that is in full compliance with the one or more food customization preferences of the user 13. Instead, such a non-compliant automated customized food generation machine 10* is ascertained to be able to only generate one or more non-compliant customized food items 22 that are only in partial compliance with the one or more food customization preferences of the user 13. For example, the non-compliant automated customized food generation machine 10* may be determined or ascertained (by the compliance determining module 422) to be able to generate one or more non-compliant customized food items 22 that are in compliance with a first one or more food customization preferences (e.g., ingredient purity preferences) of the user 13 but not in compliance with a second one or more food customization preferences (e.g., ingredient sourcing preferences) of the user 13.

In the same or alternative implementations, operation 872 may include an operation 874 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are partially or totally non-compliant with one or more ingredient preferences of the user. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected (e.g., selected by, for example, the automated customized food generation machine controlling module 416) for generating the one or more customized food items 22 based on determination, by the compliance determining module 422, that the non-compliant automated customized food generation machine 10* is able to currently generate one or more non-compliant customized food items 22 that are partially or totally non-compliant with one or more ingredient preferences of the user 13 (but which may be ascertained to be compliant with one or more other food customization preferences of the user 13).

Referring now to FIG. 8I, in various implementations, operation 872 may additionally or alternatively include an operation 875 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that include one or more ingredients that are at least compliant with one or more ingredient integrity preferences of the user. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected (e.g., selected by, for example, the automated customized food generation machine controlling module 416) for generating the one or more customized food items 22 based on determination, by the compliance determining module 422, that the non-compliant automated customized food generation machine 10* is able to currently generate one or more non-compliant customized food items 22 that include one or more ingredients that are at least compliant with one or more ingredient integrity preferences of the user 13 (but the one or more non-compliant customized food items 22 not being, for example, compliant with one or more other food customization preferences of the user 13 such as not being in compliance with ingredient sourcing preferences of the user 13 that meat ingredients be provided by Oscar Meyer).

In various implementations, operation 875 may, in turn, further include an operation 876 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more ingredient purity preferences of the user. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected (e.g., selected by, for example, the automated customized food generation machine controlling module 416) for generating the one or more customized food items 22 based on determination, by the compliance determining module 422, that the non-compliant automated customized food generation machine 10* is able to currently generate one or more non-compliant customized food items 22 that are made from one or more ingredients that are at least compliant with one or more ingredient purity preferences of the user 13 (e.g., one or more ingredients that are compliant with one or more user preferences that sources for processed ingredients such as sugar or flour has been tested to be free of heavy metals) but the one or more non-compliant customized food items 22 not being compliant with, for example, one or more other food customization preferences of the user 13.

In some implementations, operation 876 may further include an operation 877 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more user preferences that one or more sources for the one or more ingredients were tested for presence or absence of one or more impurities. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected (e.g., selected by, for example, the automated customized food generation machine controlling module 416) for generating the one or more customized food items 22 based on determination, by the compliance determining module 422, that the non-compliant automated customized food generation machine 10* is able to currently generate one or more non-compliant customized food items 22 that are made from one or more ingredients that are at least compliant with one or more user preferences that one or more sources (e.g., harvest crop or slaughtered animal or animals) for the one or more ingredients (e.g., vegetable, meat, or dairy ingredients) were tested for presence or absence of one or more impurities (e.g., bacteria or viruses) but the one or more non-compliant customized food items 22 not being compliant with, for example, one or more other food customization preferences of the user 13.

In some cases, operation 877 may further include an operation 878 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more user preferences that one or more sources for the one or more ingredients were tested to be free of one or more specified impurities. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected (e.g., selected by, for example, the automated customized food generation machine controlling module 416) for generating the one or more customized food items 22 based on determination, by the compliance determining module 422, that the non-compliant automated customized food generation machine 10* is able to currently generate one or more non-compliant customized food items 22 that are made from one or more ingredients that are at least compliant with one or more user preferences that one or more sources (e.g., a crop or harvested crop, a processed batch of flour or sugar, a cow or a cattle herd, and so forth) for the one or more ingredients were tested to be free of one or more specified impurities (e.g., bacteria, viruses, prions, artificial hormones, heavy metals, and so forth).

Turning now to FIG. 8J, in various implementations, operation 877 may alternatively or additionally include an operation 879 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are a least compliant with one or more user preferences that one or more sources for the one or more ingredients were tested for presence or absence of one or more infectious agents. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected for generating the one or more customized food items 22 based on determination, by the compliance determining module 22, that the non-compliant automated customized food generation machine 10* is able to currently generate one or more non-compliant customized food items 22 that are made from one or more ingredients that are a least compliant with one or more user preferences that one or more sources (e.g., harvested crop, a farm, a slaughtered animal or animals, and so forth) for the one or more ingredients (e.g., meat or vegetable ingredients) were tested for presence or absence of one or more infectious agents (but the one or more non-compliant customized food items 22 not compliant with, for example, one or more other food customization preferences of the user 13). Note that for ease of illustration and readability, the text for some of the operational blocks (e.g., operation 853, 872, 875, and 876) have been deleted from FIG. 8J since such text is redundant.

In some cases, operation 879 may further include an operation 880 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more user preferences that one or more sources for the one or more ingredients were tested for presence or absence of one or more bacterial or viral agents. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected for generating the one or more customized food items 22 based on determination, by the compliance determining module 422, that the non-compliant automated customized food generation machine 10* is able to currently generate one or more non-compliant customized food items 22 that are made from one or more ingredients that are at least compliant with one or more user preferences that one or more sources for the one or more ingredients were tested for presence or absence of one or more bacterial or viral agents (e.g., salmonella, staphylococcus aureus, clostridium botulinum, E. coli, and so forth).

In the same or alternative implementations, operation 879 may additionally or alternatively include an operation 881 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more user preferences that one or more sources for the one or more ingredients were tested for presence or absence of one or more prions. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected for generating the one or more customized food items 22 based on determination, by the compliance determining module 422, that the non-compliant automated customized food generation machine 10* is able to currently generate one or more non-compliant customized food items 22 hat are made from one or more ingredients that are at least compliant with one or more user preferences that one or more sources (e.g., cattle herd or slaughtered cow) for the one or more ingredients (e.g., beef ingredients) were tested for presence or absence of one or more prions.

Turning to FIG. 8K, in various implementations, operation 877 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more user preferences that one or more sources for the one or more ingredients were tested for presence or absence of one or more impurities may actually include an operation 882 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more user preferences that one or more sources for the one or more ingredients were tested for presence or absence of one or more pesticides and/or heavy metals. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected for generating the one or more customized food items based on determination, by the compliance determining module 422, that the non-compliant automated customized food generation machine 10* is able to currently generate one or more non-compliant customized food items 22 that are made from one or more ingredients that are at least compliant with one or more user preferences that one or more sources for the one or more ingredients were tested for presence or absence of one or more pesticides (e.g., DDT) and/or heavy metals (e.g., lead or mercury).

In the same or alternative implementations, operation 877 may additionally or alternatively include an operation 883 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more user preferences that one or more sources for the one or more ingredients were tested for presence or absence of one or more antibiotics. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected for generating the one or more customized food items 22 based on determination, by the compliance determining module 422, that the non-compliant automated customized food generation machine 10* is able to currently generate one or more non-compliant customized food items 22 that are made from one or more ingredients that are at least compliant with one or more user preferences that one or more sources for the one or more ingredients (e.g., meat ingredients) were tested for presence or absence of one or more antibiotics (e.g., Amikacin, Gentamicin, Rifaximin, Doripenem, and so forth).

In various implementations, operation 875 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that include one or more ingredients that are at least compliant with one or more ingredient integrity preferences of the user may include an operation 884 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more user preferences that the one or more ingredients are obtained from one or more specified sources and/or one or more specified locations. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected for generating the one or more customized food items 22 based on determination, by the compliance determining module 422, that the non-compliant automated customized food generation machine 10* is able to currently generate one or more non-compliant customized food items 22 that are made from one or more ingredients that are at least compliant with one or more user preferences that the one or more ingredients are obtained from one or more specified sources (e.g., Del Monte or Oscar Mayer) and/or one or more specified locations (e.g., United States).

In the same or alternative implementations, operation 875 may additionally or alternatively include an operation 885 for directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are made from one or more ingredients that are at least compliant with one or more user preferences that the one or more ingredients are not obtained from one or more specified sources and/or one or more specified locations. For instance, the automated customized food generation machine controlling module 416 including the compliance determining module 422 of the automated customized food generation machine 10a or 10b of FIG. 3A or 3B (or of the network device 12a or 12b of FIG. 3D or 3E) directing or controlling a non-compliant automated customized food generation machine 10* to generate the one or more customized food items 22, the non-compliant automated customized food generation machine 10* having been selected for generating the one or more customized food items 22 based on determination, by the compliance determining module 422, that the non-compliant automated customized food generation machine 10* is able to currently generate one or more non-compliant customized food items 22 that are made from one or more ingredients that are at least compliant with one or more user preferences that the one or more ingredients are not obtained from one or more specified sources (e.g., Tyson Foods) and/or one or more specified locations (e.g., Britain).

Referring to FIG. 8M, in various implementations, operation 872 for directing the automated customized food generation machine to generate the one or more customized food items by directing a non-compliant automated customized food generation machine to generate the one or more customized food items, the non-compliant automated customized food generation machine having been selected for generating the one or more customized food items based on determination that the non-compliant automated customized food generation machine is able to currently generate one or more non-compliant customized food items that are only in partial compliance with the one or more food customization preferences of the user may include an operation 886 for determining that the non-compliant automated customized food generation machine is able to currently generate one or more non-compliant customized food items that are only in partial compliance with the one or more food customization preferences of the user by querying one or more automated customized food generation machines to determine whether any of the one or more queried automated customized food generation machines have one or more ingredients in one or more sufficient quantities in order to be able to generate one or more non-compliant customized food items that are only in partial compliance with the one or more food customization preferences of the user. For instance, the compliance determining module 422 including the machine querying module 424 of the automated customized food generation machine 10a or 10b of FIG. 3A or 3B (or of the network device 12a or 12b of FIG. 3D or 3E) determining that the non-compliant automated customized food generation machine 10* is able to currently generate one or more non-compliant customized food items 22 that are only in partial compliance with the one or more food customization preferences of the user 13 by having the machine querying module 424 query one or more automated customized food generation machines 10* (via wireless and/or wired networks 8) to determine or ascertain whether any of the one or more queried automated customized food generation machines 10* have one or more ingredients in one or more sufficient quantities in order to be able to generate one or more non-compliant customized food items 22 that are only in partial compliance with the one or more food customization preferences of the user 13 (e.g., to generate an energy bar that is made from some of the ingredients preferred by the user 13 but not to generate the energy bar with all of the preferred ingredients of the user 13).

In the same or alternative implementations, operation 872 may include an operation 887 for determining that the non-compliant automated customized food generation machine is able to currently generate one or more non-compliant customized food items that are only in partial compliance with the one or more food customization preferences of the user based on ingredient supply status data of one or more automated customized food generation machines that indicates supply status of one or more ingredients supplies of the one or more automated customized food generation machines, the ingredient supply status data having been stored in memory and provided previously by the one or more automated customized food generation machines. For instance, the compliance determining module 422 of the automated customized food generation machine 10a or 10b of FIG. 3A or 3B (or of the network device 12a or 12b of FIG. 3D or 3E) determining or ascertaining that the non-compliant automated customized food generation machine 10* is able to currently generate one or more non-compliant customized food items 22 that are only in partial compliance with the one or more food customization preferences of the user 13 based on ingredient supply status data of one or more automated customized food generation machines 10* that indicates supply status of one or more ingredients supplies of the one or more automated customized food generation machines 10*, the ingredient supply status data having been stored in memory 340 and provided previously by the one or more automated customized food generation machines 10*.

Turning now to FIG. 8N, in various implementations, operation 853 for directing the automated generation of the one or more customized food items by directing an automated customized food generation machine to generate the one or more customized food items, the automated customized food generation machine to be directed being designed to generate one or more customized food items customized for one or more specific users may include an operation 888 for directing the automated customized food generation machine to generate the one or more customized food items in response to the received generic food request and in response to verification that the user is in the near vicinity of the automated customized food generation machine. For instance, the automated customized food generation machine controlling module 416 including the near vicinity verification module 426 (see FIG. 4C) of the automated customized food generation machine 10a or 10b of FIG. 3A or 3B (or of the network device 12a or 12b of FIG. 3D or 3E) directing or controlling the automated customized food generation machine 10* to generate the one or more customized food items 22 in response to the received generic food request and in response to verification, by the near vicinity verification module 426, that the user 13 is in the near vicinity (e.g., within ten feet) of the automated customized food generation machine 10*. For example, if the user 13 is directed to a particular automated customized food generation machine 10* via a computing device 15 (e.g., a personal mobile device such as a Smartphone) or via the user interface (e.g., display 30) of another automated customized food generation machine 10* that the user is interacting with (see the example scenario illustrated in FIG. 1B), then an initial verification that the user 13 is in the near vicinity of the particular automated customized food generation machine 10* may be required before the particular automated customized food generation machine 10* is directed or controlled in order to generate the one or more customized food items 22.

In some implementations, operation 888 may include an operation 889 for directing the automated customized food generation machine to generate the one or more customized food items in response to the received generic food request and in response to biometric verification that the user is in the near vicinity of the automated customized food generation machine. For instance, the automated customized food generation machine controlling module 416 including the biometric verification module 428 (see FIG. 4C) of the automated customized food generation machine 10a or 10b of FIG. 3A or 3B (or of the network device 12a or 12b of FIG. 3D or 3E) directing or controlling the automated customized food generation machine 10* to generate the one or more customized food items 22 in response to the received generic food request and in response to biometric verification (e.g., fingerprint verification, ocular verification, and so forth), by the biometric verification module 428, that the user 13 is in the near vicinity of the automated customized food generation machine 10*.

In the same or alternative implementations, operation 888 may additionally or alternatively include an operation 890 for directing the automated customized food generation machine to generate the one or more customized food items in response to the received generic food request and in response to user location verification that the user is in the near vicinity of the automated customized food generation machine. For instance, the automated customized food generation machine controlling module 416 including the user location verification module 430 (see FIG. 4C) of the automated customized food generation machine 10a or 10b of FIG. 3A or 3B (or of the network device 12a or 12b of FIG. 3D or 3E) directing or controlling the automated customized food generation machine 10* to generate the one or more customized food items 22 in response to the received generic food request and in response to user location verification, by the user location verification module 430, that the user 13 is in the near vicinity of the automated customized food generation machine 10*. In some cases, the current location of the user 13 may be based on location data provided by, for example, the personal mobile device of the user 13.

In the same or alternative implementations, operation 888 may additionally or alternatively include an operation 891 for directing the automated customized food generation machine to generate the one or more customized food items in response to the received generic food request and in response to identification and/or password verification that verifies that the user is physically interfacing with the automated customized food generation machine by inputting user identification and/or password into the automated customized food generation machine. For instance, the automated customized food generation machine controlling module 416 including the user identification/password verification module 432 (see FIG. 4C) of the automated customized food generation machine 10a or 10b of FIG. 3A or 3B (or of the network device 12a or 12b of FIG. 3D or 3E) directing the automated customized food generation machine 10* to generate the one or more customized food items 22 in response to the received generic food request and in response to identification and/or password verification, by the user identification/password verification module 432, that verifies that the user 13 is physically interfacing with the automated customized food generation machine 10* by inputting user identification and/or password into the automated customized food generation machine 10*.

Turning now to FIG. 9 illustrating another operational flow 900. Operational flow 900 includes certain operations that mirror the operations included in operational flow 500 of FIG. 5. These operations include a generic food request receiving operation 902, a user preference information obtaining operation 904, and an automated customized food generation directing operation 906 that corresponds to and mirrors the generic food request receiving operation 502, the user preference information obtaining operation 504, and the automated customized food generation directing operation 506, respectively, of FIG. 5.

In addition, operational flow 900 further includes an indicator presenting operation 908 for presenting, prior to the directing of the automated generation of the one or more customized food items, one or more indicators that identify an automated customized food generation machine that will generate the one or more customized food items. For instance, the indicator presenting module 308* of the automated customized food generation machine 10a or 10b of FIG. 3A or 3B (or of the network device 12a or 12b of FIG. 3D or 3E) presenting, prior to the directing or controlling of the automated generation of the one or more customized food items 22, one or more indicators 220* that identify an automated customized food generation machine 10* that will generate the one or more customized food items 22. Note that in various implementations operation 908 is actually executed prior to operation 906.

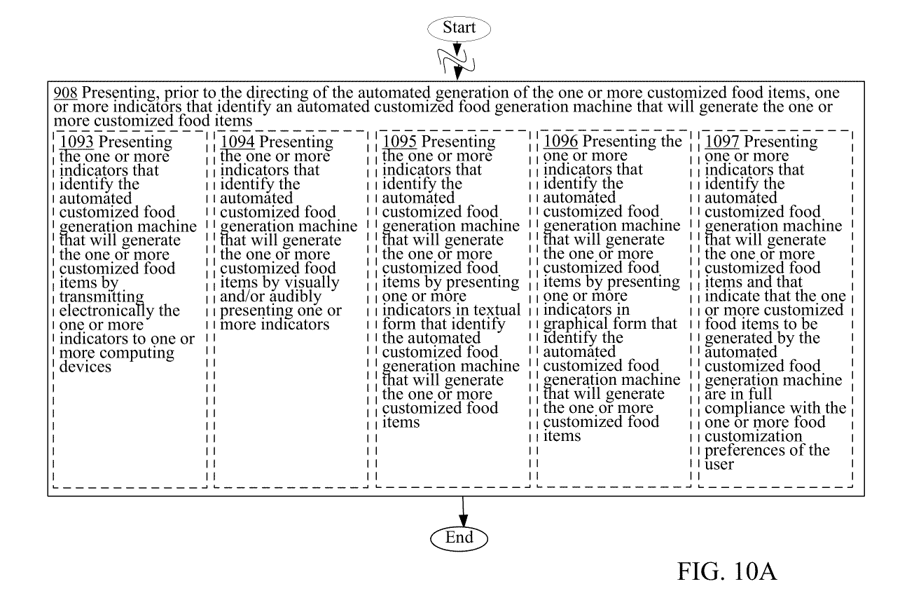

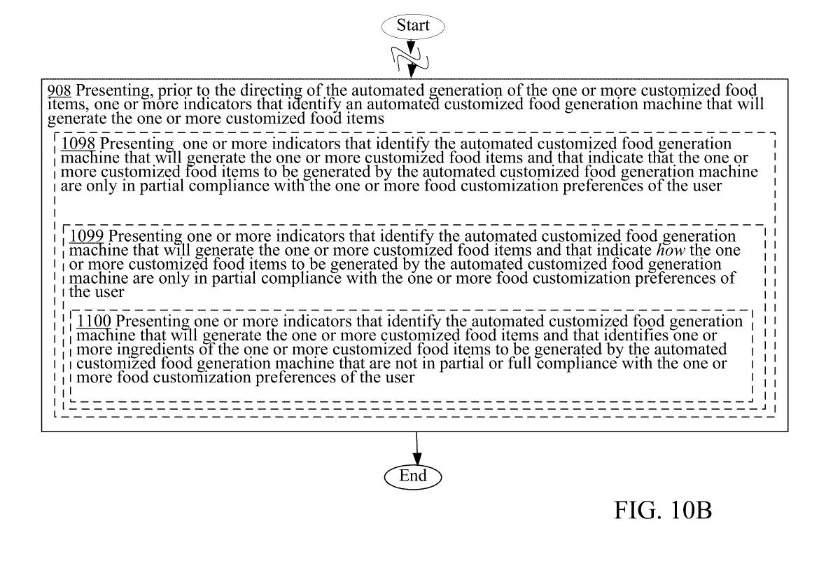

FIGS. 10A and 10B illustrate various ways that the indicator presenting operation 908 may be implemented in various alternative implementations. For example, in some implementations, the indicator presenting operation 908 may include an operation 1093 for presenting the one or more indicators that identify the automated customized food generation machine that will generate the one or more customized food items by transmitting electronically the one or more indicators to one or more computing devices as illustrated in FIG. 10A. For instance, the indicator presenting module 308* including the indictor transmitting module 434 (see FIG. 4D) of the automated customized food generation machine 10a or 10b of FIG. 3A or 3B (or of the network device 12a or 12b of FIG. 3D or 3E) presenting the one or more indicators 220* that identify the automated customized food generation machine 10* that will generate the one or more customized food items by having the indictor transmitting module 434 transmit electronically the one or more indicators 220* to one or more computing devices 15 (e.g., personal mobile device such as a Smartphone or tablet computer, a workstation or laptop computer, and so forth).

In some implementations, the indicator presenting operation 908 may include an operation 1094 for presenting the one or more indicators that identify the automated customized food generation machine that will generate the one or more customized food items by visually and/or audibly presenting one or more indicators. For instance, the indicator presenting module 308* including the visual/audio presenting module 436 (see FIG. 4D) of the automated customized food generation machine 10a or 10b of FIG. 3A or 3B (or of the network device 12a or 12b of FIG. 3D or 3E) presenting the one or more indicators 220* that identify the automated customized food generation machine 10* that will generate the one or more customized food items by visually and/or audibly presenting the one or more indicators 220*.

The one or more indicators that may be presented through the indicator presenting operation 908 may be in a variety of forms. For, example, in some implementations, the indicator presenting operation 908 may include an operation 1095 for presenting the one or more indicators that identify the automated customized food generation machine that will generate the one or more customized food items by presenting one or more indicators in textual form that identify the automated customized food generation machine that will generate the one or more customized food items. For instance, the indicator presenting module 308* of the automated customized food generation machine 10a or 10b of FIG. 3A or 3B (or of the network device 12a or 12b of FIG. 3D or 3E) presenting the one or more indicators that identify the automated customized food generation machine 10* that will generate the one or more customized food items 22 by presenting one or more indicators in textual form (e.g., indicator 220d or 220e that provides an address or directions to the automated customized food generation machine 10* as illustrated in FIG. 2D or 2E) that identify the automated customized food generation machine 10* that will generate the one or more customized food items 22.

In some implementations, the indicator presenting operation 908 may include an operation 1096 for presenting the one or more indicators that identify the automated customized food generation machine that will generate the one or more customized food items by presenting one or more indicators in graphical form that identify the automated customized food generation machine that will generate the one or more customized food items. For instance, the indicator presenting module 308* of the automated customized food generation machine 10a or 10b of FIG. 3A or 3B (or of the network device 12a or 12b of FIG. 3D or 3E) presenting the one or more indicators that identify the automated customized food generation machine 10* that will generate the one or more customized food items by presenting one or more indicators in graphical form (e.g., the indicator 220f of FIG. 2F) that identify the automated customized food generation machine 10* that will generate the one or more customized food items 22.

In some implementations, the indicator presenting operation 908 may include an operation 1097 for presenting one or more indicators that identify the automated customized food generation machine that will generate the one or more customized food items and that indicate that the one or more customized food items to be generated by the automated customized food generation machine are in full compliance with the one or more food customization preferences of the user. For instance, the indicator presenting module 308* of the automated customized food generation machine 10a or 10b of FIG. 3A or 3B (or of the network device 12a or 12b of FIG. 3D or 3E) presenting one or more indicators (e.g., indicator 220d of FIG. 2D,) that identify the automated customized food generation machine 10* that will generate the one or more customized food items 22 and that indicate that the one or more customized food items 22 to be generated by the automated customized food generation machine 10* are in full compliance with the one or more food customization preferences of the user 13. For example, the indicator 220d of FIG. 2D identifying the automated customized food generation machine 10* as being a “compliant machine.”

In some implementations, the indicator presenting operation 908 may include an operation 1098 for presenting one or more indicators that identify the automated customized food generation machine that will generate the one or more customized food items and that indicate that the one or more customized food items to be generated by the automated customized food generation machine are only in partial compliance with the one or more food customization preferences of the user as illustrated in FIG. 10B. For instance, the indicator presenting module 308* of the automated customized food generation machine 10a or 10b of FIG. 3A or 3B (or of the network device 12a or 12b of FIG. 3D or 3E) presenting one or more indicators (e.g., indicator 220g of FIG. 2G) that identify (e.g., provide the address of) the automated customized food generation machine 10* that will generate the one or more customized food items 22 (e.g., hamburger) and that indicate that the one or more customized food items 22 to be generated by the automated customized food generation machine 10* are only in partial compliance with the one or more food customization preferences of the user 13. For example, the indicator 220g of FIG. 2G indicates that the automated customized food generation machine 10* is a non-compliant machine (e.g., that is only able to generate non-compliant customized food items 22).

As further illustrated in FIG. 10B, in various implementations, operation 1098 may further include an operation 1099 for presenting one or more indicators that identify the automated customized food generation machine that will generate the one or more customized food items and that indicate how the one or more customized food items to be generated by the automated customized food generation machine are only in partial compliance with the one or more food customization preferences of the user. For instance, the indicator presenting module 308* of the automated customized food generation machine 10a or 10b of FIG. 3A or 3B (or of the network device 12a or 12b of FIG. 3D or 3E) presenting one or more indicators (e.g., indicator 220g of FIG. 2G) that identify the automated customized food generation machine 10* that will generate the one or more customized food items 22 (e.g., hamburger) and that indicate how the one or more customized food items 22 to be generated by the automated customized food generation machine 10* are only in partial compliance with the one or more food customization preferences of the user 13. For example, the indicator 220g of FIG. 2G indicates the non-compliance (e.g., beef from Texas, whole grain bread rather than whole wheat bread) of the customized food item (e.g., hamburger) to be generated by the automated customized food generation machine 10*.

In some implementations, operation 1099 may further include an operation 1100 for presenting one or more indicators that identify the automated customized food generation machine that will generate the one or more customized food items and that identifies one or more ingredients of the one or more customized food items to be generated by the automated customized food generation machine that are not in partial or full compliance with the one or more food customization preferences of the user. For instance, the indicator presenting module 308* of the automated customized food generation machine 10a or 10b of FIG. 3A or 3B (or of the network device 12a or 12b of FIG. 3D or 3E) presenting one or more indicators (e.g., indicator 220g of FIG. 2G) that identify (e.g., provide an address or map location of) the automated customized food generation machine 22 that will generate the one or more customized food items 22 and that identifies one or more ingredients of the one or more customized food items 22 to be generated by the automated customized food generation machine 10* that are not in partial or full compliance with the one or more food customization preferences of the user 13. For example, indicator 220g identifies “Beef” and “Whole Grain Brea” as not being in compliance with the food customization preferences of the user 13.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In some instances, one or more components may have been referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in some embodiments,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein, “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include, but are not limited to, a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and application programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server. The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Specific examples of operably couplable include, but are not limited, to physically mateable and/or physically interacting components, and/or wirelessly interactable, and/or wirelessly interacting components, and/or logically interacting, and/or logically interactable components.

Although one or more users may be shown and/or described herein as a single illustrated figure, those skilled in the art will appreciate that one or more users may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1.-201. (canceled)

202. A system, comprising:
a generic food request obtaining module configured to obtain a generic food request for one or more food items from a user;
a user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request; and
an automated customized food generation controlling module configured to control automated generation of one or more customized food items in response to the obtained generic food request and in accordance, at least in part, with the acquired user preference information.

203. (canceled)

204. (canceled)

205. The system of claim 202, wherein said generic food request obtaining module configured to obtain a generic food request for one or more food items from a user comprises:
a generic food request obtaining module configured to obtain a generic food request from the user that requests for a particular type of food item.

206. The system of claim 205, wherein said generic food request obtaining module configured to obtain a generic food request from the user that requests for a particular type of food item comprises:
a generic food request obtaining module configured to obtain a generic food request from the user that requests for a particular type of prepared meal.

207. The system of claim 205, wherein said generic food request obtaining module configured to obtain a generic food request from the user that requests for a particular type of food item comprises:
a generic food request obtaining module configured to obtain a generic food request from the user that requests for a particular type of energy bar.

208. (canceled)

209. (canceled)

210. The system of claim 202, wherein said generic food request obtaining module configured to obtain a generic food request for one or more food items from a user comprises:
a user identification verification information obtaining module configured to obtain user identification verification information from the user.

211.-226. (canceled)

227. The system of claim 202, wherein said generic food request obtaining module configured to obtain a generic food request for one or more food items from a user comprises:
a generic food request obtaining module configured to obtain a generic food request from the user that does not identify any food customization preferences of the user.

228. The system of claim 202, wherein said generic food request obtaining module configured to obtain a generic food request for one or more food items from a user comprises:
a generic food request obtaining module configured to obtain a generic food request from the user that requests for a food item without identifying any specific food items.

229.-231. (canceled)

232. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire at least a portion of the user preference information from the Internet.

233. The system of claim 232, wherein said user preference information acquiring module configured to acquire at least a portion of the user preference information from the Internet comprises:
a user preference information acquiring module configured to acquire at least a portion of the user preference information from one or more social networking sites.

234. (canceled)

237. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire user preference information of the user that indicates one or more ingredient preferences of the user.

238. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire user preference information of the user that indicates one or more medical dietary restrictions of the user.

239. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire user preference information of the user that indicates one or more medical dietary needs of the user.

240. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire user preference information of the user that indicates one or more user preferences related to purity of the one or more ingredients.

241. The system of claim 240, wherein said user preference information acquiring module configured to acquire user preference information of the user that indicates one or more user preferences related to purity of the one or more ingredients comprises:
a user preference information acquiring module configured to acquire user preference information of the user that indicates one or more user preferences that one or more sources for the one or more ingredients were tested for presence or absence of one or more impurities.

242. The system of claim 241, wherein said user preference information acquiring module configured to acquire user preference information of the user that indicates one or more user preferences that one or more sources for the one or more ingredients were tested for presence or absence of one or more impurities comprises:
a user preference information acquiring module configured to acquire user preference information of the user that indicates one or more user preferences that one or more sources for the one or more ingredients were tested to be free of one or more specified impurities.

243.-247. (canceled)

248. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire user preference information of the user that indicates one or more user preferences that the one or more ingredients are obtained from one or more specified sources and/or one or more specified locations.

249. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire user preference information of the user that indicates one or more user preferences that the one or more ingredients are not obtained from one or more specified sources and/or one or more specified locations.

250. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire past food consumption data of the user that indicates one or more past food consumption activities of the user.

251. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire past machine usage data of the user that indicates one or more past usages by the user of one or more automated customized food generation machines.

252. The system of claim 202, wherein said user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request comprises:
a user preference information acquiring module configured to acquire past travel data of the user that indicates one or more past travel paths of the user.

253. The system of claim 202, wherein said automated customized food generation controlling module configured to control automated generation of one or more customized food items in response to the obtained generic food request and in accordance, at least in part, with the acquired user preference information comprises:
an automated customized food generation machine controlling module configured to control an automated customized food generation machine to generate the one or more customized food items, the automated customized food generation machine to be controlled being designed to generate one or more customized food items customized for one or more specific users.

254. (canceled)

255. (canceled)

256. The system of claim 253, wherein said automated customized food generation machine controlling module configured to control an automated customized food generation machine to generate the one or more customized food items, the automated customized food generation machine to be controlled being designed to generate one or more customized food items customized for one or more specific users comprises:
an automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module, that the compliant automated customized food generation machine is able to currently generate one or more compliant customized food items that are in compliance with the one or more food customization preferences of the user.

257. The system of claim 256, wherein said automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module, that the compliant automated customized food generation machine is able to currently generate one or more compliant customized food items that are in compliance with the one or more food customization preferences of the user comprises:
an automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items that are in compliance with one or more food item preferences of the user.

258. The system of claim 256, wherein said automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module, that the compliant automated customized food generation machine is able to currently generate one or more compliant customized food items that are in compliance with the one or more food customization preferences of the user comprises:
an automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items that are in compliance with one or more ingredient preferences of the user.

259. The system of claim 256, wherein said automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module, that the compliant automated customized food generation machine is able to currently generate one or more compliant customized food items that are in compliance with the one or more food customization preferences of the user comprises:
an automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items having one or more ingredients that are in compliance with one or more ingredient integrity preferences of the user.

260. The system of claim 259, wherein said automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items having one or more ingredients that are in compliance with one or more ingredient integrity preferences of the user comprises:
an automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items having one or more ingredients that are in compliance with one or more ingredient purity preferences of the user.

261. The system of claim 260, wherein said automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items having one or more ingredients that are in compliance with one or more ingredient purity preferences of the user comprises:
an automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items having one or more ingredients that are in compliance with one or more user preferences that one or more sources for the one or more ingredients were tested for presence or absence of one or more impurities.

262.-267. (canceled)

268. The system of claim 259, wherein said automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items having one or more ingredients that are in compliance with one or more ingredient integrity preferences of the user comprises:
an automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items having one or more ingredients that are in compliance with one or more user preferences that the one or more ingredients are obtained from one or more specified sources and/or one or more specified locations.

269. The system of claim 259, wherein said automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items having one or more ingredients that are in compliance with one or more ingredient integrity preferences of the user comprises:
an automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module that the compliant automated customized food generation machine is able to currently generate one or more compliant customized food items having one or more ingredients that are in compliance with one or more user preferences that the one or more ingredients are not obtained from one or more specified sources and/or one or more specified locations.

270. The system of claim 256, wherein said automated customized food generation machine controlling module including a compliance determining module configured to control a compliant automated customized food generation machine to generate the one or more customized food items, the compliant automated customized food generation machine having been selected for generating the one or more customized food items based on determination by the compliance determining module, that the compliant automated customized food generation machine is able to currently generate one or more compliant customized food items that are in compliance with the one or more food customization preferences of the user comprises:
a machine querying module configured to query one or more automated customized food generation machines to determine whether any of the one or more automated customized food generation machines having one or more compliant ingredients in one or more sufficient quantities in order to be able to generate one or more compliant customized food items that are in compliance with the one or more food customization preferences of the user.

271. (canceled)

272. The system of claim 253, wherein said automated customized food generation machine controlling module configured to control an automated customized food generation machine to generate the one or more customized food items, the automated customized food generation machine to be controlled being designed to generate one or more customized food items customized for one or more specific users comprises:
an automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that are only in partial compliance with the one or more food customization preferences of the user.

273. (canceled)

274. (canceled)

275. The system of claim 272, wherein said automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that are only in partial compliance with the one or more food customization preferences of the user comprises:
an automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that include one or more ingredients that are at least compliant with one or more ingredient integrity preferences of the user.

276. The system of claim 275, wherein said automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that include one or more ingredients that are at least compliant with one or more ingredient integrity preferences of the user comprises:
an automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that are made from one or more ingredients that are at least compliant with one or more ingredient purity preferences of the user.

277. (canceled)

284. The system of claim 275, wherein said automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that include one or more ingredients that are at least compliant with one or more ingredient integrity preferences of the user comprises:
an automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that are made from one or more ingredients that are at least compliant with one or more user preferences that the one or more ingredients are obtained from one or more specified sources and/or one or more specified locations.

285. The system of claim 275, wherein said automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that include one or more ingredients that are at least compliant with one or more ingredient integrity preferences of the user comprises:
an automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that are made from one or more ingredients that are at least compliant with one or more user preferences that the one or more ingredients are not obtained from one or more specified sources and/or one or more specified locations.

286. The system of claim 272, wherein said automated customized food generation machine controlling module including a compliance determining module configured to control a non-compliant automated customized food generation machine to generate the one or more customized food items, the non-compliant automated customized food generation machine having been selected for generating the one or more customized food items based on determination by the compliance determining module that the non-compliant automated customized food generation machine is able to currently generate one or more non-compliant customized food items that are only in partial compliance with the one or more food customization preferences of the user comprises:
a machine querying module configured to query one or more automated customized food generation machines to determine whether any of the one or more queried automated customized food generation machines have one or more ingredients in one or more sufficient quantities in order to be able to generate one or more non-compliant customized food items that are only in partial compliance with the one or more food customization preferences of the user.

287. (canceled)

288. The system of claim 253, wherein said automated customized food generation machine controlling module configured to control an automated customized food generation machine to generate the one or more customized food items, the automated customized food generation machine to be controlled being designed to generate one or more customized food items customized for one or more specific users comprises:
an automated customized food generation machine controlling module including a near vicinity verification module configured to control the automated customized food generation machine to generate the one or more customized food items in response to the received generic food request and in response to verification by the near vicinity verification module that the user is in the near vicinity of the automated customized food generation machine.

289. (canceled)

290. The system of claim 288, wherein said automated customized food generation machine controlling module including a near vicinity verification module configured to control the automated customized food generation machine to generate the one or more customized food items in response to the received generic food request and in response to verification by the near vicinity verification module that the user is in the near vicinity of the automated customized food generation machine comprises:
an automated customized food generation machine controlling module including a user location verification module configured to control the automated customized food generation machine to generate the one or more customized food items in response to the received generic food request and in response to user location verification by the user location verification module, that the user is in the near vicinity of the automated customized food generation machine.

291. (canceled)

292. The system of claim 202, further comprising:
an indicator presenting module configured to present, prior to the automated generation of the one or more customized food items, one or more indicators that identify an automated customized food generation machine that will generate the one or more customized food items.

293.-297. (canceled)

298. The system of claim 292, wherein said indicator presenting module configured to present, prior to the automated generation of the one or more customized food items, one or more indicators that identify an automated customized food generation machine that will generate the one or more customized food items comprises:
an indicator presenting module configured to present one or more indicators that identify the automated customized food generation machine that will generate the one or more customized food items and that indicate that the one or more customized food items to be generated by the automated customized food generation machine are only in partial compliance with the one or more food customization preferences of the user.

299. (canceled)

300. (canceled)

301. An article of manufacture, comprising:
a non-transitory storage medium bearing:
one or more instructions for obtaining a generic food request for one or more food items from a user;
one or more instructions for acquiring, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request; and
one or more instructions for controlling automated generation of one or more customized food items in response to the obtained generic food request and in accordance, at least in part, with the acquired user preference information.

302. An automated customized food generation machine, comprising:
a generic food request obtaining module configured to obtain a generic food request for one or more food items from a user;
a user preference information acquiring module configured to acquire, from one or more sources other than the user, user preference information of the user that indicates one or more food customization preferences of the user including at least one or more ingredient integrity preferences of the user related to integrity of one or more ingredients, the user preference information to be acquired in response to obtaining the generic food request;
an automated customized food generation controlling module configured to control automated generation of one or more customized food items in response to the obtained generic food request and in accordance, at least in part, with the acquired user preference information; and
a customized food item manufacturing system configured to manufacture one or more customized food items.
